(19) United States
(12) Patent Application Publication
(10) Pub. No.: US 2026/0066502 A1
(43) Pub. Date: Mar. 5, 2026

(54) FUSES INTERNAL TO ELECTROCHEMICAL CELLS

(71) Applicant: Enovix Corporation, Fremont, CA (US)

(72) Inventors: Bruno A. Valdes, Sunnyvale, CA (US); Daniel J. Noelle, Mountain View, CA (US); Dmytro Poplavskyy, San Jose, CA (US); Michael J. Armstrong, New Braunfels, TX (US); Robert K. Rosen, Lincoln, CA (US)

(21) Appl. No.: 19/312,053

(22) Filed: Aug. 27, 2025

Related U.S. Application Data
(60) Provisional application No. 63/688,043, filed on Aug. 28, 2024.

(51) Int. Cl. H01M 50/583; H01H 85/041; H01H 85/143; H01M 4/13; H01M 50/474; H01M 50/533

(52) U.S. Cl. CPC H01M 50/583; H01M 4/13; H01M 50/474; H01M 50/533; H01H 85/041; H01H 85/143; H01M 2200/103

(57) ABSTRACT

The present inventions relate to methods, systems, apparatuses, controllers, software, and composition of matter associated with electrochemical energy storage devices. The present inventions relate to cell assemblies comprising electrode current collector fuses disposed within the current collectors. The fuse may be formed within a distal portion of the current collector, the distal portion being devoid of electrode active material. The fuse may be reinforced with a supporting member incorporated into the cell assembly structure. The supporting member may function as a spacer member and/or maintain integrity of the cell assembly during normal operation, e.g., while enabling fuse action under a current surge.

### PRIORITY APPLICATIONS

This application claims priority to U.S. Provisional Patent Application No. 63/688,043, filed on Aug. 28, 2024, which is incorporated herein by reference in its entirety.

### BACKGROUND

The present invention relates to methods and structures such as electrode assemblies for use in energy manipulation (e.g., storage and/or release) devices such as batteries, to energy manipulation devices employing such structures, and to methods for manufacturing such structures and energy manipulation devices.

Batteries are a type of energy manipulation device having electrochemical cells in which carrier ions travel between a cathode structure and an anode structure through an electrolyte within each electrochemical cell (e.g., voltaic cell) abbreviated herein as “cell.” The anode structure and cathode structure in the cell are separated by a gap. The cell may include a separator structure. The separator structure may be incorporated in the battery cell during assembly of the battery and during battery operation. Anode and cathode current collectors of the respective anode and cathode, pool electric current from the respective active electrochemical electrodes and enable transfer (e.g., flow) of the current to the environment outside the battery. For example, lithium-based secondary batteries are a type of energy storage device having cells in which carrier ions, such as lithium, sodium, potassium, calcium or magnesium ions, travel between a cathode structure and an anode structure (e.g., and vice versa) through an electrolyte within each cell.

There are a number of shortcomings related to (e.g., secondary) batteries, their use, and the process of making secondary batteries. For example, internal short circuit (ISC) poses a safety risk for (e.g., lithium-ion) battery cells. In the event an ISC occurs, the cell can rapidly discharge across the short, and concentrated joule heating causes that location to rapidly rise in temperature, which leads to exothermic breakdown of the nearby active battery materials and ignition of the cell. An ISC might occur due to a manufacturing defect such as a loose particle within the stack piercing the separator or due to an external abuse event such as nail penetration. Accordingly, systems and methods are disclosed herein for mitigation of catastrophic failure due to ISC, which minimally (e.g., do not) compromise working performance and energy density of secondary batteries. The electrochemical cells (e.g., battery cells) require safety protection against harm caused by a current surge above a threshold. A fuse internal to the cell assembly may alleviate such harm. The fuse can be assembled as part of a (e.g., think) current collector strip. The fuse of the cell assembly should be sufficiently rigid to withstand (e.g., cycles of) expansion and contraction of the cell assembly, e.g., when it is incorporated in a battery comprising silicon containing an anode.

There is a requirement for a fuse in an energy manipulation device that provides safety protection against a current surge above a threshold, e.g., to avoid harm. The harm may comprise a (e.g., catastrophic) event to the cell assembly, to personnel, to the ambient environment external to the energy manipulation device (e.g., battery) such as to the facility in which the device is disposed. The fuse may be configured to maintain rigidity during cycles of expansion and contraction that the cell undergoes during its prescribed operation.

### TECHNICAL FIELD OF INVENTION

The present disclosure relates to energy manipulation devices. The present disclosure relates more particularly to electrochemical cells comprising fuses internal to the cell assembly, and corresponding assembly structures.

### SUMMARY

In some aspects, the present disclosure resolves one or more of the aforementioned hardships and/or shortcomings. In some embodiments, the present disclosure provides solutions to curtail the aforementioned hardships and/or shortcomings. The solutions include method(s), device(s), apparatus(es), system(s), and/or design(s). In some aspects, the present inventions relate to method(s), device(s), apparatus(es), system(s), and design(s), utilized for a battery comprising cell(s). Methods, apparatuses, devices, program instructions, and structures, are disclosed herein for integrating a fuse into an internal structure of a cell assembly, e.g., into at least one current collector type of the cell assembly. The implementations may comprise forming the fuse in a component of the cell assembly, reinforcing the fuse with a support, and/or positioning the fuse within the cell structure. The component of the cell assembly may be a current collector of an electrode, e.g., cathode. The fuse may be incorporated into (e.g., only) one electrode types, e.g., the cathode. Incorporation into the structure of a certain type of electrode may depend at least in part on material, functional, structural and/or architectural, considerations of the cell assembly, e.g., on material properties of the component in which the fuse is incorporated, on the function of that component within the cell (e.g., for transmitting electrical current), on a space available for incorporation of the fuse, and/or to the relative position of cell components during the prescribed operation of the cell assembly such as disclosed herein (e.g., electrical charge and discharge cycles).

In some aspects, disclosed herein is configuration of a cell comprising an electrode (e.g., cathode) current collector fuse, e.g., disposed between an active material portion and a corresponding busbar. The fuse can be made by cutting the tab to generate a narrow section such as a winding section, for the current surge to pass through. The fuse can be reinforced with a support (e.g., adhesive tape) to which the fuse adheres to. The support can be incorporated into the cell assembly structure, e.g., stacked cell structure. The support should stay intact during normal operation of the battery. The melting temperature of the tape should align with the threshold temperatures of the fuse, e.g., to support the fuse during its intact lifetime in the battery. The support can function as a spacer member, e.g., be incorporated as part of the spacer member structure supporting the cathode current collector.

In another aspect, a device for energy manipulation, the device comprising: a cell assembly being an electrochemical cell assembly, the cell assembly comprising an electrode separated from a counter-electrode by a stacking gap, the electrode comprising an electrode current collector having a middle portion contacting an electrode active material, the current collector comprising a distal portion contacting the middle portion, the distal portion having (a) a tab portion disposed at a terminal of the current collector, and (b) a fuse portion contacting the tab portion, the fuse portion being operatively coupled with the middle portion of the current collector. In some embodiments, the distal portion being devoid of the electrode active material. In some embodiments, the current collector has a lateral axis constituting the longest axis of the current collector, the middle portion and the distal portion being disposed along the lateral axis. In some embodiments, the electrode is stacked along a stacking axis with the counter-electrode, a lateral axis being normal to the stacking axis. In some embodiments, the electrode has an electrodes lateral length along the lateral axis smaller than a counter-electrode lateral length, and a collective lateral length of the middle portion and of the fuse portion is smaller than the counter-electrode lateral length. In some embodiments, the cell assembly comprises a spacer member disposed adjacent to a distal lateral end of the electrode active material and along the lateral axis, the spacer member being configured to contact the fuse portion of the current collector such that the spacer member supports the fuse portion structurally during at least a portion of a use of the cell assembly, the use comprising electrically charging the electrode or electrically discharging the electrode. In some embodiments, the spacer member is separated from the electrode active material by a lateral gap. In some embodiments, the stacking gap comprises a separator, the spacer member being coupled with the separator. In some embodiments, the spacer member adheres to the separator by an adhesive. In some embodiments, the separator has a middle lateral portion and a distal lateral portion contacting the middle lateral portion, the spacer member being coupled with the distal lateral portion of the separator facing the fuse portion of the current collector. In some embodiments, the adhesive comprises carboxylic acids and carboxylic acid salts. In some embodiments, the adhesive comprises a polymer, a resin, a copolymer, a mixture of polymers, any types thereof, or any combination thereof. In some embodiments, the salt is a divalent cationic salt. In some embodiments, the salt is a zinc salt. In some embodiments, the adhesive comprises a carbon backbone with negatively polar side groups and/or hydrogen bond forming side groups. In some embodiments, the carbon backbone is an aliphatic chain. In some embodiments, the cell assembly comprises a supporting structure configured to support the fuse. In some embodiments, the supporting structure is configured to support the fuse at a side of the current collector along the stacking axis. In some embodiments, the supporting member adheres to the fuse or to the spacer member. In some embodiments, the supporting member adheres to a surface normal to the stacking axis, the surface being of the fuse or of the spacer member. In some embodiments, the spacer member is a first spacer member, and wherein the cell assembly comprises a second spacer member disposed at an opposing lateral side of the separator. In some embodiments, the first spacer member and the second spacer member are disposed along a lateral axis of the separator, the spacer members being disposed adjacent to opposing lateral ends of the electrode active material. In some embodiments, the first spacer member and the second spacer member are each separate from the opposing lateral ends of the electrode active material in at least one use type of the cell assembly. In some embodiments, the use type comprises electrically charging the electrode active material or electrically discharging the electrode active material. In some embodiments, the middle portion of the current collector couples with a remainder end of the current collector, the remainder end opposing the tab portion, the remainder end contacting the middle portion of the current collector, the remainder end being along the lateral axis of the current collector. In some embodiments, the second spacer member is configured to support the remainder end of the current collector during use of the cell assembly. In some embodiments, the remainder end can dangle when unsupported by the second spacer member. In some embodiments, the first spacer member and the second spacer member constitute a first pair of spacer members coupled with a first face of the separator along the stacking axis, the cell assembly comprising a second pair of spacer members coupled with the separator at a second face of the separator opposing the first face; the first pair of spacer member being configured to face the electrode current collector. In some embodiments, the tab portion is bent in a direction having a vector component along the stacking axis. In some embodiments, the tab is coupled with an electrode busbar. In some embodiments, a unit cell comprises the electrode and the counter-electrode, the device comprising unit cells stacked along the stacking axis, the unit cells being similar to the unit cell. In some embodiments, the unit cells are at least about 25, 50, 100-, 150-, 200-, or 250-unit cells. In some embodiments, a lateral surface area of the electrode is rectangular comprising a rectangle, the rectangle having an aspect ratio of at least about 1:2, 1:5, 1:10, or 1:50. In some embodiments, the cell assembly is configured to operate at standard operation conditions comprising cycles of electrical charge and discharge; C-rate charging, voltage differential, or any combination thereof. In some embodiments, the cycles comprise at least about 400, 800, 1000, 1200, or 1500 cycles. In some embodiments, the C-rate comprises a C-rate of at least about 0.2, 0.5, or 0.7. In some embodiments, the voltage differential is at least about 3.5 Volts (V), 4.0V, 4.5V, or 5.0V. In some embodiments, the device comprises a constraint system configured to curb volumetric expansion of the cell assembly to abide by jurisdictional standards and/or industry standards, the fuse remaining functional during the volumetric expansion. In some embodiments, the constraint system is configured to curb reversible volumetric expansion and contraction of the cell assembly. In some embodiments, the cell assembly is of a rechargeable battery. In some embodiments, the electrode active material comprises silicon. In some embodiments, the silicon is at least about 5%, 15%, 20%, or 40% of the electrode active material by weight. In some embodiments, the device comprises charge carriers, the charge carriers being alkali and/or alkali earth cations. In some embodiments, the charge carriers comprise lithium cation. In some embodiments, the fuse portion comprises a meandering fuse. In some embodiments, the meandering fuse is a serpentine type fuse. In some embodiments, the serpentine type fuse comprises a cut portion of the fuse portion of the current collector. In some embodiments, the cut portion is indicative of laser dicing. In some embodiments, the meandering fuse has a lateral width that is at most 100 micrometers long. In some embodiments, the meandering fuse comprises at least two inflection points. In some embodiments, the meandering fuse comprises at least 3, 4, or 5 inflection points. In some embodiments, a longitudinal height of (a) the middle portion of the current collector, (b) the tab portion, (c) the fuse portion, and (d) any remainder portion, are the same. In some embodiments, a slot is disposed in a connection between the tab portion and the fuse portion of the current collector. In some embodiments, the device comprises an electrode busbar disposed in the slot, the busbar being parallel to a stacking axis. In some embodiments, the middle portion of the current collector has a first height, the height being along a height axis normal to the stacking axis and normal to the lateral axis, the fuse having a second height that is the same or smaller than the first height. In some embodiments, the tab portion of the current collector has a third height that is the same or smaller than the first height. In some embodiments, the third height is the same or smaller than the second height. In some embodiments, along the stacking axis, the fuse portion of the current collector is on the same plane as the middle portion of the current collector. In some embodiments, along the stacking axis, the fuse portion of the current collector is on a different plane as the middle portion of the current collector by a longitudinal distance. In some embodiments, a unit cell comprises the electrode and the counter electrode, the cell assembly comprises unit cells similar to the unit cell, the unit cells being stacked along the stacking axis, the fuse portion of the current collector of each of the unit cells is on a respectively different plane as a middle portion of the current collector of each of the unit cells by the longitudinal distance, respectively. In some embodiments, the middle portion of the current collector couples with a remainder end of the current collector, the remainder end opposing the tab portion, the remainder end contacting the middle portion of the current collector, the remainder end being along the lateral axis of the current collector. In some embodiments, along the stacking axis, a remainder portion of the current collector is on the same plane as the middle portion of the current collector. In some embodiments, along the stacking axis, the remainder portion of the current collector is on a different plane as the middle portion of the current collector by a longitudinal distance. In some embodiments, a unit cell comprises the electrode and the counter electrode, the cell assembly comprises unit cells similar to the unit cell, the unit cells being stacked along the stacking axis, the fuse portion of the current collector of each of the unit cells is on a respectively different plane as a middle portion of the current collector of each of the unit cells by the longitudinal distance, respectively. In some embodiments, (a) along the stacking axis, the fuse portion of the current collector is on a different plane as the middle portion of the current collector by a first longitudinal distance, and (b) along the stacking axis, the remainder portion of the current collector is on a different plane as the middle portion of the current collector by a second longitudinal distance. In some embodiments, the first longitudinal distance is the same as the second longitudinal distance. In some embodiments, along the stacking axis, a direction of deviation by the first longitudinal distance is the same as the direction of the second longitudinal distance. In some embodiments, a unit cell comprises the electrode and the counter electrode, the cell assembly comprises unit cells similar to the unit cell, the unit cells being stacked along the stacking axis. In some embodiments, (A) the fuse portion of the current collector of each of the unit cells is on the respectively different plane as the middle portion of the current collector of each of the unit cells by the first longitudinal distance, respectively, and/or (B) the middle portion of the current collector of each of the unit cells is on the respectively different plane as the middle portion of the current collector of each of the unit cells by the second longitudinal distance, respectively. In some embodiments, the fuse is configured to protect against harm caused by an electrical surge. In some embodiments, the harm is to the device, to personnel handling the device, to a facility in which the device is disposed, to an environment in which the facility is disposed, to an ambient environment external to the device, to an internal environment of the device, to equipment in the facility, or to any combination thereof. In some embodiments, the electrical surge, if not curbed by the fuse, can cause a thermal runaway reaction. In some embodiments, on activation, the fuse is configured for irreversible use; and optionally the fuse can be slow blow type fuse, fast acting type fuse, or very fast active type fuse. A method comprising: (a) providing any of the aforementioned devices; and (b) manufacturing, testing, buffering, storing, transporting, and/or using the device for the energy manipulation. In some embodiments, the device is manufactured by a manufacturing process. In some embodiments, the manufacturing process comprises roll-to-roll manufacturing. In some embodiments, the fuse is generated on a roll generating a web comprising sets of electrodes. In some embodiments, the set of electrodes comprises at most a single digit number of electrodes. In some embodiments, the web comprises tractor holes, and skewer alignment holes. In some embodiments, electrodes are stacked with counter electrodes along the stacking axis using the skewer alignment holes to generate the cell assembly.

In another aspect, an apparatus for using any of the aforementioned devices, the apparatus comprises: at least one controller configured to (a) operatively couple with at least one component and with the device; and (b) executing, or directing the at least one component to execute, one or more operations associated with manufacturing, testing, buffering, storing, transporting, and/or using, the device. In some embodiments, the at least one controller is configured to operatively couple with a power source and/or with a communication platform. In some embodiments, one or more of the at least one component is of the device.

In another aspect, one or more non-transitory computer readable media comprising program instruction physically inscribed thereon, the program instructions, when read by one or more processors, are configured to (I) execute, or direct execution of, one or more operations associated with manufacturing, testing, buffering, storing, transporting, and/or using, any of the aforementioned devices, and (II) the one or more operations comprising directing at least one component to execute the one or more operations, the one or more processors being configured to operatively couple with the at least one component. In some embodiments, one or more of the at least one component is of the device.

In another aspect, an object for energy manipulation, the object comprises: an electrode current collector having a middle portion configured to contact an electrode active material, the current collector comprising a distal portion contacting the middle portion, the distal portion having (a) a tab portion disposed at a terminal of the current collector, and (b) a fuse portion contacting the tab portion, the fuse portion being operatively coupled with the middle portion of the current collector. In some embodiments, the distal portion being devoid of the electrode active material. In some embodiments, the current collector has a lateral axis constituting the longest axis of the current collector, the middle portion and the distal portion being disposed along the lateral axis. In some embodiments, the electrode is configured for stacking along a stacking axis with a counter-electrode, a lateral axis being normal to the stacking axis, the electrode having an electrodes lateral length along the lateral axis smaller than a counter-electrode lateral length of the counter-electrode, and a collective lateral length of the middle portion and of the fuse portion is smaller than the counter-electrode lateral length. In some embodiments, the middle portion is planar along a plane, the tab portion is configured for bending outside of the plane. In some embodiments, the tab is configured for coupling with an electrode busbar. In some embodiments, a lateral surface area of the electrode is rectangular comprising a rectangle, the rectangle having an aspect ratio of at least about 1:2, 1:5, 1:10, or 1:50. In some embodiments, the fuse portion comprises a meandering fuse. In some embodiments, the meandering fuse is a serpentine type fuse. In some embodiments, the serpentine type fuse is a cut portion of the fuse portion of the current collector. In some embodiments, the cut portion is indicative of laser dicing. In some embodiments, the meandering fuse has a lateral width that is at most 100 micrometers long. In some embodiments, the meandering fuse comprises at least two inflection points. In some embodiments, the meandering fuse comprises at least 3, 4, or 5 inflection points. In some embodiments, a longitudinal height of (a) the middle portion of the current collector, (b) the tab portion, (c) the fuse portion, and (d) any remainder portion, are the same. In some embodiments, a slot is disposed in a connection between the tab portion and the fuse portion of the current collector. In some embodiments, the object is configured to be coupled with an electrode busbar, the slot being configured to engage with the electrode busbar parallel to a stacking axis normal a largest planar surface of the electrode. In some embodiments, the middle portion of the current collector has a first height, the height being along a height axis normal to the lateral axis, the heigh axis begins disposed in a largest surface area face of the electrode, the fuse having a second height that is the same or smaller than the first height. In some embodiments, the tab portion of the current collector has a third height that is the same or smaller than the first height. In some embodiments, the third height is the same or smaller than the second height. In some embodiments, the fuse portion of the current collector is on the same plane as the middle portion of the current collector, the same plane comprising the lateral axis, the same plane comprising a largest surface area face of the electrode. In some embodiments, the middle portion of the current collector couples with a remainder end of the current collector, the remainder end opposing the tab portion, the remainder end contacting the middle portion of the current collector, the remainder end being along the lateral axis of the current collector. In some embodiments, the fuse is configured to protect against harm caused by an electrical surge. In some embodiments, the harm is to the object, to personnel handling the object, to a facility in which the object is disposed, to an environment in which the facility is disposed, to an ambient environment external to the object, to an internal environment of the object, to equipment in the facility, or to any combination thereof. In some embodiments, the electrical surge, if not curbed by the fuse, can cause a thermal runaway reaction. In some embodiments, on activation, the fuse is configured for irreversible use; and optionally the fuse can be slow blow type fuse, fast acting type fuse, or very fast active type fuse. In some embodiments, the electrode is configured for assembly in a cell assembly operating at standard operation conditions comprising cycles of electrical charge and discharge; C-rate charging, voltage differential, or any combination thereof. In some embodiments, the cycles comprise at least about 400, 800, 1000, 1200, or 1500 cycles. In some embodiments, the C-rate comprises a C-rate of at least about 0.2, 0.5, or 0.7. In some embodiments, the voltage differential is at least about 3.5 Volts (V), 4.0V, 4.5V, or 5.0V. In some embodiments, the electrode is configured to use in a rechargeable battery. In some embodiments, the electrode active material comprises silicon. In some embodiments, the silicon is at least about 5%, 15%, 20%, or 40% of the electrode active material by weight.

In another aspect, a method comprises: (a) providing any of the aforementioned objects; and (b) manufacturing, testing, buffering, storing, transporting, and/or using the object for the energy manipulation. In some embodiments, the object is manufactured by a manufacturing process. In some embodiments, the manufacturing process comprises roll-to-roll manufacturing. In some embodiments, the fuse is generated on a roll generating a web comprising sets of electrodes. In some embodiments, the set of electrodes comprises at most a single digit number of electrodes. In some embodiments, the web comprises tractor holes, and skewer alignment holes. In some embodiments, electrodes are stacked with counter electrodes along the stacking axis using the skewer alignment holes to generate the cell assembly.

In another aspect, an apparatus for using any of the aforementioned objects, the apparatus comprises: at least one controller configured to (a) operatively couple with at least one component and with the object; and (b) executing, or directing the at least one component to execute, one or more operations associated with manufacturing, testing, buffering, storing, transporting, and/or using, the object. In some embodiments, the at least one controller is configured to operatively couple with a power source and/or with a communication platform. In some embodiments, one or more of the at least one component is of the object.

In another aspect, one or more non-transitory computer readable media comprising program instruction physically inscribed thereon, the program instructions, when read by one or more processors, are configured to (I) execute, or direct execution of, one or more operations associated with manufacturing, testing, buffering, storing, transporting, and/or using, any of the aforementioned objects, and (II) the one or more operations comprising directing at least one component to execute the one or more operations, the one or more processors being configured to operatively couple with the at least one component. In some embodiments, one or more of the at least one component is of the object.

In another aspect, a (e.g., secondary) battery comprising a battery enclosure, and an electrode assembly and an electrolyte within the battery enclosure, wherein: the electrode assembly comprises a plurality of unit cells stacked in a stacking direction, each of the unit cells comprising an anode structure, a separator structure, and a cathode structure, wherein the cathode or anode structure comprises a fuse section incorporated into a cathode or anode current collector.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions are inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions are inscribed on at least one medium (e.g., on a medium or on media).

In another aspect, an apparatus comprises at least one controller that is configured (e.g., programmed) to direct a mechanism used in a methodology disclosed herein to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus comprises at least one controller configured (e.g., programmed) to implement (e.g., effectuate), or direct implementation of the method, process, and/or operation disclosed herein. In some embodiments, the at least one controller implements any of the methods, processes, and/or operations disclosed herein.

In another aspect, non-transitory computer readable program instructions, when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a mechanism, outside of the mechanism, or in a location remote from the mechanism disclosed herein (e.g., in the cloud).

In another aspect, a system comprises an apparatus and at least one controller configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein. In some embodiments, at least two operations (e.g., instructions) of the apparatus are directed by the same controller. In some embodiments, at least two operations (e.g., instructions) of the apparatus are directed by different controllers. In some embodiments, at least two operations (e.g., instructions) are carried out by the same processor and/or by the same sub-computer software product. In some embodiments, at least two of operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method comprises executing one or more operations associated with at least one configuration of the mechanism(s) (e.g., device(s)) disclosed herein.

In another aspect, an apparatus comprises at least one controller is configured (i) operatively coupled to the device, and (ii) direct executing one or more operations associated with at least one configuration of the device(s) disclosed herein.

In another aspect, at least one controller is associated with the methods, devices, and software disclosed herein. In some embodiments, the at least one controller comprises at least one connector configured to connect to a power source. In some embodiments, the at least one controller being configured to operatively couple with a power source at least in part by (I) having a power socket and/or (II) being configured for wireless power transfer using inductive charging. In some embodiments, the at least one controller comprises a non-volatile memory, e.g., a solid-state device (SSD) such as a FLASH memory. In some embodiments, the at least one controller is included in, or comprises, a hierarchical control system. In some embodiments, the hierarchical control system comprises at least three hierarchical control levels. In some embodiments, the at least one controller is included in a control system disclosed herein. In some embodiments, the at least one controller is configured to control at least one other component of a mechanism (e.g., system, device, or apparatus) disclosed herein. In some embodiments, the device disclosed herein is a component of a system, and wherein the at least one controller is configured to (i) operatively couple to another component of the system and (ii) direct operation of the other component. In some embodiments, the at least one controller is configured to direct operation of the other component at least in part for participation of the other component in a method disclosed herein.

In another aspect, non-transitory computer readable program instructions for a method disclosed herein, the non-transitory computer readable program instructions, when read by one or more processors operatively coupled with the device, cause the one or more processors to direct executing one or more operations associated with at least one configuration of the device(s) disclosed herein.

In some embodiments, the program instructions are of a computer product.

The various embodiments in any of the above aspects are combinable (e.g., within an aspect), as appropriate. Individual features (e.g., embodiments) disclosed herein are combinable in any manner requested and/or desired, as applicable.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

It should be appreciated that any patent, publication, or other disclosure material, in whole or in part, which is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

### BRIEF DESCRIPTION OF THE DRAWINGS

The novel features of the present disclosure are set forth with particularity in the appended claims. Each of the figures disclosed herein is shown in accordance with some implementations of the subject matter of the disclosure. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 depicts a schematic example of various cells;

FIG. 2 depicts schematic examples of folding options for energy manipulation device (e.g., battery) components, and a current collector;

FIG. 3 depicts schematic examples of devices (e.g., batteries) and cells;

FIG. 4 depicts schematic examples of cell architectures;

FIG. 5 depicts schematic exploded views of device (e.g., battery) components;

FIG. 6 depicts illustrative examples of device (e.g., battery) components;

FIG. 7 shows images and exploded view of device (e.g., battery) components;

FIG. 8 shows images of device (e.g., battery) components;

FIG. 9 schematically shows various stages of a cell;

FIG. 10 depicts illustrative examples of an energy manipulation device portion shown as a perspective view, and a fuse regions;

FIG. 11 shows a images of web portions comprising an electrode precursors and portions thereof;

FIG. 12 depicts illustrative examples of energy manipulation device (e.g., battery) components;

FIG. 13 shows distal portions of an electrode as a scheme as an image;

FIG. 14 shows distal portions of an electrode as a scheme as an image;

FIG. 15 shows a side of the cell assembly;

FIG. 16 shows a side of the cell assembly;

FIG. 17 shows a voltage difference at a surge event;

FIG. 18 shows chemical structures of adhesive components;

FIG. 19 shows a method flowchart for fuse formation in a current collector;

FIG. 20 depicts a schematic example of a control system;

FIG. 21 depicts a schematic example of a processing system;

FIG. 22 shows results of an electrical overload tests;

FIG. 23 shows X-ray images of a fuse before and after a nail penetration test; and

FIG. 24 shows voltage and temperature response of a cell during a nail penetration test.

The figures and components therein may not be drawn to scale. Various components of the figures described herein may not be drawn to scale.

### DETAILED DESCRIPTION

While various embodiments of the inventions have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments, aspects, examples, variations, alternates, and instances, disclosed herein are combinable, as appropriate.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Terms such as “a,” “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

An immediately consecutive second feature to a first feature is devoid of another feature disposed therebetween, the features being of the same type. The feature can be a real-life feature, a calculated feature, or any other virtual feature.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The phrase “including X, and/or Y” is meant to have the same meaning as the phrase “comprising X or Y” under currently prevailing US law.

The term “operatively coupled,” “operatively configured,” or “operatively connected” refers to a first mechanism that is coupled (or connected) to a second mechanism to allow the intended operation of the second and/or first mechanism. The coupling may comprise physical or non-physical coupling. The non-physical coupling may comprise signal-induced coupling (e.g., wireless coupling).

The phrase “is/are structured” or “is/are configured,” when modifying an article, refers to a structure of the article that can bring about the referred result.

The symbol “*” designates the mathematical operation of multiplication, e.g., “times.”

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter equivalent of a bounding sphere.

Performing a reversible first operation is understood herein to mean performing the first operation and being capable of performing the opposite operation to that first operation (e.g., which is a second operation). For example, when a controller directs reversibly opening a shutter, that shutter can also close, and the controller can optionally direct a closure of that shutter. For example, when an attractor reversibly binds to a charge carrier, that attractor can also release that charge carrier after its binding.

While the disclosure refers to a cathode as an electrode, the electrode may be an anode, as applicable.

While various portions herein may refer for simplicity to a battery as an energy storage device, that disclosure is extended to any another energy storage device, as applicable.

As noted above, implementations of the present disclosure can relate to (e.g., secondary) batteries, the structures that make up the (e.g., secondary) batteries, and the methods and processes for manufacturing the structures and batteries. As used herein, the term “anode” used in the context of a (e.g., secondary) battery may refer to the negative electrode in a (e.g., secondary) battery. “Anode material” or “anodically active” as used herein may refer to a material or materials suitable for use as the negative electrode of a (e.g., secondary) battery. The term “cathode” as used herein in the context of a (e.g., secondary) battery may refer to the positive electrode in a (e.g., secondary) battery. “Cathode material” or “cathodically active” as used herein may refer to a material or materials suitable for use as the positive electrode of a (e.g., secondary) battery.

In some implementations described herein, the term “electrode” may be used to refer to either the anode or the cathode, and the term “counter-electrode” may refer to the other or opposite. For the sake of explanation, implementations may be described in terms of “electrode” and “counter-electrode.” It should be appreciated that in these implementations, the term electrode may be replaced by the term anode while the term counter-electrode may be replaced by the term cathode, as applicable. Alternatively, in these implementations, the term electrode may be replaced by the term cathode while the term counter-electrode may be replaced by the term anode, as applicable.

The prescribed use of the device (e.g., battery) comprises during charge-discharge cycling, during transportation, during storage, during maintenance, during upgrade, or any combination thereof. The prescribed use (e.g., operation) of the cell assembly comprises during formation of the cell assembly, during buffering of the cell assembly, during the prescribed use of the device comprising the cell assembly, or any combination thereof.

In some embodiments, the energy manipulation device may comprise at least one battery. The battery may comprise one or more cells. The battery may be a rechargeable battery, e.g., a secondary battery. The charge carriers of the battery may comprise alkali earth, alkali cations, a plurality of types of any thereof, or any combination thereof. In an example, the battery comprises charge carriers such as lithium charge carriers.

In some embodiments, the energy manipulation device may comprise at least one battery. The battery may comprise one or more cells. The battery may be a rechargeable battery, e.g., a secondary battery. The charge carriers of the battery may comprise alkali earth, alkali cations, a plurality of types of any thereof, or any combination thereof. In an example, the battery comprises charge carriers such as lithium charge carriers. In some embodiments, charge carriers may comprise carrier ions. In some embodiments, carrier ions are provided to positive electrodes and/or negative electrodes by carrier ion supply layers. Carrier ion supply layers may comprise one or more sources of lithium ions, sodium ions, potassium ions, calcium ions, magnesium ions, aluminum ions, and/or similar such ions. The battery may or may not be a polymer type battery such as a lithium polymer type battery.

In some embodiments, the energy manipulation device includes at least one unit cell. The energy manipulation device may comprise a population of unit cells (e.g., also referred to herein as a “set of cells”). The device may comprise an electrode connector operatively coupled with the electrode and a counter-electrode connector operatively coupled with the counter-electrode, with operatively coupled comprising electrically connected. The electrode connector may be also referred to herein as “an electrode terminal,” and the counter-electrode connector may be also referred to herein as “a counter-electrode terminal.” The device may comprise an electrode busbar, a counter-electrode busbar, an electrode terminal operatively coupled with the electrode busbar, and a counter-electrode terminal operatively coupled with the counter-electrode busbar. The electrode and counter electrode of the unit cell are separated by each other by a gap, e.g., to electrically separate the electrode from the counter-electrode. The gap may include a separator configured to (a) electrically isolate the electrode from the counter electrode and (b) allow traversal of charge carriers through the separator. In some embodiments, each unit cell of the set of cells, includes an electrode structure and a counter-electrode structure separated from each other by a gap. One or more (e.g., each) cells of the set of cells, each include a separator disposed in the gap. In some embodiments, the battery includes adjacent electrode sub-units. Each of the electrode sub-units has a dimension in the X-axis, Y-axis and Z-axis, respectively. The X-axis, Y-axis and Z-axis are each mutually perpendicular, akin to a Cartesian coordinate system. As used herein, the dimensions of each electrode sub-unit in the Z-axis may be referred to as a “height”, dimensions in the X-axis may be referred to as a “length” and dimensions in the Y-axis may be referred to as a “width.” The electrode sub-units may be combined into one or more unit cells. A cell can include (a) at least one anodically active material mass (e.g., layer) and/or (b) at least one cathodically active material mass (e.g., layer). In some embodiments, the anodically active material is separated from the cathode by the gap. In some embodiments, the cathodically active material is separated from the anode by the gap. In some embodiments, the cathodically active material is separated from the anodically active material by the gap. The set of cells may comprise at least 2, 10, 20, 50, 100, 150, 200, 250, or 500 cells. The set of cells may comprise any number of cells between any of the aforementioned number of cells, e.g., from 2 to 500 cells, or from 50 to 500 cells. An active material mass may operatively couple to a current collector. The active material mass may comprise one or more layers. The active material may form a gradient

In some embodiments, the device includes an electrode busbar and a counter-electrode busbar. The electrode busbar can be operatively coupled with (e.g., electrically connected with) the electrode, e.g., via electrode tab. The counter-electrode busbar is operatively coupled with (e.g., electrically connected with) the counter-electrode, e.g., via counter-electrode tab. The electrode busbar can be operatively coupled with the electrodes of the set of cells, e.g., via electrode tabs. The counter-electrode busbar is operatively coupled with the counter-electrodes of the set of cells, e.g., via counter-electrode tabs. An electrode tab can be an extension of the electrode that is devoid of the electrode active material. A counter-electrode tab can be an extension of the counter-electrode that is devoid of the counter-electrode active material.

In some embodiments, the device includes a first busbar and a second busbar that are in electrical contact with the anode(s) and the cathode(s), respectively, e.g., via electrode tabs. The electrode tabs on the first side of the stack of cells can be electrically coupled with the first busbar, which may be referred to as an anode busbar. The electrode tabs on the second side of the stack of cells may be electrically coupled with the second busbar, which may be referred to as a cathode busbar. In some embodiments, the first busbar is electrically coupled with a first electrical terminal of the secondary battery, which is electrically conductive. When the first busbar comprises an anode busbar for the device (e.g., battery), the first electrical terminal comprises a negative terminal. In some embodiments, the second busbar is electrically coupled with a second electrical terminal of the device, which is electrically conductive. When the second busbar comprises a cathode busbar for the device, the second electrical terminal comprises a positive terminal of the device.

In some embodiments, the cell may be coupled with a (e.g., solid) busbar. In some embodiments, the set of cells may be coupled with the (e.g., solid) busbar. The busbar may comprise a (e.g., solid) material of a class. The material class may include an elemental metal, a metal alloy, or an allotrope of elemental carbon, any plurality of types thereof, or any combination thereof. The busbar may comprise (e.g., solid) material, e.g., including one or more types of materials. At least two types of materials may belong to the same class of materials. At least two types of materials may belong to different classes of materials. A class of material may be a composite or a non-composite material. A class of material may be a tacky material (e.g., a tacky connector), or a solid material (e.g., that is non-tacky). A class of material may be a material that is fluid, or non-fluid, e.g., during manufacture of the energy manipulation device such as a battery. In an example, the (e.g., solid) busbar may comprise a metal alloy and an elemental metal. In an example, the (e.g., solid) busbar may comprise two types of metal alloys. In an example, the (e.g., solid) busbar may comprise a composite material and a non-composite material. The busbar may comprise any conductive material disclosed herein. In an example, the busbar includes copper (e.g., Cu101) and Inconel (e.g., N178). The material class can be an oxygen free material. The material class may be an electronic grade material.

In some embodiments, a busbar is attached to the current collector tabs, e.g., the attachment being assisted by the tacky connector. In an example, the busbar contacts the tacky connector that contacts the tab(s). The busbar may have a cross section of a Euclidean shape, e.g., a vertical cross section. The busbar may have a cross section of a geometric planar shape, e.g., a vertical cross section. The shape may include a polygon, an ellipse, a combination thereof and/or a plurality thereof. The polygon may include a rectangle, or a plurality of rectangles. In an example, a vertical cross section of the busbar is a rectangle. In an example, the vertical cross section of the busbar comprises at least two different types of shapes, e.g., rectangles. In an example, the vertical cross section of the busbar comprises at least two types of shapes that are (e.g., substantially) the same, and that are distinct from each other. The two types of shapes may comprise the same type of material or may each be from a different type of material. The two types of shapes may comprise the same class of material or may each be from a different class of material. Two of the shapes may be separated from each other by a gap. Two of the shapes may contact each other. A cross section of the busbar may comprise an indentation, e.g., a depression. The depression may be configured to accommodate (a) folded tab(s) (b) any tacky connector, (c) any welding, or (d) any combination thereof. The depression may be configured to increase adhesion of the tab to the (e.g., solid) busbar. The increased adhesion may be at least in part by increasing the (e.g., solid) busbar's adhesion to (i) any tacky connector and/or (ii) any welding. A contacting surface of the busbar is an exposed surface of the busbar face(s) configured to contract the (a) the tab(s), (b) any tacky connector, (c) any welding, or (d) any combination thereof. The contacting surface may undergo surface treatment before the contact. The surface treatment may be configured to increase adhesion between the (e.g., solid) busbar and (a) the tab(s), (b) any tacky connector, (c) any welding, or (d) any combination thereof. The surface treatment may comprise roughening of the contacting surface. The surface treatment may comprise etching, scraping, or printing (e.g., 3D printing). The surface treatment may comprise mechanical treatment type, chemical treatment type, any plurality thereof, or any combination thereof. The (e.g., solid) busbar may comprise one or more perforations (e.g., holes). The perforation(s) may be configured to accommodate dimensionality changes occurring in the cell, e.g., during charging and/or discharging. The dimensionality changes of the cell may occur during its (e.g., normal) operation, testing, maintenance, storage, shipping, or any combination thereof.

In some embodiments, the cell undergoes pre-loading with charge carriers, e.g., before its regular use. The pre-loading may comprise loading the cell with charge carriers, e.g., “pre-lithiation” in the case of lithium cations being the charge carriers. The pre-loading (also referred herein as “buffering”) may be performed during manufacturing and/or before providing the battery for its intended use. The pre-loading may facilitate insertion of additional charge carriers for a charge carrier source such as a lithium source, into the electrode(s) of the battery such as into the anode(s). The electrode may be a vertically short electrode. The pre-loading may replenish (e.g., irreversible) loss of the charge carriers during formation of the battery, e.g., to increase (a) efficiency of the first cycle and/or (b) cell capacity. The pre-loading may result in a reservoir of the charge carriers within the cell, and/or smaller cycled voltage window. The pre-loading may improve current distribution, e.g., during fast charge. The pre-loading may improve the cycle life of the battery. Buffering or pre-loading may result in pressurization of the cell at its first charging cycle, e.g., due to loading of the anode with charge carriers such as lithium. The pressure adjuster described herein can aid in maintaining overpressure in the system without having to put pressure during buffering, e.g., the adjuster can establish a minimal/threshold overpressure in the device during formation without having to buffer the cell. A rough exposed surface of charge carrier plating may remain throughout the life of the battery, and may compromise function of the battery, e.g., due to depletion of charge carriers and/or due to causing a short (e.g., as a consequence of dendrite formation from an electrode to its counter electrode). In some examples, the geometry of a battery may include a side gap located adjacent to a cell, to enable electrolyte to flow into the gap during buffering.

In some embodiments, a cell comprises an electrode (e.g., reference electrode), a counter electrode, separated from each other by a gap, also referred to herein as “a separation space.” The separation space may comprise a separator, e.g., having a material comprising conduits or pores, e.g., micro conduits, or micropores. The pores and/or conduits may be configured to facilitate charge carriers (e.g., ions) to propagate through the separator. The conduits may be channels. Pores of the separator may form the conduit. The battery cell may comprise, or may be coupled with, an insulator such as a dynamic insulator. The battery cell may comprise, or may be coupled with, a dividing space. At least one component may be electrically insulating, e.g., the separator body, the insulator, or at least one component of the dividing space. The dividing space and the separating space may or may not have the same material content. A divider material may be disposed in the dividing space. The dividing material may or may not be of the same type of material as the separator. The separator may be (e.g., substantially) a plane, or a layer. The separator may be an ionically permeable microporous material suitable for use as a separator in an electrochemical cell. In some embodiments, the separator layer is coated with ceramic particles on one or both sides. In some embodiments, a cell includes an anode current collector in the center, which may comprise or be electrically coupled with, one of the electrode tabs on one of the sides of the secondary battery. In some implementations, the unit cell includes the anodically active material layer, the separator layer, the cathodically active material layer, and a cathode current collector in a stacked formation along a stacking axis. The cathode current collector may comprise a cathode tab devoid of cathode active material. The anode current collector may comprise an anode tab devoid of anode active material. The anode tab may be disposed at the same side of the cathode tab, or at a different side such as an opposing side.

In some embodiments, the cathode includes cathodically active material. The cathodically active material may include a cathodically active material including transition metal oxides, transition metal sulfides, transition metal nitrides, lithium-transition metal oxides, lithium-transition metal sulfides, lithium-transition metal nitrides, any plurality thereof, and/or any combination thereof. The cathodically active material may include transition metal elements of the transition metal oxides, transition metal sulfides, transition metal nitrides, any plurality thereof, and/or any combination thereof. The cathodically active material may include metal elements having a d-shell or f-shell. The cathodically active material may comprise metal element including Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, Au, any plurality thereof, and/or any combination thereof. The cathodically active material may include lithium cobalt oxide (LiCoO₂), LiNi_{0.5}Mn_{1.5}O₄, Li(NiₓCo_{y}Al_{z})O₂, lithium metal phosphate (e.g., lithium iron phosphate, LiFePO₄), Li2MnO₄, V2O5, molybdenum oxysulfides, phosphates, silicates, vanadates, sulfur, sulfur compounds, oxygen (air), lithium nickel manganese cobalt oxide (Li(NiₓMn_{y}Co_{z})O₂), any combinations thereof, and/or any plurality thereof. The cathode active material may comprise LiCoO₂ in an amount of at least about 95%, 97%, 97.5%, or 98% by weight of the total cathode material mass. The cathode composition may comprise a binder such as polyvinylidene fluoride (PVDF) in an amount of about 1% by weight. The cathode composition may also comprise a conductive carbon additive, e.g., carbon black. In some implementations, the cathode (e.g., cathodically active material) is selected from transition metal oxides, transition metal sulfides, transition metal nitrides, lithium-transition metal oxides, lithium-transition metal sulfides, transition-metal phosphates, lithium-transition-metal phosphates, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanides, actinides, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathode active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, and combinations thereof. The cathode active material may comprise, S (e.g., Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5, metal oxides, metal sulfides, metal phosphates, binders, fillers, any plurality thereof, or any combination thereof. The filler may be inert to the chemistry of the device, e.g., chemistry of the cell. The binders may include polyvinylidene difluoride and/or polytetrafluoroethylene. The cathode may comprise LCO, NCM, LFP, LMO, Nickel, Lithium manganese Iron phosphate, lithium manganese iron phosphate, sodium-ion, nickel, manganese rich lithium, lithiated cobalt oxide, lithiated manganese oxide, lithiated nickel-manganese-cobalt oxide, any plurality of types thereof, or any combination thereof. The cathode (e.g., and the device) may be devoid of cobalt.

In some embodiments, the energy manipulation device may comprise a battery. The device may comprise Li-ion batteries, nickel metal hydride batteries, alkaline batteries, any plurality of types thereof, or any combination thereof. The battery may include a cell comprising Cu, Al, Ni, polyethylene, polypropylene, any derivatives thereof, any plurality of types thereof, or any combination thereof.

In some embodiments, the anode includes anodically active material. The anodically active material may include silicon (Si), germanium (Ge), tin (Sn), lead (Pb), antimony (Sb), bismuth (Bi), zinc (Zn), aluminum (Al), titanium (Ti), nickel (Ni), cobalt (Co), cadmium (Cd), any combination thereof, and/or any plurality thereof. The anodically active material may include alloys and/or intermetallic compounds including Si, C, Ge, Sn, Pb, Sb, Bi, Zn, Al, Ti, Ni, Co, Cd, any combination thereof, and/or any plurality thereof. The anodically active material may include alloys, and/or intermetallic compounds. The anodically active material may include oxides, carbides, nitrides, sulfides, phosphides, selenides, tellurides of Si, Ge, Sn, Pb, Sb, Bi, Zn, Al, Ti, Fe, Ni, Co, V, or Cd, any combination thereof, or any plurality thereof. The anodically active material may include mixtures (e.g., containing Lithium), composites (e.g., containing Lithium), any combination thereof, and/or any plurality thereof. The anodically active material may include salts (e.g., of Sn), hydroxides (e.g., of Sn), lithium titanate, lithium manganate, lithium aluminate, lithium-containing titanium oxide, lithium transition metal oxide, ZnCo₂O₄, particles of graphite, particles of carbon, metal form of the charge carriers (e.g., lithium metal), any combinations thereof, and/or any plurality thereof. The anodically active material may be coated. The coating may comprise stabilized metal form of the charge carrier material (e.g., lithium metal particles). The particulate material may include lithium carbonate-stabilized lithium metal powder, lithium silicate stabilized lithium metal powder, other source of stabilized lithium metal powder or ink, any combination thereof, and/or any plurality thereof. The anode active material may comprise a material intercalating the charge carriers. The active material of the anode may include silicon and/or an allotrope of elemental carbon. The allotrope of elemental carbon may be any of the ones disclosed herein, e.g., active carbon, graphite, carbon fiber, carbon nanotube, amorphous carbon, black carbon and/or a fullerene. The carbon nanotubes may comprise single-walled carbon nanotubes (SWCNT). The black carbon may comprise nanoscale particles having a characteristic size of less than about one micrometer and more than about one nanometer. The tubular structures may comprise nested tubes, e.g., at least 2, or 3 nested tubes. The carbon fibers may be weaved, aligned (e.g., in parallel and/or at an angle relative to each other), randomly situated, or any combination thereof, as applicable. The anode may be a nearly (e.g., substantially) 100% silicon—carbon anode. The anode may comprise particulate material. The anode may comprise a carbon scaffold on which silicon is deposited (e.g., layer of silicon). An exposed surface of the silicon may be coated by the, or by at least one other, of the allotropes of elemental carbon. The carbon may comprise black carbon. The carbon may include hard carbon and/or soft carbon. The carbon-silicon structure may comprise successive layers and/or scaffold. The carbon may comprise a particulate material. The particulate material may serve as a base for deposition of the one or mor layers. The particulate material may or may not include crevices. The one or more layers may be deposited onto an exposed surface of the crevices. Anodically active materials may comprise carbon materials such as graphite and soft or hard carbons, or graphene (e.g., single-walled or multi-walled carbon nanotubes), or any of a range of metals, semi-metals, alloys, oxides, nitrides, compounds capable of intercalating lithium, compounds forming an alloy with lithium, any plurality thereof, or any combination thereof. Specific examples of the metals or semi-metals that may be used as the anode material include graphite, tin, lead, magnesium, aluminum, boron, gallium, silicon, Si—C composites, Si/graphite blends, silicon oxide (SiOₓ), porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, mixtures thereof, any plurality thereof, or any other combination thereof. In some implementations, the anodically active material may comprise aluminum, tin, silicon, an oxide thereof, a nitride thereof, a fluoride thereof, other alloy thereof, any plurality thereof, or any combination thereof. In some implementations, the anodically active material may comprise silicon, an alloy thereof, a composite thereof, an oxide thereof, any plurality thereof, or any combination thereof. In some embodiments, the battery may be without an active material (e.g., simple cell).

In some embodiments, the electrode active material comprises one or more additives. The electrode active material may comprise an anode active material, a cathode active material, or any combination thereof. The additives may be present in the electrode active material in an amount of at least about 0.5%, 1.0%, 1.5%, or 2.0%, by weight (wt/wt). The additives may be present in an amount of at most about 0.5%, 1.0%, 1.5%, or 2.0%, by weight (wt/wt). The additives may be present in an amount of any value between the aforementioned values, e.g., from about 0.5% to about 2.0% by weight. The additives may be dispersed within the bulk of the electrode composition and/or may be deposited as a surface treatment on the electrode material particulates. The selection, concentration, and/or placement, of the additives may depend at least in part on the target electrochemical function. The selection, concentration, and/or placement, of the additives may depend at least in part on the electrode formulation. The selection, concentration, and/or placement, of the additives may depend at least in part on the battery architecture.

In some embodiments, a binder is present in the electrode composition. The binder may comprise a polymer, a resin, any plurality of types thereof, or any combination thereof. The resin may comprise a rubber-based material. The binder may promote mechanical cohesion between active material particulates. The binder may support adhesion to a current collector surface. The binder may comprise one or more solvent-based chemistries. The solvent can be an organic solvent. The solvent can be a non-aqueous solvent. The solvent can be an aqueous solvent. In some embodiments, the binder comprises a rubber such as styrene-butadiene rubber (SBR), a polysaccharide derivative such as carboxymethyl cellulose (CMC), any plurality thereof, or any combination thereof. The SBR may impart elasticity and/or mechanical flexibility, e.g., to accommodate volumetric expansion of active material such as during cycling. The CMC may provide viscosity modulation, slurry processability, and/or interfacial binding properties. In some embodiments, a combination of two or more binders is utilized to tune rheological behavior. The combination may substantially enhance structural integrity of the dried electrode film. The binder may be uniformly distributed throughout the electrode layer. The binder may be concentrated at the interfacial region between the active material and the current collector.

In some embodiments, the energy manipulation device comprises an electrochemical cell. The cell may comprise an electrode and a counter-electrode separated from each other by a gap. The device may comprise a simple cell, e.g., comprising passive electrodes. The simple cell may comprise an anode current collector, a cathode current collector separated from the anode current collector by a gap, an electrolyte, and charge carriers. The cell may comprise partially active electrodes—one current collector contacting an active material mass. The mass can be a layer. The cell may comprise fully active electrodes—both electrode and counter-electrode current collectors of the cell, each contacting a respective active material mass, e.g., a layer.

In some examples, the energy manipulation device may comprise a fuel cell. In other examples, the energy manipulation device may comprise a primary battery, which may be a non-rechargeable battery. The primary battery may be a battery comprising Li metal, alkaline, zinc-carbon, silver-oxide, and/or any other suitable material. In some examples, the energy manipulation device may comprise a secondary battery, which may be rechargeable. The secondary battery may be a battery comprising Li ion, lead acid (lead dioxide with sulfuric acid), nickel cadmium, nickel metal hydride, and/or any other suitable material. The use of a secondary battery or rechargeable battery may enable a reduction in environmental waste, as the materials may be reused for multiple cycles as compared to a primary or non-rechargeable battery. In some examples, the energy manipulation device described herein may comprise an electrochemical cell. As noted above, the cell may include an anode material and a cathode material. In an example, an electrochemical cell comprises passive electrodes, wherein the simple electrochemical cell includes an anode charge carrier, a cathode charge carrier separated from the anode by a gap, an electrolyte and charge carriers. In some examples, the energy manipulation device may comprise one or more active electrodes, wherein one charge carrier is in contact with an active material mass. The active material mass can comprise (e.g., be deposited in a form of) a layer. In some examples, the energy manipulation device may comprise one or more fully active electrodes, wherein the electrode and/or counter electrode charge carriers of a cell each contact a respective active material mass, e.g., a layer. The active material mass is configured to operatively coupled with its respective current collector of the electrode. The current collector may have an electrical conductivity of at least about 10³ Siemens/cm (S/cm), 10⁴ S/cm, 10⁵ S/cm, or 10⁶ S/cm. The current collector may have an electrical conductivity between any of the aforementioned values, e.g., from about 10³ S/cm to about 10⁶ S/cm, or from about 10⁵ S/cm to about 10⁶ S/cm.

In some examples, the cell comprises an active material, a charge carrier, an electrolyte, any plurality of types thereof, or any combination thereof. The active material (e.g., mass such as layer) may be added to one side or to both sides of a cell or cell stack. In some embodiments, the electrode comprises a current collector (e.g., conductor) comprising elemental metal, metal alloys, an allotrope of elemental carbon, any plurality of types thereof, or any combination thereof. The allotrope of elemental carbon may comprise graphite, carbon nanotubes, carbon wires, fullerenes, hard carbon, soft carbon, active carbon, carbon black, acetylene black, Ketjen black, cylindrical carbon nanotubes, carbon fibers, any plurality of types thereof, or any combination thereof. The nanotubes and/or nanowires, may be nested or non-nested. The cell may comprise charge carriers comprising salts such as lithium salts. The electrolyte material may comprise solid, semi-solid, liquid, any plurality of types thereof, or any combination thereof. The electrolyte materials may include salts, acids, and/or bases, e.g., dissolved in non-aqueous polar solvent(s). In some embodiments, the electrolyte may comprise a polymer-based electrolyte. The polymer-based electrolyte may include PEO-based polymer electrolyte, polymer-ceramic composite electrolyte, polymer-ceramic composite electrolyte, polymer-ceramic composite electrolyte, and/or similar such electrolytes. In some embodiments, the electrolyte may include an oxide-based electrolyte (e.g., lanthanum titanate (Lio.34Lao.56TiO3), Al-doped lithium lanthanum zirconate (Li6.24La3ZrzAlo.24O11.98), Ta-doped lithium lanthanum zirconate (Li6.4La3Zri.4Tao.6O12), lithium aluminum titanium phosphate (Lit.4Alo.4Tit.6(PO4)3), and/or similar such electrolytes. In some embodiments, the electrolyte may comprise a solid electrolyte (e.g., sulfide-based electrolyte such as lithium tin phosphorus sulfide (LiioSnP2Si2), lithium phosphorus sulfide (13-Li3PS4), lithium phosphorus sulfur chloride iodide (Li6PS5C1o.91o.i), and/or similar such electrolytes. The electrolyte may comprise ethylene carbonate, diethylcarbonate, dimethylcarbonate, ethylmethylcarbonate, propylene carbonate, any derivatives thereof, or any combination thereof.

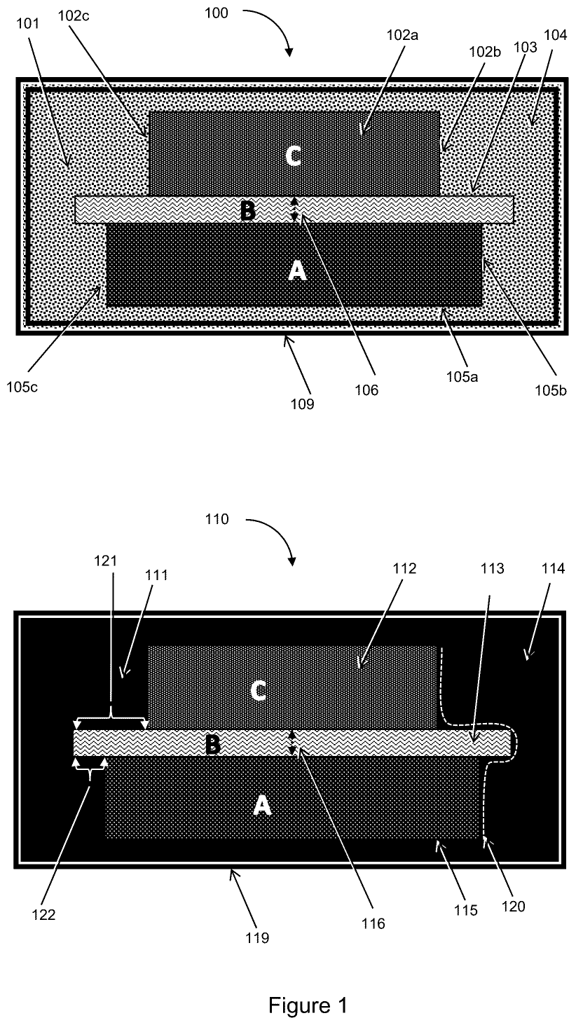

FIG. 1 shows in example 100 a schematic representation of a cell, the cell comprising an electrode 102a-“C” (e.g., a cathode), and an opposing electrode which is a counter electrode 105a-“A” (e.g., an anode). A separator is disposed in separator space (e.g., gap) 103—“B.” The battery cell is disposed in a battery having housing 109. The housing can be rigid, or flexible. The housing may include a rigid portion and/or a flexible portion. The battery can optionally have an insulator 104. The insulator may comprise one or more materials comprising a ceramic, a polymer, or a resin. The battery may comprise one or more insulator types. In an example, a polymer may fill a cathode gap, and alumina fills a cathode gap, the gap being from the edge of the cell to its immediately adjacent edge of the case (also herein “casing”). In some embodiments, insulator may comprise a non-electrically conductive material. The ceramic may comprise alumina (Al₂O₃), zirconia (ZnO₂), magnesium oxide (MgO), boron nitride (BN), mullite, boehmite, or silicon carbide (SiC, e.g., in pure form). Under normal conditions during use of the battery, the main current is a load current 106 passing from one electrode to its opposing electrode, and through separation space 103. When volume 104 comprises the insulator, the insulator contacts at least at opposing sides 102b and 102c of electrode 102a and at opposing sides 105b and 105c of counter-electrode 105a.

FIG. 1 shows in example 110 a schematic representation of a cell, the cell comprising an electrode 112—“C” (e.g., a cathode), and an opposing electrode which is a counter electrode 115—“A” (e.g., an anode). A separator is disposed in separator space 113—“B.” The battery cell is disposed in a battery having housing 119. The separation space extends 121 beyond electrode 112, and extends 122 beyond counter electrode 115, the extension being along a long axis of each of the electrode, the long axis depicted in FIG. 1. The extension can extend longer in the lateral direction. The extension can form the tab. The battery has an insulator 114. Under the normal conditions, the load current 116 may be passing through separation space 113.

In some embodiments, the different extension distances of the components of the cell in the lateral direction, form a corrugated (e.g., misaligned) face of the cell, and thus a set of the cells, e.g., as depicted in FIG. 1, 120 for a cell. The cell can comprise at least one uneven side, e.g., as is depicted in FIG. 1, 120. The uneven (e.g., misaligned) side can create a wavy side of a set of cells.

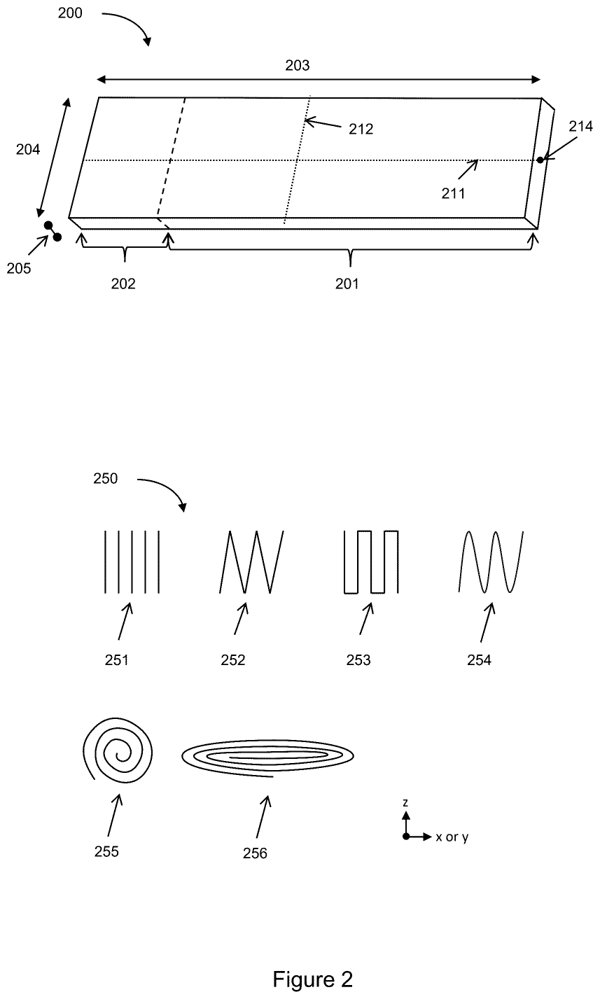

FIG. 2 shows a schematic example 200 of a current collector in the form of a film or strip. The electrode active material may contact (e.g., be deposited onto) a conductive sheet, e.g., having a thickness of at most about 6 millimeters (mm), 5 mm, 2.5 mm, 1 mm, or 0.5 mm. The conductive sheet may be a foil, e.g., having a thickness of at most about 0.4 mm, 0.2 mm, or 0.1 mm. The current collector may comprise an internal portion, e.g., when assembled in the battery. The internal portion of the current collector contacts the active material of the electrode. The tab may be (e.g., substantially) devoid of the electrode active material. The current collector has a length axis and a width, and a height. The current collector has a face type having a largest surface area, the face type including sections 201, and 202. The current collector has a length 203, a width 204, and a height 205. Section 202 designates the tab of the current collector that can bend upon assembly of the energy storage device such as to couple with a busbar, and section 201 designates the planar section of the current collector that can be coupled to an electrode active material, e.g., a powder with binder(s) and/or filler(s). In the example shown in 200, the tabs assume the same width 204 along their length. In some embodiments, the tabs contract (e.g., narrow such as taper) along their length, e.g., and along the longest axis 211. Longest axis 211 of the current collector intersects position 214 on a face of the electrode having height 205 and width 204, which face has the smallest surface area in the example of 200. The current collector has a shorter axis 212 normal to axis 211. The contraction of the tabs along axis 211 may be symmetrical about axis 211, e.g., using a mirror symmetry, the mirror being along axis 211.

In some embodiments, the current collector may be an anode current collector. In some embodiments, the current collector may be a cathode current collector. The anode current collector may comprise a conductive material such as copper, carbon, nickel, stainless-steel, cobalt, titanium, and tungsten, and alloys thereof, or any other material suitable as an anode current collector layer. The current collector has an electrical conductivity of at least about 103 Siemens/cm, 104 Siemens/cm, or 105 Siemens/cm. The current collector has an electrical conductivity between any of the aforementioned values, e.g., from about 103 Siemens/cm to about 105 Siemens/cm. The cathode current collector may comprise aluminum, nickel, cobalt, titanium, and tungsten, or alloys thereof, or any other material suitable for use as a cathode current collector layer. In some embodiments, the cathode current collector comprises a metal such as aluminum, carbon, chromium, gold, nickel, NiP, palladium, platinum, rhodium, ruthenium, an alloy of silicon and nickel, titanium, or a combination thereof. In an example, a cathode current collector comprises gold or an alloy thereof such as gold silicide. By way of further example, in one embodiment, a cathode current collector comprises nickel or an alloy thereof such as nickel silicide.

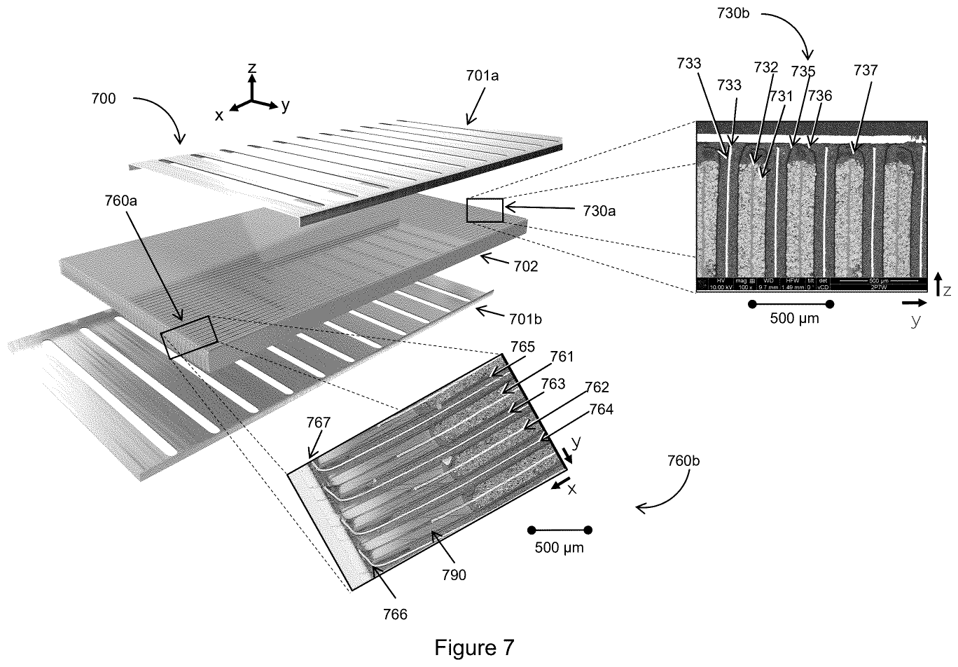

FIG. 2 shows in example 250, a schematic vertical cross section of various batteries, showing arrangement and/or folding of battery cells with respect to a Cartesian coordinate system. In example 251, battery cells are arranged parallel to each other. Examples 252-255 show various folding of a sheet comprising one or more battery cells, with 252 showing a zigzag fold, 253 showing a top hat fold, 254 showing a sinusoidal type fold, 255 showing a spiral (e.g., rolling) fold, and 256 an oval or oblong spiral (e.g., rolling) fold. The battery may comprise a battery cell folded in a wound (e.g., jelly roll) configuration having an oblong or cylindrical configuration, e.g., as shown in FIG. 7, 750.

In some embodiments, one or more cells are disposed within a housing to form the device, e.g., battery. The housing may insulate the battery from one or more reactive agents (also referred to herein as “reactive species”) in the ambient environment external to the device. The reactive agent(s) may comprise oxygen, water, alcohol, thiol, sulfuric acid, phosphoric acid, carboxylic acid, hydrogen sulfide, any plurality thereof, or any combination thereof. The reactive agent(s) may be oxygen based, sulfur based, and/or phosphorous based. The reactive agent(s) may include water and/or oxygen. In an example, the reactive agent(s) comprise water in a liquid and/or vapor form. The water may be in the form of droplets. The housing may be configured to separate and/or insulate the cell(s) from the reactive agent(s) present in the ambient environment external to the device, e.g., to curtail (e.g., hinder, or prevent) reactive agent(s) from reaching the cell such as including reaching the electrode(s) and any fuse of the device.

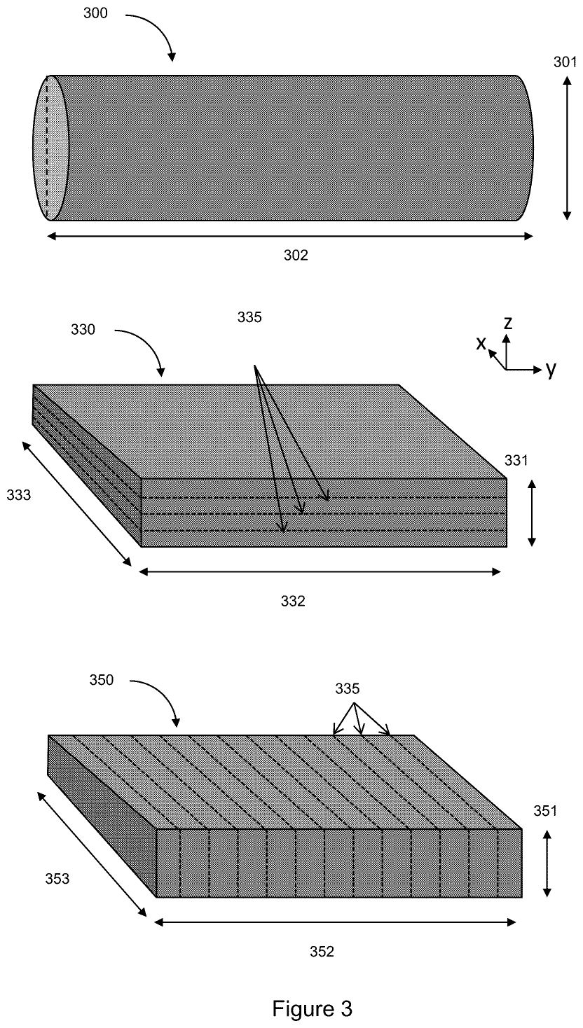

The energy manipulation device is of a (e.g., Euclidean) three-dimensional (3D) geometric shape. The device may have an asymmetrical shape, e.g., its housing may be asymmetrical in shape. The Euclidean 3D shape may comprise a cylinder or a prism. The prism may be a Euclidean prism, or an amorphous prism. In some embodiments, the battery is a prismatic battery. In some embodiments, the battery is a cylindrical battery. The battery may have a first FLS such as a height (e.g., FIG. 3, 331) of at least about 1 millimeters (mm), 2 mm, 3 mm, 5 mm, 6 mm, 8 mm, or 10 mm. The first FLS of the battery may be of any value between any of the aforementioned values, e.g., from about 1 mm to about 10 mm. The battery may have a second FLS such as a length (e.g., FIG. 3, 332) of at least about at least about 10 millimeters (mm), 50 mm, 100 mm, 150 mm, or 200 mm. The second FLS of the battery may be of any value between any of the aforementioned values, e.g., from about 10 mm to about 200 mm. The battery may have an aspect ratio of the second FLS to the first FLS of at least about 5:1, 8:1, 10:1, 15:1, 20:1, 25:1, 35:1, or 50:1. The battery may have an aspect ratio of the second FLS to the first FLS between any of the aforementioned values, e.g., from about 5:1 to about 50:1.

FIG. 3 shows schematic perspective view examples of energy manipulation devices such as batteries and battery cell architectures therein, relative to a Cartesian coordinate system. Example 300 shows a cylindrical battery housing having a length 302 and height 301, which is a diameter. The battery may comprise cell(s) that form a rolled sheet. In example 300, each of the bottom and top faces of the cylinder has a smaller surface area as compared to the side surface of the cylinder—to the curved surface of the cylinder. Example 330 shows a prismatic battery housing that is a rectangular prism, or a cuboid. The battery has length 332, height 331, and width 333. Battery cells 335 are stacked in the battery along height 331, and along the Z direction. In example 330, face XY has a larger surface area than face XZ, and face XY has a larger surface area than face YZ. Example 350 shows a prismatic battery housing that is a rectangular prism, or a cuboid. The battery has length 352, height 351, and width 353. Battery cells 335 are stacked in the battery along length 352, and along the X direction. In example 350, face XY has a larger surface area than face XZ, and face XY has a larger surface area than face YZ.

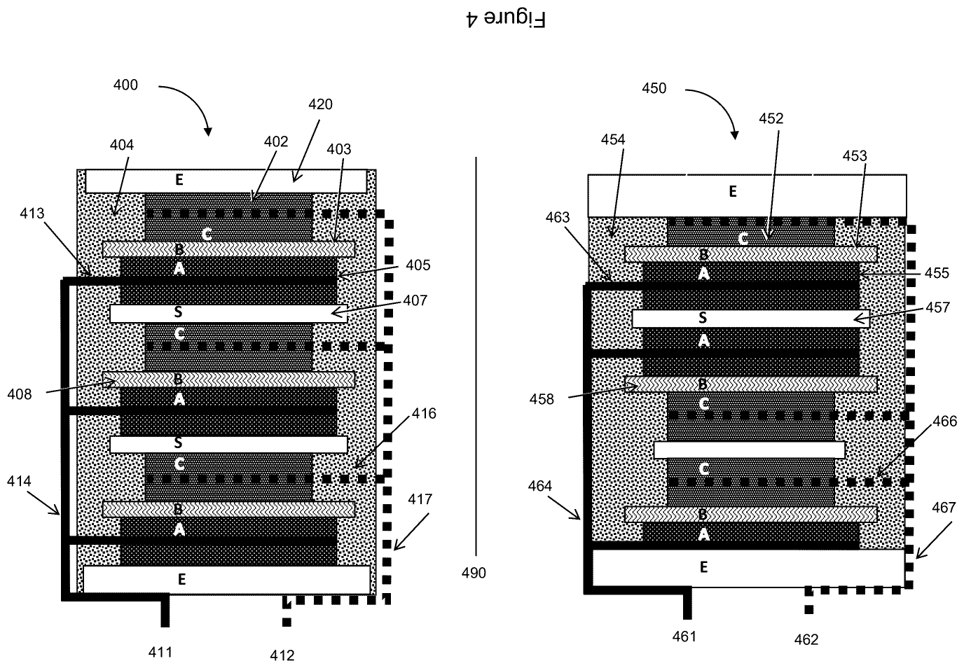

In some embodiments, the device such as battery comprises battery cells. The battery cells may be stacked along an axis. A dividing space may be disposed between every two immediately adjacent cells such that a first cell contacts the first face of the dividing space, and a second cell contacts a second face of the dividing space opposing its first space. The dividing space may comprise an insulator, e.g., any insulator disclosed herein. The insulator may or may not comprise the dynamic insulator. The dividing space may be configured to electrically separate one cell from another. The stack of cells may follow a pattern; the pattern may comprise a sequence. The sequence may comprise an arrangement of components of the battery cell with respect to each other. The sequence may comprise an anode, a separation space, a cathode, and a dividing space. The sequence may follow a CBAS pattern, or a CBASABCS pattern, with “C” designating a cathode, “B” designating a separation space, “A” designating an anode, “S” designating the dividing space, and “E” designates an end plate, e.g., see FIG. 4. The cells may be stacked in one or more groups. The separation space may comprise two opposing faces. A face of the separation space contacting the anode, and an opposing face contacting the cathode. The cell may comprise components comprising an anode, a cathode, a separation space, and an optional dividing space. The dividing space may comprise the same type of material as the separation space. The dividing space and the separation space may be (e.g., substantially) the same. The components of the cell may be disposed along an axis. The components of the cell may be (e.g., substantially) symmetrically arranged along the axis, e.g., in mirror symmetry, the mirror plane running along the axis, and/or in a rotational symmetry, the rotational axis running along the cell stacking axis (e.g., parallel to axis 490 in FIG. 4). At least two components of the cell may extend in a direction (e.g., substantially) perpendicular to the cell stacking axis at a (e.g., substantially) same distance. At least two components of the cell may extend in a direction (e.g., substantially) perpendicular to the cell stacking axis (e.g., laterally) at a different distance from that axis. The different distance extension of the components can form a corrugated (e.g., misaligned) face of the cell, and of the set of cells, e.g., as depicted in FIG. 1, 120. See also sides (e.g., edges) of cell sets in FIGS. 4, 400, and 450. In an example, the cathode extends less than the anode, the extension being in a direction perpendicular to the cell stacking axis. In an example, the separation space extends more than the anode and/or more than the cathode, the extension being in a direction perpendicular to the cell stacking axis. The endplate and the rigid constraint portion may be of the same material type or of different material types. For example, the endplate and the rigid constraint portion may comprise stainless steel. For example, the rigid constraint portion may comprise stainless steel (e.g., SS-301 or SS-316), and the endplates may comprise aluminum. The rigid constraint portion may comprise stainless steel, or Inconel. Any portion of the constraint system (e.g., the rigid constraint portion) may comprise a coating, e.g., a lacquer. The coating may comprise ClearClad, polyimide, or an electrodeposition coating. The electrodeposition coating may comprise Shimizu type coating. The coating may hinder deposition of charge carrier plating such as lithium plating, e.g., during use of the cell assembly.

FIG. 4 shows a schematic cross-sectional example 400 of a battery comprising cathode 402, anode 405, separation space 403, and dividing space 407. The battery cells are disposed in volume 404 of the battery that can include an insulator such as a dynamic insulator. The battery cells are stacked along an axis 490, in a repeating CBAS arrangement. Each anode “A” in the battery includes an anode current collector such as 413, the anode current collectors being coupled in parallel to a main anode current collector 414—an anode busbar, ending with anode contact 411 forming a terminal tab. Each cathode “C” in the battery includes a cathode current collector such as 416, the cathode current collectors being coupled in parallel to a main cathode current collector 417—cathode busbar, ending with cathode contact 412—terminal cathode tab.

FIG. 4 shows a schematic cross-sectional example 450 of a battery comprising cathode 452, anode 455, separation space 453, and dividing space 457. The battery cells are disposed in volume 454 of the battery that can include an insulator such as a dynamic insulator. The battery cells are stacked along an axis 490, in a repeating CBASABCS arrangement. Each anode “A” in the battery includes a current collector such as 463, the anode current collectors being coupled in parallel to a main anode current collector 464 (e.g., busbar), ending with anode contact 461—terminal anode tab. Each cathode “C” in the battery is operatively coupled (e.g., connected) with a cathode current collector such as 466, the cathode current collectors being coupled in parallel to a main cathode current collector 467 (e.g., busbar), ending with cathode contact 462—terminal cathode tab. In FIG. 4, the main cathode current collector is disposed on a different face of the set of cells as the main anode current collector, which is the opposing face.

In some embodiments, the battery comprises one or more main current collectors, e.g., as disclosed herein. The main current collector may include a busbar and/or a busbar extender. The main current collectors may or may not contact the insulator covering the edges of the cells. In the example shown in FIG. 4, 400, the main current collectors 417 and 414, are separated from the insulator 404 by a gap. In the example shown in 400, the main current collectors 417 and 414 contact the insulator 404.

In some embodiments, an end plate is disposed at a distal end of a cell set, e.g., at opposing distal ends of the set of cells and along the cell's stacking axis (e.g., FIG. 4, 490). FIG. 4, 400 shows an example of two opposing end plates disposed at both distal ends of a set of stacked cells, the end plates designed by “E,” the end plate 420 contacting the insulator at its opposing lateral ends. FIG. 4, 450 shows an example of two opposing end plates disposed at both distal ends of a set of stacked cells, the end plates designed by “E,” the end plate is devoid of the insulator at its two opposing lateral ends—normal to stacking axis 490.

In some embodiments, an energy storage device such as a battery, comprises a plurality of cells. Each of the cells comprises an anode separated by a gap from a cathode. The gap may comprise a separator. The cell may comprise one or more electrolyte types. Each of the electrodes (e.g., anode and cathode) comprises a current collector, e.g., a strip, a foil, or a film, of conductive material on which the active electrode material is disposed of. The conductive material may comprise an elemental metal, a metal alloy, or an allotrope of elemental carbon. In an example, the elemental metal comprises aluminum or copper. In an example, the metal alloy may comprise stainless steel. In an example, the allotrope of elemental carbon may comprise carbon nanotubes, or carbon fibers. The tubular structures (e.g., nanotubes) may comprise nestled tubes, e.g., at least about 2, 3, 4, or more nestled tubes. The carbon fibers may be weaved, randomly dispersed, or any combination thereof. The strip of conductive material may or may not comprise a composite material. At least two cells in the energy storage device (e.g., battery) may be stacked in a direction (e.g., substantially) normal to their face having the largest surface area. The electrode has an electrode face having the largest surface area, and the counter-electrode has a counter-electrode face having the largest surface area. In some embodiments, there is a difference in a volume of the cell between a state of charge and a state of discharge of an electrode of the cell. The volume of the cell may repeatedly and/or reversibly alter between the state of charge and the state of discharge repeatedly. The reversible discharge may not be completely reversible, e.g., there may be an attrition in the properties of one or more components of the cell during a cycle of charge/discharge. The repeated cycling between the state of charge/discharge may comprise at least about 150 cycles, 200 cycles, 250 cycles, 300 cycles, 400 cycles, 500 cycles, 700 cycles, 800 cycles, 1000 cycles, 1200 cycles, or 1500 cycles. The repeated cycling between the state of charge/discharge may comprise any value of cycle between any of the aforementioned cycles, e.g., from about 150 cycles to about 1500 cycles. In some embodiments, there is a difference in a volume of the cell between a state of charge and a state of discharge of an electrode of the cell. The change in volume may comprise a change in at most about 20*, 25*, 50*, 100*, 200*, 300*, or 400* of an initial volume of the cell. The change in volume may comprise a change in at least about 10*, 25*, 50*, 100*, 200*, or 300* of an initial volume of the cell. The change in volume may comprise a change in any of the aforementioned values, e.g., from about 10* to about 400*, from about 100* to about 400*, or from about 20* to about 200*. The symbol “*” designates the mathematic operation of multiplication.

The energy storage device may comprise at least one constraint (e.g., a brace, or a harness). The constraint may be configured to (e.g., substantially) maintain constant dimensions and/or volume of the device during the charge/discharge operations. The constraint may be configured to maintain internal pressure in the device, e.g., during the charge/discharge operations. The internal overpressure in the device may be at most about 100PSI, 150PSI, 200PSI, 500PSI, 1000 PSI, 2000 PSI, 3000 PSI, 5000PSI, or 10000PSI. The internal overpressure in the device may be at most about 50 PSI, 100PSI, 150PSI, 200PSI, 500PSI, 1000 PSI, 2000 PSI, 3000 PSI, or 5000PSI. The internal overpressure in the device may be between the above referenced pressures, e.g., from about 50PSI to about 10000 PSI, from about 50PSI to about 500PSI, or from about 50PSI to about 2000PSI, or from about 100PSI to about 3000PSI. The internal overpressure in the device may be greater than the ambient pressure external to the device, e.g., above 14.6 PSI. In some embodiments, the energy storage device has a face type having the largest surface area among its face types. The face a face type having the largest surface area may deform (e.g., bend) during the, or as a consequence of, the overpressure phase. The face type having the largest surface area may (e.g., substantially) reversibly deform during the life of the device. Substantial reversal of the face's deformation may be within the specification and/or intended use of the device.

In some embodiments, the battery cell set is disposed in an orthogonal stacked configuration.

In some embodiments, the device comprises a constraint system. The constraint system may be applied over one or both of the X-Y surfaces of the device (e.g., battery). In some embodiments, the constraint system includes a plurality of perforations to facilitate distribution (e.g., by flow of) an electrolyte solution after the cell, or cell set, has been assembled. In some embodiments, the casing comprises stainless steel, aluminum, titanium, beryllium, beryllium copper (hard), copper (O₂ free, and/or hard), nickel, other metals or metal alloys, composite, polymer, ceramic, any plurality thereof, any combination thereof, or any other suitable material as applicable.

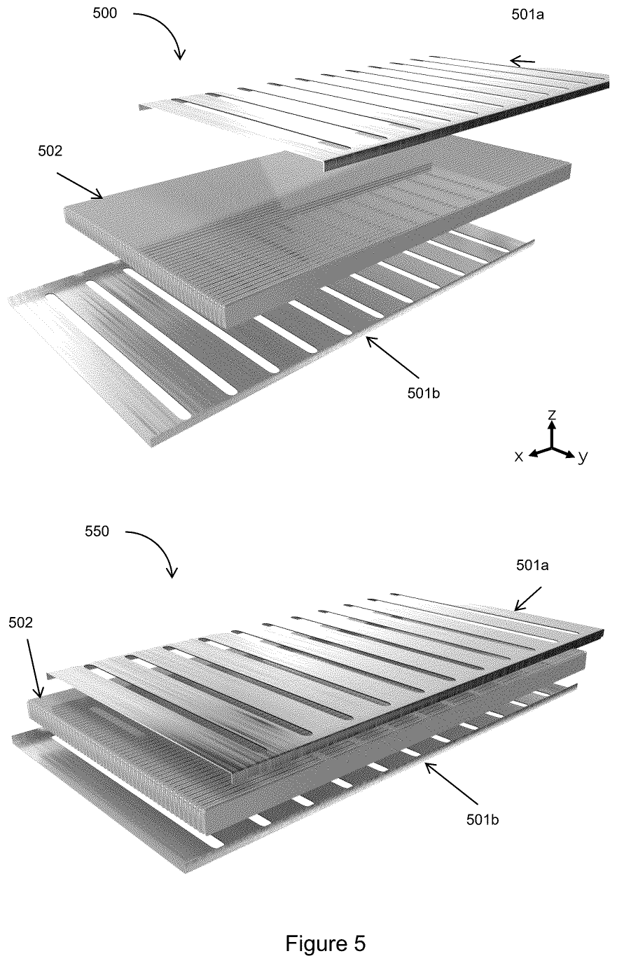

FIG. 5 shows in example 500 an exploded view of a pair of constraints 501a and 501b encasing a set (e.g., a population) of stacked battery cells 502, the pair of constraints being part of a constraint system. Example 550 shows an exploded view in which the two constraints 501a-b are closer to the stacked cell set 502. FIG. 5 is shown with respect to a Cartesian coordinate system. Each of the constraints may curb expansion of the battery cells during charge and/or discharge. Curbing the expansion may or may not be anisotropic. In the example shown in FIG. 5, the constraint can deter expansion of the cells anisotropically along the Y axis.

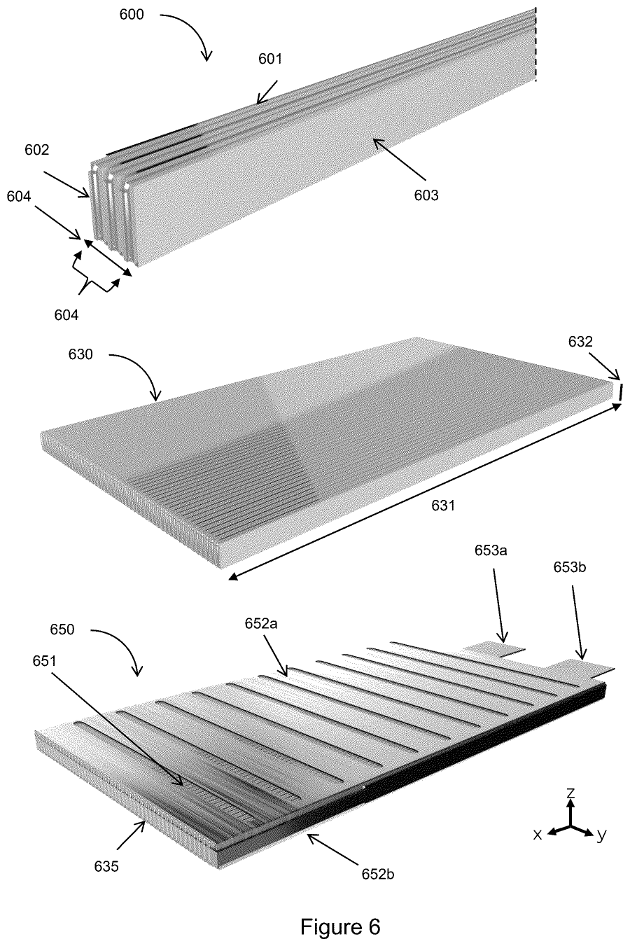

In some embodiments, the cell comprises an anode separated by a gap from an anode. The cell may comprise a separator disposed in the gap. The cells may be elongated, e.g., an elongated box. The face of the cell opposing the largest surface area face of the electrode (e.g., anode or cathode) may have an aspect ratio of at least about 10:1, 15:1, 20:1, 35:1, or 50:1, the aspect ratio being a length (e.g., FIG. 6, 631) of the face to a height (e.g., FIG. 6, 632) of that face. The cell may have an aspect ratio between any of the aforementioned values, e.g., from about 10:1 to about 50:1, the aspect ratio being the length of the cell to the height. The cell may have an aspect ratio of at least about 5:1, 8:1, 10:1, 15:1, 20:1, 25:1 35:1, or 50:1, the aspect ratio being a height (e.g., FIG. 6, 632) of the cell to a width (e.g., FIG. 6, 604, showing a width of three cells). The cell may have an aspect ratio between any of the aforementioned values, e.g., from about 5:1 to about 50:1, the aspect ratio being the height of the cell to the width.

FIG. 6 shows in example 600 a lateral portion of three cells, each comprising an electrode such as 601, a counter electrode such as 603, and a separator 602 disposed between each immediately adjacent pair of electrode and counter electrode. In example 600, the electrode (e.g., 601) extends less than the counter electrode 603 to the lateral edge 604 of the stacked cells, with the separator extending more towards the edge than the electrode, and then the counter-electrode, e.g., thus forming a corrugated, or wavy, lateral edge 604. Example 630 shows a stack of cells, e.g., in which the cells are horizontally stacked. The stacking axis of the cells may be parallel to a face of the cell having the largest surface area, e.g., of a prismatic battery such as a rectangular box.

Example 650 shows a set of stacked cells 651 enclosed by two opposing casings 652a and 652b. Current collectors of the stacked cells are coupled with connectors 653a and 653b. 653a connect to the electrodes of the set of cells, and 653b connects to the counter-electrodes of the set of cells. The cells enclosed by the casings (e.g., housing or case), are further secured by a flexible material 655, e.g., a band. The flexible material may comprise a polymer or a resin. The flexible material may be an electrical insulator. The casing may comprise one or more openings. In the example of FIG. 6, casing 652a includes oblong openings, e.g., that are evenly spaced along the X direction. FIG. 6 is shown with respect to a Cartesian coordinate system.

FIG. 7 shows in example 700 an exploded view of a pair of constraints 701a and 701b of a constraint system encasing a set (e.g., a population) of stacked battery cells 702. Each of constraints 701a-b includes oblong openings, e.g., that are evenly spaced along the X direction. FIG. 7 is shown with respect to a Cartesian coordinate system. The constraint may form a cage, e.g., having one or more openings such as slits, e.g., oblong silts or holes.

In some embodiments, the cell is configured with at least one gap portion that can be occupied during expansion of the active material. The gap may be between the electrode and counter electrode, or adjacent to an edge (e.g., side) of the electrode. Some of the cells described herein comprise gaps located adjacent to the electrode(s), e.g., at side(s) of the electrode(s). These gaps may enable electrolyte to flow into the gaps, e.g., during buffering. Accordingly, when the starting material is added to the device (whether in an active or inactive state), the starting material can occupy these gaps.

In some embodiments, the architecture of the cell assembly comprises spacer members. The spacer member may comprise, e.g., a tape, disposed along a stacking axis. The cathode is laterally shorter than the anode along the stacking axis. The spacer members may be disposed at both opposing sides of the cathode current collector. The positioning of the spacer members may be selected to align the cathode height with the anode height. Each spacer member may be at least about 45 μm, 50 μm, or 55 μm in width along the stacking axis. Each spacer member may be at most about 75 μm, 78 μm, or 80 μm in width along the stacking axis. Each spacer member may be of any value between the aforementioned values, e.g., from about 45 μm to about 80 μm. The lower range values may correspond to configurations in which, e.g., a fuse support is incorporated into the stack. The higher range values may correspond to configurations with a minimal fuse support.

Example 730b is a microscope image of section 730a. The image shows a set of cells comprising (a) anodes including (i) anode active material such as 731 and (ii) anode current collector such as anode current collector 732; (b) anodes including (iii) anode active material such as 733 and (iv) cathode current collector such as cathode current collector 734; (c) separators such as separators 735 and 736; and (d) insulating material such as 737. The insulating material 737 is disposed in a side gap at the edge of the electrode. Each cathode is separated from its immediately adjacent anode by a gap; the separator is disposed in the gap. In the example shown in 730, a pair of immediately adjacent separators are separated from each other. The separators extend more toward an edge of the set of cells, as compared to the cathode, which extends more towards the edge than the anode. The insulator is disposed in the volume between the set of cells and the edge of the set of cells. The ends of the separators along the z direction alternate between a first pair of immediately adjacent separator ends pointing towards each other, and a second pair of immediately adjacent separator ends pointing away from each other, the ends being along the z direction. For example, the ends of separators 735 and 736 point towards each other. Each anode and cathode in the cell interlace each other along the y direction (e.g., are disposed alternatively), which is the stacking direction of the cells. In the example shown in 730b, (a) the active anode material is disposed at both sides of the respective anode current collector and (b) the active cathode material is, disposed at both sides of the respective cathode current collector, the sides being along the z direction. In the example shown in 730b, (a) the active anode material is disposed on both side of the anode current collector such that it (e.g., substantially, schematically and/or generally) forms a mirroring plane for the anode active material, and (b) the active cathode material is disposed on both side of the cathode current collector such that it (e.g., substantially, schematically and/or generally) forms a mirroring plane for the anode active material.

Example 760b is a microscope image of section 760a. The image shows a set of cells comprising (a) anodes including (i) anode active material such as 761 and (ii) anode current collector such as anode current collector 762; (b) anodes including (iii) anode active material such as 763 and (iv) cathode current collector such as cathode current collector 764; (c) separators such as separator 765. Each cathode is separated from its immediately adjacent anode by a gap; the separator is disposed in the gap, the gap being along the stacking axis. In the example shown in 760a and 760b, the cathode active material extends to the edge of the cell in the X direction, and bends towards the Y direction to electrically connect its immediately adjacent cathode current collector along the Y direction. The bend portions (e.g., tabs) of the cathode current collectors are joined by a material operatively (e.g., electrically) coupling the tabs, including a tacky connector 767, to form a busbar. In the example shown in FIG. 7, the cathode contacts the separator that contacts the anode, which contacts any additional separator in the set of cells. Endplates may be disposed at both end of the set of cells along the stacking direction, e.g., along the Y direction. FIG. 7 shows a spacer member 790. The spacer member 790 is disposed along a stacking axis of the cell assembly. The spacer member 790 is positioned on opposing lateral sides of the cathode current collector 764 (along X axis), e.g., to align the cathode lateral length with an anode lateral length, the lateral axis being normal to the stacking axis (along Y axis). The spacer member 790 has a longitudinal dimension along the stacking axis corresponding to a range of about 45 μm to about 80 μm.

In some embodiments, the interior of the casing is separated from an exterior of the casing, e.g., to hinder reactive specie(s) in the external environment to traverse to the interior environment such as to cause the harm. Terminals configured to conduct the electrical current flow are configured to allow electrical connectivity of the external environment with the cell(s) disposed in the interior of the housing. The housing comprises a seal to separate the interior environment of the housing from its exterior environment. The terminals extend through the seal from the interior of the housing to the external environment. Each of the terminals can be coupled with the housing (e.g., at the seal area) by coupler. The coupler may comprise a compressible material such as a malleable material. The terminal may be secured to the housing by an adhesive, e.g., at the seal. The terminal may be secured to the seal at least in part by the adhesive and/or by the compressible material. The compressible material may be an adhesive. The compressible material and/or the adhesive, may comprise a polymer, a resin, a combination thereof, or a plurality of types thereof. The adhesive may be (e.g., substantially) confined to the seal. The adhesive may comprise polypropylene or epoxy glue. The fuse may be reinforced by an adhesive, e.g., to any portion of the device such as disclosed herein. The fuse may be located (e.g., and reinforced to) a portion of the device sufficiently distant from susceptible material(s) such that when the fuse activates, the harm will not be made due to activation of the susceptible material(s). The susceptible material may participate in the chemistry of the device, e.g., of the cell. The susceptible material(s) may comprise any of the active materials of the cell, any electrolyte, any separator, any insulator, any divider, any current collector, any busbar, any adhesive, any plurality (e.g., of types or otherwise) thereof, or any combination thereof. The compressible material may be disposed in the seal, in an interior of the housing, in the exterior of the housing, or any combination thereof. In some embodiments, the terminal is compressed by the compressible material, which is compressed by the seal of the housing.

In some examples, the battery is disposed in a housing comprising a pouch. The pouch may insulate the battery content (e.g., the cell therein) from one or more reactive agent in the ambient environment external to the pouch. The pouch may enclosure the case of the battery, and the cell(s) housed therein. The pouch may comprise one or more layers. The one or more layers may include a material comprising a polymer, a resin, an elemental metal (e.g., strip, film, foil, and/or powder thereof), or a metal alloy (e.g., strip, film, foil, and/or powder thereof). The one or more layers may include one or more of these materials. The pouch may have an external surface having a color comprising black, silver, or white.

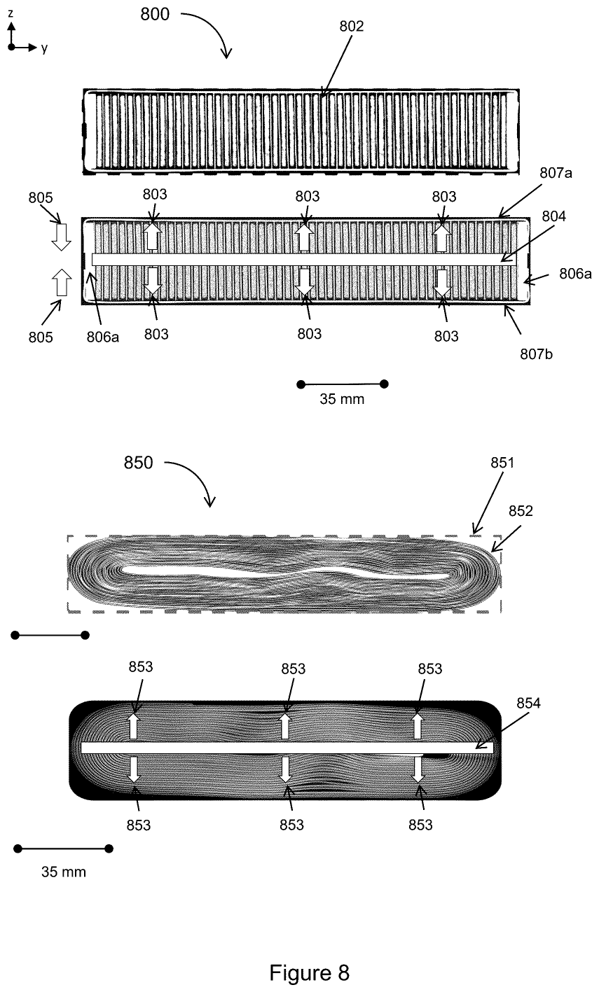

FIG. 8 shows an example of vertical cross sections of various batteries with respect to a Cartesian coordinate system, viewed from a side having a length and a height (e.g., FIG. 3, height 351 and length 352), and depicted as a cross section. Example 800 shows battery cells such as cell 802 stacked in a direction normal to the z axis, the battery having housing 801. During a charge and discharge cycle, the battery expands and contracts. The expansion creates a force in the battery in a direction perpendicular to the stacking direction of the cells and toward the edges of the battery (e.g., along arrows 803), and in a direction along the stacking axis such as along 804. Constraints 807a and 807b are coupled with the cell stack to curb expansion. The constraints may limit displacement along the direction of arrows 803 and along 804. The constrain may anisotropically constraint the expansion of the cell stack. The constraints 807a-807b are disposed opposing each other and separated by a gap. Endplates 806a and 806b are disposed between the constraint and the cell stack. Each endplate may contact a distal end of the cell stack along the stacking direction. The endplates and the constraints may be arranged in a mirror symmetry about the stacking axis. The contraction and expansion may cause pressure buildup inside the battery. Heat may be generated during charge and discharge cycles, e.g., in interior of the cell stack such as along 804. The heat may be dissipated from the battery along arrows 803, increasing operational safety by reducing the risk of thermal runaway. Charge carriers generated from a precursor card may diffuse into the cell stack in the direction of arrow 805 (e.g., from locations corresponding to arrows 803). Diffusion of charge carriers may occur through perforations in the constraint system (e.g., perforation 651 of FIG. 6).

In some embodiments, one or more cells are enclosed in a rigid enclosure. The rigid enclosure may comprise the constraint system and/or endplates. The enclosure may comprise an elemental metal, a metal alloy, an allotrope of elemental carbon, a polymer, a resin, a plurality of types thereof, or any combination thereof. The housing may be made of a material with greater, lesser, or (e.g., substantially) equal hardness compared to the enclosure. In an example, the housing may comprise a pouch having a lower hardness than a rigid enclosure such as a can. The pouch may be nested inside a harder housing (e.g., a can). A protective layer may be disposed between the enclosure and the housing, e.g., FIG. 6, 635. The protective layer may comprise an elastic material, a polymer, a resin, a plurality of types thereof, or any combination thereof. The protective layer may form a band around the sides of the enclosure. The sides may include types with relatively smaller surface area. The protective layer may have a thickness, elasticity, and/or durability sufficient to cushion physical interaction between the housing and the enclosure. The protective layer may have a sponge-like geometry. The layer may be porous or non-porous. The protective layer may include polyurethane, polypropylene, polyethylene, and/or rubber. The layer may be attached to the enclosure by adhesion or by compression. The protective layer may be a pouch protective layer (PPL).

In an example, charge carriers and/or an electrolyte mixture are introduced into one or more cells from outside the cell assembly and within the housing. The entering materials may enter from outside the constraint system, outside the endplates, and/or from within the housing (e.g., pouch and/or can). Entry may occur from a seal, a surface of the housing, or a protective cell layer. Entry may occur by diffusion along a concentration gradient. When the starting material enters from a side of the battery having the largest surface area (e.g., top or bottom surface in example 650 of FIG. 6), diffusion may proceed inward toward the stack interior (e.g., towards 804 and opposing the directions of arrows 803 in FIG. 8). Entry may be faster when the stack includes elongated cell components with a high aspect ratio of height (e.g., 351) to width—lateral length (e.g., 353), disposed along a face-parallel axis. Entry from a constraint-facing direction (e.g., 807a-807b) may provide faster access to the cell assembly's center, than entry from a direction orthogonal to 803 (e.g., facing the wide surface of the electrodes).

Example 850 shows battery cell 852 rolled upon itself about an axis normal to the page (e.g., jelly roll configuration). Battery cell 852 is disposed in housing 851. During a charge and discharge cycle, the battery expands and contracts. Expansion generates force in the direction perpendicular to the roll axis and toward the battery edges (e.g., along arrows 853). One or more constraints may be added to control the expansion. The contraction and expansion may produce internal pressure. Heat may accumulate in stack interior 854. The heat may be released from the battery along arrows 853. The stacked cell layout shown in example 800 may provide improved thermal conductivity compared to the rolled configuration of example 850. The stacked cell layout shown in example 800 may provide improved diffusion for the entering materials compared to the rolled configuration of example 850. The stacked cell layout shown in example 800 may provide improved diffusion for the entering materials compared to the rolled configuration of example 850.

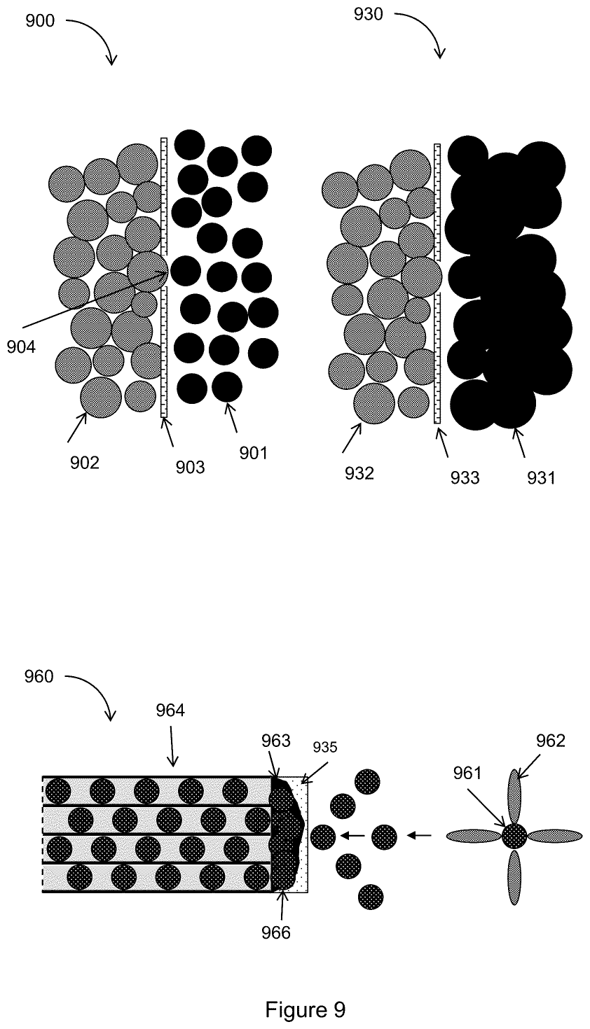

FIG. 9 schematically shows a cause for the expansion and contraction of a cell during charge and discharge states. Example 900 shows an anode discharge states. Anode active material such as 901 is separated from cathode active material such as 902 by a gap in which separator 903 is disposed. The separator has a perforation (e.g., conduit such as a pinhole) through which charge carriers can transverse from one electrode to its counter electrode. Example 930 shows an anode charged state. Anode active material such as 931 is separated from cathode active material such as 932 by a gap in which separator 933 is disposed. As compared to the anode discharged state shown in example 900, the anode active material is inflated, e.g., expanded. The cathode active material is depicted as occupying (e.g., substantially) the same volume between the charged and discharged state.

Example 960 shows an anode in which charge carriers are provided. The charge carriers such as 961 (e.g., lithium cation) become surrounded by a mobile electrolyte 962 such as a fluid or semi-fluid electrolyte, e.g., solvent or gel. The charge carriers propagate through solid electrolyte interphase (SEI) 935. Deposition 963 of a reduced from of the charge carriers 966 may occur on at least one edge type of the set of cells (e.g., anode)—at its interface; followed by diffusion of the charge carriers into the electrode active material portion 964, e.g., comprising an allotrope of elemental carbon such as graphite. The deposition may comprise accumulation of the reduced form of the charge carriers at the interface. Due to the cell's arrangement having their stacking direction along the Y axis, and their edges pointing towards opposing sides along the X direction, it may be impractical to diffuse the charge carriers along the stacking axis, e.g., due to longer and/or inhomogeneous diffusion. In this cell set configuration, it may be more beneficial to allow the charge carriers to diffuse from one or both opposing side along the X axis. The stacked cells may span tenths of millimeters in the stacking direction, e.g., at least about 10, 50, or 100 millimeters. The cells may span a length along the X axis of at least about 1, 2, 3, 5, 6, or 8 millimeters. The cells may span a length along the X axis of at most about 2, 3, 5, 6, 8, or 10 millimeters. The cells may be held by a constraint system (e.g., FIG. 6, 650). The constraint system may comprise perforations (e.g., holes) that facilitate penetration of the charge carriers from a charge carrier source (e.g., metal) through the constraint, to the cells of the cell assembly, e.g., the holes in constraint system 501a and 501b. The source of the charge carriers may contact one or both opposing sides of the cell assembly. A charge carrier source can be positioned adjacent to the edge of the electrode stack. Diffusion of charge carriers may occur from the source through perforations in constraint portions. The perforations may correspond to holes in the constraint system, e.g., FIG. 5, 501a and 501b. The diffusion may proceed along the X direction to enter the stacked cells. The configuration may reduce inhomogeneous charge distribution and support direct interfacial delivery. The stacked cells may be held by a constraint system such as that shown in FIG. 6, example 650. The stacked cells may span at least about 10 mm, 50 mm, 100 mm, or 200 mm along the Y direction. The stacked cells may span at most about 200 mm, 300 mm, 400 mm, or 500 mm along the Y direction. The stacked cells may span any value between any of the aforementioned values, e.g., from about 10 mm to about 500 mm along the Y direction. The stacked cells may span at least about 1 mm, 2 mm, 3 mm, or 5 mm along the X direction. The stacked cells may span at most about 5 mm, 6 mm, 8 mm, or 10 mm along the X direction. The stacked cells may span any value between any of the aforementioned values, e.g., from about 1 mm to about 10 mm along the X direction. The set of cells in the cell arrangement may comprise at least 2, 10, 20, 50, 100, 150, 200, 250, or 500 cells. The set of cells may comprise any number of cells between the aforementioned number of cells, e.g., from 2 to 500 cells, or from 50 to 500 cells. The face of the cell opposing the largest surface area face of the electrode (e.g., anode or cathode) may have an aspect ratio of at least about 10:1, 15:1, 20:1, 35:1, or 50:1, the aspect ratio being a length (e.g., FIG. 6, 631) of the face to a height (e.g., FIG. 6, 632) of that face. The cell may have an aspect ratio of at least about 5:1, 8:1, 10:1, 15:1, 25:1 20:1, 35:1, or 50:1, the aspect ratio being a height (e.g., FIG. 6, 632) of the cell to a width (e.g., FIG. 6, 604, showing a width of three cells).

In some embodiments, the battery is a rechargeable battery. The battery may undergo cycles of charge and discharge, with one cycle including one change and one discharge operation. The capacity of the battery to store and/or release electrical charge may diminish over the number of cycles it undergoes, e.g., at least in part due to various chemical reactions occurring in the battery during cycling. The reactions may comprise depletion of essential components such as essential chemical(s) for the function of the battery, e.g., depletion of the charge carriers. At least one essential component may be depleted during the first electrolytic cycle of the battery—during buffering, the essential component(s) may comprise starting material for passivation layer of the active material, e.g., SEI layer on an anode active material.

In some embodiments, the energy manipulation device (e.g., battery) contains critical component(s) required for operation of the cell. The component may comprise a chemical. The critical components may initially be in optimized relative amounts in the battery. Some of the component(s) may enhance some performance attribute(s) while diminishing other attribute(s), e.g., making other attributes worse. A goal for cell performance could be to use an optimized amount of (e.g., critical) components to maximize the benefits while minimizing the drawbacks for best performance of the cell and/or device such as battery. Such optimization may differ in the buffering stage to the optimization in the performance stage—including at least two charging cycles.

For example, during charging of a cell, charge carriers move from the cathode to the anode. When charge carriers (e.g., lithium cations) come into contact with a starting material (e.g., FEC) they undergo a reduction reaction and form a stable solid electrolyte interphase (SEI) layer on the anode's surface. The SEI layer (e.g., significantly) improves the cycling stability of the batteries such as by preventing electrolyte decomposition, e.g., on the anode surface. Although formation of the SEI layer is requested for the stability of the battery, some of the starting materials (e.g., FEC) and the charge carriers become irreversibly bound, and thus removed from the cyclic operation of the battery, e.g., the rechargeable battery. Problems can arise due to the expanding and contracting of the electrode active material such as of the anode. In an example, the SEI layer is formed during charging, when the anode is expanded to a first size. As the battery discharges, the anode contracts to a second smaller size. In some examples, the SEI layer is not sufficiently elastic and as the anode contracts, the SEI layer cracks and/or breaks, thus exposing portions of the anode active material. Such problem may be exacerbated in batteries with electrodes comprising materials (e.g., Si, SiOx, Si—C, etc.) that have large volume differences between their charged and discharged states. The silicon content in the electrode may be at least about 5%, 10%, 15%, 20%, 40%, 50%, 80%, 90%, 95%, 97%, 98%, or 99% wt/wt. The silicon content in the electrode may be between any of the aforementioned percentages, e.g., from about 20% to about 99%, or from about 80% to about 99% wt/wt. In the next charging cycle, the SEI layer may become mended (e.g., clogged) to fix the cracks in the SEI layer caused in the previous cycle. Mending the SEI layer may require additional starting material amount (e.g., FEC), e.g., and charge carriers. In such scenario, the cycle of charging and discharging the battery may result in continual consumption of the starting materials, e.g., and of charge carriers. Buffering may be used to replenish the consumed charge carriers in such case. However, there are currently inadequate solutions to replenish the starting materials required, e.g., the FEC. When the FEC concentration decreases in the electrolyte (e.g., to allow for more cycles of mending the SEI layer), the higher FEC concentration may decrease the efficiency of the battery and/or cause safety concerns for the battery. Higher concentration of FEC may result in generating gas, e.g., the higher the temperature experienced by the battery. Concentrations of FEC above 40% could form solids that decrease the efficiency of the battery. Higher concentration of FEC may increase the impedance of the battery and/or increase the viscosity of the electrolyte. Increasing the viscosity of the electrolyte can reduce the travel rate of the charge carriers in the battery. The gas generated may comprise hydrogen (H₂), carbon dioxide (CO₂), carbon monoxide (CO), methane (CH₄), short aliphatic (e.g., CₓH_{2X+2} such as ethane), or any combination thereof. The active FEC concentration can be most about 0.5%, 1%, 5%, 10%, 15%, or 30% v/v. The active FEC concentration can be between any of the aforementioned percentage values, e.g., from about 1% to about 20%, from about 0.25% to about 30%, from about 0.25% to about 5%, from about 5% to about 15%, or from about 15% to about 30%. In an example, the cell has at most about 15% active FEC available in the electrolyte mixture.

The passivation layer may result from an electrochemical reduction of electrolyte component(s) (e.g., FEC) at the electrode interface. The passivation layer may allow charge carriers (Li+) transport through the passivation layer while hindering (e.g., blocking) electron flow, e.g., to hinder (e.g., prevent) decomposition of other electrolyte components. The passivation layer may stabilize the active material (e.g., of the anode) at least in part by hindering (e.g., impeding or substantially preventing) direct contact between the electrons and the other electrolyte components, thus reducing degradation of the electrolyte and improving cycle life. The passivation layer may comprise inorganic salts, e.g., LiF, Li₂CO₃, organic compounds (e.g., lithium alkyl carbonates, Fluoroethylene Carbonate (FEC) and vinylene carbonate (VC) polymerization products). Generation of the passivation layer may consume the charge carriers, e.g., irreversibly. Lithium may be converted into Lithium carbonate and lithium fluoride in the reduction reaction to form the passivation layer, which reaction may be irreversible.

In some embodiments, charge carriers (e.g., Li ions) reside in a cathode when the battery is in a discharged state, and reside in the anode when the battery is in a charged state. For example, when a battery charges, charge carriers (e.g., carrier ions) migrate into one or more electrode active materials. As the charge carriers traverse (e.g., move) in and out of the active material of the electrodes, the active material undergoes a volume change. The movement in an out of the active material may be referred to as ingress and egress of the charge carriers relative to the active material. The amount of expansion may differ depending on the active materials used for the electrode. For example, a graphite electrode may expand by about 6% to 10% when the graphite electrode is charged. In another example, a silicon electrode may expand up to 300% when the silicon electrode is charged. In another example, a silicon oxide electrode may expand up to 210% when the silicon oxide electrode is charged. In another example, an electrode comprising silicon may expand up to about 20%, 50%, 75%, 100%, 200%, 300%, or 350% when the silicon electrode is charged, the percentage being volume per volume. In some embodiments, graphite electrodes require less starting material (e.g., fluoroethylene carbonate (FEC)) than silicon electrodes because the graphite electrodes expand less.

In some embodiments, an energy storage device such as a battery, comprises a plurality of cells. Each of the cells comprises an anode separated by a gap from a cathode. The gap may comprise a separator. The cell may comprise one or more electrolyte types. Each of the electrodes (e.g., anode and cathode) comprises a current collector, e.g., a strip, a foil, or a film, of conductive material on which the active electrode material is disposed of. The conductive material may comprise an elemental metal, a metal alloy, or an allotrope of elemental carbon. In an example, the elemental metal comprises aluminum or copper. In an example, the metal alloy may comprise stainless steel. In an example, the allotrope of elemental carbon may comprise carbon nanotubes, or carbon fibers. The tubular structures (e.g., nanotubes) may comprise nestled tubes, e.g., at least about 2, 3, 4, or more nestled tubes. The carbon fibers may be weaved, randomly dispersed, or any combination thereof. The strip of conductive material may or may not comprise a composite material. At least two cells in the energy storage device (e.g., battery) may be stacked in a direction (e.g., substantially) normal to their face having the largest surface area. The electrode has an electrode face having the largest surface area, and the counter-electrode has a counter-electrode face having the largest surface area. In some embodiments, there is a difference in a volume of the cell between a state of charge and a state of discharge of an electrode of the cell. The volume of the cell may repeatedly and/or reversibly alter between the state of charge and the state of discharge repeatedly. The reversible discharge may not be completely reversible, e.g., there may be an attrition in the properties of one or more components of the cell during a cycle of charge/discharge. The repeated cycling between the state of charge/discharge may comprise at least about 200 cycles, 500 cycles, 800 cycles, 1000 cycles, 1200 cycles, or 1500 cycles. In some embodiments, there is a difference in a volume of the cell between a state of charge and a state of discharge of an electrode of the cell. The change in volume may comprise a change in at most about 20%, 25%, 50%, 100%, 200%, 300%, or 400% of an initial volume of the cell. The change in volume may comprise a change in at least about 10%, 25%, 50%, 100%, 200%, or 300% of an initial volume of the cell. The change in volume may comprise a change in any of the aforementioned values, e.g., from about 10% to about 400%, from about 100% to about 400%, or from about 20% to about 200%. The charge carriers may interact with the active material (e.g., comprising silicon) such as in an intercalation and/or alloying process (e.g., Li—Si alloying). The Li—Si alloying may form alloys comprising Li₁₅Si₄ or Li₂₂Si₅. The lithium alloying of silicon may allow silicon to store at least 5*, 10*, or 15* more lithium as compared to graphite, with the operation “*” designating the mathematical operation of “times.”

In an example, a passivation layer is formed during operation of the device (e.g., during buffering) that consumes charge carriers and soluble passivating material in the cell. Portions of the passivation layer may be (e.g., additionally) formed during regular operation of the device, e.g., during charging and discharging cycles.

In some embodiments, electrons are formed in an operation of the cell, which electrons can further react with cell component(s). As the charge carriers move in the battery (e.g., in the cell), electrons are also moving. The electrons may travel from the current collector to the active material coupled with the current collector. When the active material contacts the current collector, such movement of electrons may be direct. When the active material does not contact the current collector, the movement may be indirect. The indirect movement may be through another active material (e.g., particle), through a conductor, or through a semiconductor. In an example, an allotrope of elemental carbon facilitates the movement of electrons from the current collector to the active material and/or from an active material mass of an electrode to another active material mass of the electrode. The allotrope of elemental carbon may comprise carbon nanotube, carbon fiber, any plurality of types thereof, or any combination thereof. The electrons may react with one or more chemicals in the device such as in the cell, e.g., some of which reactions may be detrimental to the battery's chemistry such that they diminish (e.g., harm) the device's requested performance. For example, the electrons may destabilize metal oxides during the charge/discharge cycles, e.g., due to slippage of transition metal layers, phase transitions and/or electrochemical strain. Mitigation (e.g., reduction) of the reactivity of the electrons in the battery cell may include causing confinement of the electrons to retard (e.g., reduce, deter and/or substantially prevent) reaction of the electrons with the material(s) in the device, e.g., during the prescribe operation conditions of the battery and/or during the prescribed lifetime of the battery. Generation of a passivation layer that helps confine the electrons in the active material mass and/or impede their reaction with components of the device (e.g., of the cell) external to the passivation layer, may mitigate the harmful reactivity of the electrons.

In some embodiments, the device has prescribed conditions and/or a prescribed lifetime. Operation of the device (e.g., battery) may be during its prescribed lifetime, during its prescribed use, and/or according to jurisdictional standards relating to the device-related standards. The prescribed lifetime may depend at least in part on the number of charge and discharge cycles, e.g., as disclosed herein. The number of cycles may be to full charge before the capacity of the device (e.g., battery) drops below 80%. The prescribed lifetime may be of at most about 3 years, 5 years, 6 years, or 7 years, e.g., from the date of its manufacture. The device may have a shelf life of at least about 6 months, or 12 months. The standards may include, SAE J2380, MIL-STD-810G (516.6), UL (e.g., UL1642 and/or UL 2054), SAE J2380, GB31241, MSDS, UL (UL1642), CE, CB, UN (e.g., UN38.3), RoHS, REACH, IEC (e.g., IEC 60068-2-6, IEC 60068-2, and/or IEC62133), DOT, IATA, GB, CTIA, PSE, or any combination thereof. The prescribed operating conditions comprise temperatures between a lower temperature (e.g., −20° C.) and a higher temperature (e.g., 80° C.). The higher temperature may be of at most about 60° C., 70° C., 80° C., 85° C., or 90° C. The higher temperature may be of at least about 40° C., 50° C., 55° C., 60° C., 70° C., or 80° C. The lower temperature may be of at most about −10° C., −20° C., −30° C., −40° C., or −50° C. The lower temperature may be of at least about −20° C., −10° C., or 0° C. The temperature may be between any of the aforementioned values, e.g., from about 60° C. to about −20° C., or from about 90° C. to about −40° C. The device may retain at least about 70%, 80%, or 85% of its capacity the lower temperature as compared to its capacity at ambient temperatures, e.g., at room temperature such as 20° C. or 25° C.

In some embodiments, the energy manipulation device is rechargeable. The device may be configured to allow fast charging (e.g., allowing the cell(s) to fully charge in five minutes). The device may have a C-rate of at least about 0.2C, 0.5C, 1C, 2C, 3C, 5C, 7C, 10C, 12C, or 15C, 30C, or 40C. The C-rate may be charging the device to 80% capacity, or to 90% capacity. The device may have a C-rate of any value between any of the aforementioned values, e.g., from about 0.2C to about 40C, from about 02C to about 5C, from about 3C to about 30C, from about 1° C. to about 40C or from about 2C to about 7C. The device may be charged to at most about 30 sec, 3 min. 6 min. 10 min, 12 min, 15 min, 30 min, the charging being to 80% or to 90% capacity. The device may allow to choose the mode of discharge and/or of charge. The discharge and/or of charge, may be in a continuous mode, in a pulsed mode, or in a combination of a continuous mode and pulsed mode. In some embodiments, the battery has an N/P ratio greater than one. The N/P ratio may be at least about 1.05, 1.1, or 1.15. The cell configuration, cell set architecture, and/or chemical makeup (e.g., of the electrode active material(s)), may allow for buffering such as pre-lithiation. The cell, cell set, and/or battery disclosed herein, may facilitate maintenance of cyclable charge carriers (e.g., lithium) in the anode, e.g., also at beginning of charge (BOC). The cell, cell set, and/or battery disclosed herein may provide for better conductivity and/or for lower overpotential in anode deposited material (e.g., cake comprising the active material). The cell, cell set, and/or battery disclosed herein may provide for reduced (a) cycling window and/or (b) damage due at least in part to expansion and contraction during the charge and discharged states of the cell. The cell, cell set, and/or battery disclosed herein may provide for high voltage at BOC, e.g., without buffering, e.g., without pre-loading of the charge carrier into the active material of the electrode such as in a pre-lithiation process. The nominal voltage of the device may be at least about 3.6 Volts (V), 3.7V, 3.8V. The working voltage of the device may be at least about 3V, 3.7V, 3.8V, 4.0V, 4.2V, 4.35V, 4.5V, 4.75V, 4.9V, or 5.0V. The working voltage of the device may be between any of the aforementioned values, e.g., from about 3V to about 5V, from about 3V to about 4V, or from about 4V to about 5V. The weight of the device may be at most about 1 gram(gr), 1.5 gr, 1.8 gr, 2 gr, 3.5 gr., 6 gr, 46 gr, 47 gr, 50 gr, 69 gr, 70 gr, 71 gr., or 100 gr. The weight of the device may be at any value between any of the aforementioned values, e.g., from about 1.8 gr to about 100 gr. The volumetric density of the device may be at least about 800 Watt hour per liter (Wh/liter), 805 Wh/liter, 820 Wh/liter, 900 Wh/liter, 1300 Wh/liter, or 1500 Wh/liter. The gravimetric density of the device may be of any value between any of the aforementioned values, e.g., from about 800 Wh/liter to about 1500 Wh/liter. The volumetric density of the device may be at least about 300 Watt hours per kilogram (Wh/Kg), 320 Wh/Kg, 350 Wh/Kg, 395 Wh/Kg, 400 Wh/Kg, 500 Wh/Kg, 1000 Wh/Kg, 2000 Wh/Kg or 3000 Wh/Kg. The gravimetric density of the device may be of any value between any of the aforementioned values, e.g., from about 300 Wh/Kg to about 3000 Wh/Kg, from about 300 Wh/Kg to about 400 Wh/Kg, or from about 400 to about 3000 Wh/Kg. The electrical charge capacity of the cell may be of at least about 200 milliampere hours (mAmph), 240 mAmph, 280 mAmph, 600 mAmph, 1 Amper hour (Amph), 30 Amph, 50 Amph, or 70 Amph. The electrical charge capacity of the cell may be between any of the aforementioned values, e.g., from about 200 mAmph to about 800 mAmph, from about 200 mAmph to about 1 Amph, from about 1 Amph to about 30 Amph, or from about 30 Amph to about 80 Amph.

In some embodiments, the anode comprising silicon is thinner than an anode comprising graphite, e.g., has a smaller height—FIG. 2, 205. The anode height may be at most about 30%, 35%, 40%, 50%, 65%, 75%, or 80%, thickness (along the stacking axis) of a graphite anode for a for a given loading of anode active material. The anode height may be at least about 10%, 20%, 30%, 35%, 40%, 50%, 65%, or 70%, thickness (along the stacking axis) of a graphite anode for a for a given loading of anode active material. As compared to a graphite anode for a for a given loading of anode active material, the anode height may be between any of the aforementioned percentages, e.g., from about 10%, to about 70%, or from about 30% to about 70%. In an example, the height difference in graphite anode vs. silicon anode when discharged is 35%. In an example, the height difference in graphite anode vs. silicon anode is anode is 65% of the size of the graphite anode for a given loading, when each of the anodes is fully formed. A thinner anode may allow for better current distribution through the electrode and/or lower likelihood of charge carrier plating (e.g., reduction to its elemental state) such as lithium plating.

In some embodiments, the cell is pre-loaded with charge carriers, e.g., to form an initial passivation layer. During the initial charge process (e.g., buffering such as pre-lithiation), certain starting materials (e.g., FEC) are consumed to contribute to the formation of a passivation layer, e.g., an SEI layer. The passivation layer may be the result of the electrons and/or charge carriers reacting with the electrolyte in a reduction reaction. In some embodiments, the electrolyte(s) is/are chosen such that the reduction reaction results in the passivation layer having certain properties. For example, the passivation layer may comprise a solid or semisolid (e.g., gel). The passivation layer may be porous, e.g., to allow the charge carriers to migrate into and out of the electrode active material, e.g., silicon and/or graphite. The passivation layer may allow charge carriers (e.g., Li+) to pass through it while hindering (e.g., blocking) electron flow, to reduce (e.g., prevent) decomposition of electrolyte(s). The passivation layer may stabilize the active material, e.g., at least in part by hindering (e.g., preventing) direct contact of the electrode active material with any active components (e.g., of the electrolyte mixture), such that degradation of critical cell component(s) is reduced and/or the cycle life of the battery (e.g., the cell) is improved, in comparison to a situation in which no passivation layer is formed. The passivation layer may comprise a (e.g., inorganic) salt, an organic compound, a polymer, a resin, a composite, any plurality thereof, or any combination thereof. The salt may be the salt of the charge carrier. The organic compound may be made from a carbonate precursor. The organic compounds may comprise, or may be made of a precursor comprising, lithium alkyl carbonates, fluoroethylene carbonate (FEC), vinylene carbonate (VC), polymerization products thereof, a plurality of types thereof, or any combination thereof. In some embodiments, the passivation layer comprises a different chemical form of the charge carriers such as lithium. The passivation layer may (e.g., readily) form (e.g., deposit) on one or more surfaces of the active material of the cell, e.g., of the electrode and/or of the counter-electrode. The passivation layer may be a decomposition product comprising the charge carriers and/or electrolyte mixture components. Although formation of the passivation layer may be requested for the stability of the battery and/or cell thereof, some of the starting materials (e.g., FEC) and/or the electrons, may be irreversibly bound to the passivation layer, and thus are removed from regular operation of the cell, e.g., during its charge and discharge cycles.

In some embodiments, the cell comprises an electrolyte mixture. The electrolyte mixture may comprise salt, solvent, additive, any plurality of types thereof, or any combination thereof. The electrolyte mixture may be non-aqueous. The electrolyte mixture may comprise an organic mixture. The electrolyte may comprise polar molecule. The electrolyte may be sufficiently polar to dissolve the charge carriers such that they are readily available to participate in the charge and/or discharge cycles. The electrolyte may be such that side reaction with any other device components are minimized, e.g., during the prescribed lifetime of the device and/or int eh prescribed conditions of the device. The salt may comprise a halogen salt, a borate salt, an imide salt, a sulfonyl salt, any derivatives thereof, or any combination thereof. In the case of Lithium charge carrier, the salt may comprise Lithium hexafluorophosphate (LiPF₆), Lithium tetrafluoro borate (LiBF₄), Lithium bis(fluorosulfonyl)imide (LiFSI), any derivatives thereof, or any combination thereof. The solvent may comprise a carbonate, a propionate, an ethyl acetate, any derivatives thereof, or any combination thereof. The solvent may compromise Ethylene carbonate (EC), Propylene carbonate (PC), Ethyl methyl carbonate (EMC), Diethyl carbonate (DEC), Propyl Propionate (PP), Ethyl Propionate (EP), Difluoro ethyl acetate (DFEA), or Methyl (2,2,2-trifluoroethyl) carbonate (FEMC), any derivatives thereof, or any combination thereof. The additive may comprise a carbonate, a nitrile (e.g., mono, bi, and/or thri-nitrile), a cyanide, an ethoxy, an ethylene, a sultone, any derivatives thereof, or any combination thereof. The additive may comprise fluoroethylene carbonate (FEC), Vinylene carbonate (VC), Vinyl ethylene carbonate (VEC), Succinonitrile (SN), adiponitrile (AN), 1,3,6-hexanetricarbonitrile (HTCN), 1,2-Bis(2-cyanoethoxy) ethane (DENE), propane sultone (PS), 1,3-propene sultone (PRS), any derivatives thereof, or any combination thereof.

In some embodiments, the active material comprises a passivation layer. The passivation layer may range in thickness of at least about 30 nanometers (nm), 50 nm, 100 nm, 150 nm or 200 nm. The passivation layer may range in thickness of at most about 50 nm, 100 nm, 150 nm, 200 nm, or 250 nm. The passivation layer may range in thickness between any of the aforementioned values, e.g., from about 50 nanometers (nm) to about 150 nm, or from about 30 nm to about 250 nm. The passivation layer may be configured to allow charge carriers to pass through, and hinder (e.g., prevent) electrons in passing through.

In some embodiments, the passivation layer comprises an SEI layer. The SEI layer may comprise the charge carrier such as lithium, e.g., in the form of salt(s) such as lithium fluoride (LiF) and/or Li₂CO₃. In some embodiments, the SEI layer comprises inorganic salts, and/or organic compounds. The organic compounds may comprise lithium alkyl carbonates, fluoroethylene carbonate (FEC), vinylene carbonate (VC), polymerization products thereof, a plurality of types thereof, or any combination thereof. In some embodiments, the SEI layer comprises lithium. The SEI layer may (e.g., readily) form (e.g., deposit) on one or more surfaces of the electrode active material. The SEI layer may be a decomposition product comprising lithium (or other carrier ions) and/or electrolyte mixture components. Although formation of the SEI layer is requested for the stability of the battery, some of the starting materials of the passivation layer (e.g., FEC) and/or the electrons, may be irreversibly bound to the SEI, and thus are removed from the regular operation of the cell, e.g., during its charge and discharge cycles.

In some embodiments, a passivation layer is formed, the passivation layer contacting an external surface of the active material, e.g., cathode and/or anode active material. The concentration of the starting material in the electrolyte (e.g., FEC) in the electrolyte may be between about 15% to about 30% volume of active FEC per volume of electrolyte. The concentration of the starting material may be at most about 0.25%, 0.5%, 1%, 5%, 10%, 15%, or 30% volume of starting material per volume of electrolyte. For example, the concentration of starting material may be at most about 15% volume of starting material per volume of electrolyte. The concentration of starting material may be of any percentage value between any of the aforementioned percentage values, e.g., from about 0.25% to about 30%, from about 0.25% to about 5%, or from about 5% to about 15%, volume of starting material per volume of electrolyte.

In some embodiments, the cell comprises an anode separated by a gap from an anode. The cell may comprise a separator disposed in the gap. The cells may be elongated, e.g., may assume a shape of an elongated box. The face of the cell opposing the largest surface area face of the electrode (e.g., anode or cathode) may have an aspect ratio of at least about 10:1, 15:1, 20:1, 35:1, or 50:1, the aspect ratio being a length (e.g., FIG. 6, 631) of the face to a height (e.g., FIG. 6, 632) of that face. The cell may have an aspect ratio of at least about 5:1, 8:1, 10:1, 15:1, 25:1 20:1, 35:1, or 50:1, the aspect ratio being a height (e.g., FIG. 6, 632) of the cell to a width.

In some embodiments, the architecture of the device comprising the stacked electrodes described herein (e.g., FIGS. 3, 5-8,10) allow for better (e.g., faster and/or homogenous) distribution of starting materials (e.g., FEC) into the cell, as compared to other cell arrangements. The other cell arrangements may include a folded (e.g., jelly roll) cell configuration, or cell having a smaller aspect ratio, e.g., and having vertically stacked electrodes. In an example, when the electrodes have a large aspect ratio—are elongated, (e.g., and are stacked such along a horizontal axis such as in FIG. 3, 350), starting materials introduced at the long edges of the electrodes (e.g., top and/or bottom of the device), may quickly reach the middle of the electrode height (e.g., 350), e.g., since the distance to the interior of the cell structure is shorter, e.g., relative to a situation in which the starting material(s) is/are introduced (A) at the side edges of an elongated cylinder (e.g., 300), or (B) at edges of electrodes having a smaller aspect ratio (e.g., and that are stacked along a vertical axis FIG. 3, 330).

In some embodiments, the present disclosure relates to an electrochemical energy storage device such as a battery. The device may comprise one or more electrochemical cells. Each cell may comprise an electrode structure, a counter-electrode structure, a separator structure, and an electrolyte. The electrode and counter-electrode, may each comprise its respective current collector type, and active material type disposed on a middle portion of the current collector, e.g., as a layer. The current collector may comprise a distal portion devoid of the active material. The distal portion may comprise a fuse portion and a tap portion, the tab portion being at the lateral end of the current collector, having a lateral long axis. The tab of the electrode may be operatively (e.g., physically and/or electrically) coupled with an electrode busbar. The busbar may be coupled with the tab of the current collector. The tab may connect the middle portion of the current collector contacting the active material, to the busbar. In operation, a surge current may occur, e.g., due to an internal short circuit and/or an external abuse event. The surge current may pass through the tab towards the middle portion of the current collector that contacts the active material. The surge current may cause a substantial rapid temperature increase at the short location. The temperature rise may lead to degradation of the thermal runaway reaction in the active material and/or other harmful (e.g., degradation) even. In some embodiments, a fuse is integrated into the distal portion to generate a fuse region and a tab region, the fuse region being disposed between the middle portion of the current collector, and its distal tab region, along the lateral axis of the current collector. The fuse may be dimensioned to remain intact during normal operation of the cell assembly, e.g., the cell's prescribed operation. The fuse may be dimensioned to open during a surge current, e.g., to attenuate the harm such as to prevent the harm. The fuse may disconnect the middle portion coupled with the active material, from the tab region and from the optional busbar, e.g., before a harmful even initiate such as a thermal runaway.

In some embodiments, the design of a cell assembly fuse comprises cutting a path in a distal region of a current collector. The cell assembly fuse may be cut to form a narrowed cross-section. The narrowed cross-section may be created by a laser scribing process and/or a mechanical cutting process. The fuse may be disposed in a region of the distal portion located between a middle portion of the current collector and a tab region. The narrowed cross-section may maintain a cross-sectional area that, e.g., limits electrical resistance under normal operation. The narrowed cross-section may increase electrical resistance, e.g., during a current surge. The narrowed cross-section may be dimensioned to limit energy loss during normal operation. The narrowed cross-section may provide a controlled Joule heating profile, e.g., during a surge. The narrowed cross section may be configured to heat up and disconnect above a threshold of a current surge and/or joule heating temperature. As used herein, Joule heating is a physical phenomenon in which heat is generated when electric current flows through a resistive path. The surge may occur during an internal short circuit and/or an external abuse event. The narrowed cross-section may heat locally when a surge current passes through. The narrowed cross-section may reach a temperature sufficient to open the fuse, e.g., to melt the fuse material. The opened fuse material may separate due to surface tension of the material from which the fuse is composed of, e.g., comprising elemental metal, metal alloy, any plurality of types thereof, or any combination thereof. The separation may irreversibly disconnect the current path between the distal tab region (e.g., coupled with a terminal tab such as through a busbar) and the middle portion of the current collector contacting the active material portion.

In some embodiments, fuse activation occurs when a surge current flows through a narrowed path (e.g., fuse) in a distal portion of the current collector. The narrow path may present a localized electrical resistance. The localized resistance may lead to heating of the narrowed path, e.g., during the surge current. The heating may occur due to Joule heating within the narrowed cross-section. The narrowed path may reach a temperature sufficient to melt the fuse material. The fuse material may melt at a temperature lower than the ignition temperature of the cell. The molten fuse material may exhibit surface tension that, e.g., draws the material into shape such as, a ball shape. As used herein, the surface tension is a physical phenomenon in which the surface of a molten metal contracts to minimize surface area, producing a spherical, or spherical like, geometry. The surface tension may cause separation of the molten section from the remaining portions of the current collector such that electrical current is greatly diminished, or cannot pass. The separation may open the electrical circuit between the tap and the middle portion of the current collector contacting the active material portion. The separation may occur in at most picoseconds, or milliseconds, e.g., to interrupt the surge current before thermal runaway initiates. The narrowed portion may comprise a meandering portion. The meandering portion may assume a path such as shown in examples 253 and 254 of FIG. 2. The path may comprise top hat, or sinusoidal, path. The path may have a (e.g., substantially) constant pitch. The path may have an increasing pitch, or a decreasing pitch, e.g., along the lateral axis. The path may have a (e.g., substantially) constant amplitude. The path may have an increasing amplitude, or a decreasing amplitude, e.g., normal to the lateral axis.

In some embodiments, fuse formation is integrated into the fabrication of the electrode. The fuse formation operation may be performed e.g., during preparation of a distal portion (comprising the tab portion) of a current collector. The fuse may be generated as part of the processing line used to cut, shape, and/or prepare electrode distal portion (e.g., comprising the tabs). The process may reduce (e.g., avoid) addition of separate components to the electrode. An Integration of the fuse formation into distal portion (e.g., and tab) fabrication may reduce additional operations to the assembly of the energy manipulation device. The integration may maintain compatibility with high-volume manufacturing systems. The process may maintain manufacturing throughput of the cell assembly. The integration of fuse formation during electrode fabrication may reduce complexity compared to e.g., adding discrete fuse elements. The integration may reduce cost and/or process variability. The fuse placement within the distal portion of the current collector may maintain the electrode footprint to e.g., reduce (e.g., avoid) energy density loss. The location of the fuse may be selected to reduce interference with any busbar weld section. The location of the fuse may be selected to maintain a gap from active material. The gap may reduce (e.g. prevent) thermal transfer to the active material during fuse activation. The gap may be designed to allow variation of the active material edge on the current collector within a tolerance window. The gap may be provided to allow for (e.g., minute) errors in the lateral edge of the active material disposed on the current collector (e.g., while on the web), which current collector and active material construct form the electrode. The fuse path may be generated by cutting portions of the current collector's distal portion prior to assembling the electrode into the cell assembly. Sides along a heigh axis may be removed prior to assembling the electrode into the cell assembly, the sides contacting the fuse portion of the current collector. Prior to assembling the electrode into the cell assembly may comprise, while the electrodes are in a web form, as part of a roll of current collector on which the active material is deposited, e.g., and calendered. The sides may be removed, e.g., to reduce thermal mass and/or to refine activation response.

In some embodiments, a fuse is formed by cutting a path in a distal portion of a current collector devoid of an active material, the distal portion comprising a distal tab portion. The path may be cut using a mechanical cutter (e.g., knife), or laser dicing. The path may be cut, e.g., by a laser scribing process. The path may be formed by a mechanical cutting process. The cutting process may generate a narrowed cross-section that is e.g., integral to the distal portion of the current collector. The narrowed cross-section may be dimensioned e.g., to maintain a balance between electrical resistance, fuse operation above a threshold, and sufficient mechanical strength in the cell architecture. The threshold may comprise a current threshold, a temperature threshold, or any combination thereof. The cutting location may be selected to maximize the available length for the narrowed section. The cutting location may be selected to minimize (e.g., substantially without) alteration to geometry and/or functionality of the tab. The tab may be coupled with a busbar using welding and/or adhesive such as a conductive adhesive. The cutting may be performed with high positional accuracy. The cutting may be performed with high positional accuracy, e.g., relative to a reference edge of the distal portion (e.g., of the tab) and a defined cutting axis of the electrode sheet. The positional accuracy may be measured in microns (μm) as the deviation of the cutting path centerline from a target location along the reference edge. As used herein, the high positional accuracy refers to a positional tolerance at least about ±2 μm, ±5 μm, ±10 μm, ±12 μm, or ±15 μm. The positional accuracy may be at most about ±5 μm, ±10 μm, ±12 μm, or ±15 μm, ±18 μm, ±20 μm, or ±22 μm. The positional accuracy may be of any value between the aforementioned values, e.g., from about ±2 μm to about ±15 μm, from about ±10 μm to about ±22 μm, or from about ±2 μm to about ±22 μm. The positional accuracy may maintain the narrowed section within geometric tolerances, e.g., as required for consistent electrical resistance and thermal response. The accuracy may maintain consistent fuse geometry across electrodes. The precision may reduce variation in activation performance between cells. The cutting process may be integrated into electrode fabrication operations e.g., to reduce additional process stations. The electrode fabrication operations may comprise a roll-to-roll process, calendering, cutting (e.g., dicing), spallating, ablating, and/or stacking. The integration may maintain manufacturing line speed. The integration may reduce (e.g., avoid) a reduction in energy density of the cell. The approach may reduce manufacturing cost, increase throughput, increase efficiency, reduce manufacturing errors, reduce machinery, and/or increase reliability, e.g., as compared to resorting to integration of separate fuse components into the cell assembly.

In some embodiments, the fuse is positioned in a region of the distal portion of the current collector that comprises a space unoccupied by other components of the cell assembly. The available space may minimize (e.g., may be free of) active material coverage. The location may be selected to reduce (e.g., avoid) interference with the electrode geometry. The location may maintain the effective surface area of active material in the electrode. The positioning of the fuse may promote (e.g., ensure) that the energy density of the battery is (e.g., substantially) maintained. The fuse placement may maintain the mechanical alignment of the tab with adjacent electrode components. The selected region may accommodate a narrowed cross-section of sufficient length for controlled resistance, e.g., within the geometry of the cell assembly and/or using components integral to the cell assembly. The fuse placement may reduce (e.g., avoid) areas of the distal portion (e.g., and of the tab) subjected to high stress during cycling. The positioning may allow (e.g., substantially) reliable coupling of the tab to a terminal tab and/or to a busbar, e.g., while minimally (e.g., substantially without) altering fuse geometry. The distal tab may be a tab coupling the cell assembly to an external energy source. The terminal tab may be directly coupled with the current collector. The terminal tab may be coupled with the current collector through a busbar and/or busbar extension. The controlled fuse placement in the distal portion of the current collector, may promote (e.g., enable) consistent activation behavior across the cell assembly, e.g., across multiple unit cells of the cell assembly, the unit cell comprising an electrode separated from a counter-electrode by a gap. The approach may reduce (e.g., avoid) trade-offs between safety of the cell assembly and energy density. The approach may utilize currently integrated components (e.g., current collector) of the cell assembly, e.g., and thus will not reduce the energy density of the cell assembly such as by requiring additional space.

In some embodiments, the tab is destined for welding to a terminal tab and/or to a busbar. The welding section may require high mechanical strength and/or high electrical conductivity. As used herein, high mechanical strength refers to a tensile strength of at least about 50 megapascals (MPa), or 100 MPa, e.g., to maintain structural integrity of the weld joint. As used herein, high electrical conductivity refers to a contact resistance of at most about 50 microohm (μΩ), or 100 μΩ, e.g., to maintain stable current flow through the weld joint. The welding may comprise laser welding, plasma arc welding, gas welding, shielded metal arc welding (aka stick welding), or any combination thereof. The fuse may be positioned outside the welding section. The position may reduce (e.g., prevent) changes to weld integrity. The position may reduce (e.g., prevent) variations in contact resistance at the welded joint. The spacing between the fuse and the welded joint may promote (e.g., allow) precise control of heat flow during the welding process. The welding may be performed in situ, e.g., while the active material is in contract with the current collector comprising the tab and/or while the electrode is integrated within the cell assembly. The spacing may reduce (e.g., avoid) unintentional fuse activation during welding. Positioning the fuse outside the weld section may maintain dimensional stability of the fuse during lamination. The positioning may preserve tool alignment for high-volume welding operations. The separation may reduce thermal stress on the fuse, e.g., during cell cycling. The positioning may maintain long-term stability of the fuse, e.g., during the prescribed operation of the cell assembly and/or during the prescribed lifetime of the device (e.g., battery), such as disclosed herein. The prescribed use of the cell assembly may comprise repeated expansion and contraction of the cell assembly. The approach may combine reliable welding performance with predictable fuse activation characteristics.

In some embodiments, the fuse is disposed at a gap between a middle portion of the current collector contacting the active material, and a tap portion of the current collector. The gap may reduce (e.g., prevent) direct thermal transfer from the fuse to the active material, e.g., during fuse activation. The gap may reduce (e.g., prevent) thermal degradation of a binder and/or an electrolyte, e.g., at the interface of the active material. The placement may reduce (e.g., avoid) the creation of localized regions of degraded electrochemical performance, e.g., near the fuse site. The positioning may reduce gas generation, e.g., during fuse activation. The gas may be generated at least in part by unwanted (e.g., parasitic) reactions involving the electrolyte mixture present in the generated device, e.g., battery. Generation of the gas may require an elevated temperature of an active material mass. The gap may provide clearance, e.g., to allow accurate laser cutting and/or scribing of the fuse onto the distal portion of the current collector. The clearance may reduce (e.g., prevent) damage to the active material coating disposed on the middle section of the current collector. The gap may promote dimensional consistency of the fuse section, e.g., independent of coating thickness variations. As used herein, coating thickness refers to the thickness of an active material layer applied on the current collector during electrode fabrication. The coating thickness may vary due to slurry deposition, calendering pressure, and/or drying conditions. The calendering of the active material onto the current collector may be controlled by pressure and/or by a thickness of the active material mass. The lateral gap may decouple the fuse geometry e.g., from coating thickness variations of the active material onto the current collector. The dimensional stability of the fuse section may maintain consistent electrical resistance and/or predictable activation behavior of the fuse. The positioning may promote (e.g., ensure) that active material loading remains uniform across the electrode surface. The approach may maintain energy density and/or activation reliability of the fuse.

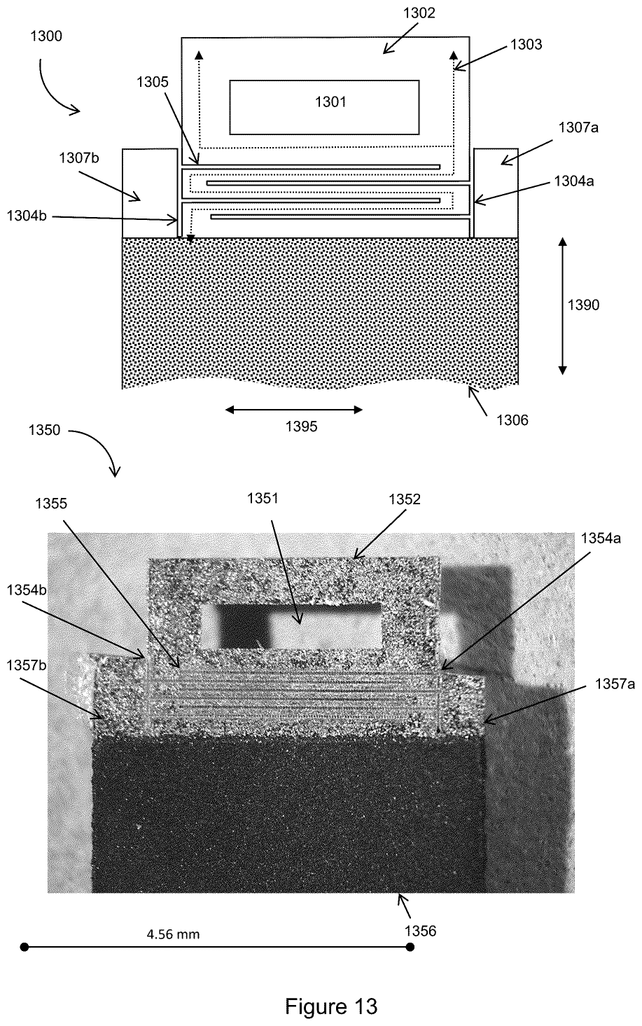

In some embodiments, side portions of the current collector along the fuse area are removed adjacent to a fuse region. The side portions may be along a height axis (e.g., Z axis) of the current collector, the heigh axis being normal to the lateral axis (e.g., X axis), and normal to the stacking axis of the cell assembly (e.g., Y axis). The removal of side portions may reduce the thermal mass surrounding the fuse. The reduced thermal mass may allow the fuse to, e.g., reach a fuse activation temperature quickly during a surge event. The activation of the fuse may be within at most about 5 milliseconds (ms) to about 20 ms. The removal of the side portions may define a controlled geometry for the fuse path. The operation may improve the predictability of activation timing. The removal may reduce parasitic conduction paths, such as around a narrowed section of the fuse. The configuration may maintain structural stability of the remaining tab section for mechanical handling. The removal may reduce stress concentration points that can develop, e.g., during cell cycling. The geometry refinement may be performed by laser cutting and/or mechanical trimming. The geometry may correspond to a narrowed fuse portion with side cutouts, e.g., as illustrated in FIG. 13. The operation may be integrated into the electrode cutting processes. The operation may be integrated with minimal (e.g., substantially without) addition of a separate process station. The approach may combine enhanced safety performance with manufacturing efficiency.

In some embodiments, one or more fuses are integrated into the device (e.g., battery). The fuse may comprise a thermal fuse, a very fast acting fuse (e.g., acts within tenths of a second), a fast-acting fuse (e.g., acts within seconds), or a slow blow fuse (e.g., acts within tens of a second). In some implementations, the fuse integrated into the secondary battery must meet certain functional requirements. For example, in some embodiments, a threshold for breaking the fuse is based at least in part on a current. The fuse can be configured to fuse at a threshold current of at least about 5 amperes (A), 10 A, 20 A, 25 A, 30 A, or 35 A. The fuse can be configured to fuse at a threshold current of any value between the aforementioned values, e.g., from about 5 A to about 35 A. In an example, the threshold current is at least about 25 A. In an example, the threshold current is at least about 21 A. The fuse can be configured to allow fast charging (e.g., allowing the cell(s) to fully charge in five minutes). The fuse can be configured to allow the device to have a C-rate of at least about 1C, 2C, 3C, 5C, 7C, or 10C. The fuse can be configured to allow the device to have a C-rate of any value between the aforementioned values, e.g., from about 1C to about 15C, or from about 2C to about 7C. The fuse may be triggered by one or more threshold types. The threshold types may include a temperature threshold, current threshold, and/or a resistance threshold. The threshold may be a value or a function. The threshold may include a minimum threshold and/or a maximum threshold, e.g., the threshold may be a threshold range or a threshold window.

In some embodiments, the material of the fuse is chosen as to curtail (e.g., prevent) interference, or other obstruction, of the chemistry of the electrochemical cell. For example, the fuse material may be inert to depletion of charge carriers, e.g., by facilitating their deposition on the fuse material through an electrolytic reaction or any other reduction reaction. In some implementations, the fuse has a lower melting point as compared to any of the other components of the current collector, e.g., due to (a) its unit volume along the path of the fuse, (b) its cross section along the stacking axis and/or (c) its cross section normal to the long path of the fuse. In some embodiments, the material of the fuse changes (e.g., melts) when heated by an energy (e.g., heat) below a threshold. The threshold temperature may be what is required to cause harm such as a runaway reaction in the cell, e.g., that may cause the harm such as igniting the cell. The harm may be any of the harms disclosed herein. In some embodiments, the threshold temperature may be required to be reached at a certain rate and/or acceleration. The fuse may be required to heat up quickly to undergo the change that will curtail (e.g., prevent) the harm. In an example, a swift rush of current is required to initiate the material change that will curtail (e.g., prevent) the harm, e.g., through a runaway reaction. In some implementations, the fuse is of a material that does not undergo a reversible change, e.g., of a material that does not reversibly connect after its disconnection through a phase change such as melting. In some embodiments, an activation (e.g., by a material change such as by melting) of the fuse is irreversible and/or happens quickly. The quick occurrence of the material change of the fuse may occur within at most fractions of a second. The fuse may activate within at most about 0.1 seconds (sec), 0.2 sec, 0.5 sec, 0.7 sec, 1 sec, 10 sec, 30 sec, 60 sec, or 90 sec. The fuse may activate at a time between any of the aforementioned times, e.g., from about 0.1 sec to about 1 sec, from about 1 sec to about 10 sec, from about 10 sec to about 90 sec, or from about 0.1 sec to about 90 sec.

In some embodiments, the fuse has a predefined length, e.g., along its path such as a meandering path. The fuse may have a length at least about 0.5 mm, 1.0 mm, 1.5 mm, 1.8 mm, 2.0 mm, 5.0 mm, or 10 mm. The fuse may have a length at most about 10 mm, 20 mm, 40 mm, 45 mm, 48 mm, or 50 mm. The fuse may have a length of any value between the aforementioned values, e.g., from about 0.5 mm to about 50 mm, from about 0.5 mm to about 15 mm, or from about 10 mm to about 50 mm. The fuse length may be selected to provide a controlled (e.g., series) resistance. The resistance may be sufficient to throttle a surge current, e.g., while minimally (e.g., substantially without) creating excess resistive loss, e.g., during normal operation. The fuse has a width at least about 100 μm, 150 μm, 200 μm, 240 μm, 300 μm, or 350 μm. The fuse may have a width at most about 300 μm, 450 μm, 480 μm, or 500 μm. The fuse may have a width of any value between the aforementioned values, e.g., from about 100 μm to about 500 μm. The fuse width may be selected to balance mechanical strength with localized heating efficiency. The fuse has a thickness at least about 50 μm, 75 μm, 100 μm, or 150 μm. The fuse may have a thickness at most about 125 μm, 140 μm, 150 μm, or 200 μm. The fuse may have a thickness of any value between the aforementioned values, e.g., from about 50 μm to about 200 μm. The fuse thickness may be selected to maintain structural rigidity, e.g., during cycling. The fuse thickness may be selected to e.g., achieve a melting temperature below the ignition threshold of the cell. The dimensional specification may be selected e.g., to provide consistent activation timing. The specification may be selected e.g., to maintain reliability during mechanical cycling. The specification may be selected to preserve the energy density of the battery.

In some embodiments, the fuse comprises a thermal fuse. The thermal fuse may operate by localized heating of a narrowed section of a current collector, e.g., during a surge current. The heating may occur due to resistive losses concentrated in the narrowed cross-section. The fuse may open when the temperature of the narrowed section exceeds the melting point of the fuse material. The fuse may be a very fast-acting type. The very fast-acting type may open in tenths of a second to interrupt rapid fault conditions such as an internal short circuit. The fuse may be a fast-acting type. The fast-acting type may open in seconds to address slower failure modes such as localized overcurrent during cycling. The fuse may be a slow-blow type. The slow-blow type may open in tenths of seconds, such as during a sustained overload with minimal (e.g., without) nuisance activation. In an example, the fuse exhibits a combined activation profile incorporating characteristics of very fast-acting, fast-acting, and slow-blow types. The combined profile may allow rapid opening, such as during high surge events and delayed opening during sustained moderate overloads. The activation profile may be determined by the geometry, thermal mass, and/or material selection of the fuse. The activation profile may be selected based on the chemistry, geometry, and/or cycling profile of the cell. The fuse may have an adiabatic activation time, e.g., less than about 10 milliseconds. The activation time may be determined by the cross-section, thermal mass, and/or material selection of the fuse. The fuse may have a resistance at least about 50 milliohms or 100 milliohms. The resistance may be set by fuse width, length, and/or thickness, e.g., to provide controlled throttling of surge current with minimal (e.g., substantially without) loss during normal operation. The selection of fuse type and/or dimensions may provide a consistent activation time across cells in high-volume production.

In some embodiments, the fuse material type is selected for compatibility with the electrochemical chemistry of the cell. The fuse material may be chemically stable with the electrolyte and/or the electrode binder, e.g., during operation. The fuse material may remain insoluble, corrosion-resistant, and/or structurally stable in the electrolyte environment. The fuse material may present a surface that is electrochemically inert to the electrolyte. The fuse material may be non-catalytic toward electrolyte decomposition reactions. The fuse material may be non-receptive to lithium plating and/or deposition of other charge carriers on its surface. The stable surface characteristics may maintain the resistance of the fuse, e.g., within a defined range over the lifetime of the cell. The chemical stability of the fuse material may support consistent electrical performance and/or predictable activation thresholds. The stability may also limit the release of metal ions into the electrolyte and reduce the risk of contamination of a solid electrolyte interphase. The compatibility of the fuse material with the cell chemistry may improve long-term durability of the fuse. The compatibility may also maintain the reliability of the safety function over repeated cycling.

In some embodiments, the fuse heats rapidly when a large surge current flows through a narrowed cross-section of a fuse. The narrowed cross-section may concentrate electrical resistance in a restricted path of the fuse. The heating may occur due to localized Joule heating in the restricted path, As used herein, Joule heating refers to a physical phenomenon in which heat is generated by current flowing through a resistive section. The thermal rise may be sufficient to reach the melting temperature of the fuse material, e.g., within fractions of a second. The rapid heating may interrupt the current path before the remainder of the cell experiences a thermal runaway reaction. The fuse material may maintain an open state after melting. The open state of the fuse may remain electrically disconnected from the busbar and from the active material portion of the current collector after activation. The irreversible opening may promote (e.g., ensure) that a shorted cell remains isolated from the electrical circuit. The fuse activation time may be at least about 0.1 seconds, 0.2 seconds, or 0.3 seconds. The fuse activation time may be at most about 1.5 seconds, 1.7 seconds, or 1.9 seconds. The fuse activation time may be of any value between the aforementioned values, e.g., from about 0.1 seconds to about 1.9 seconds. The activation time may be selected to reduce (e.g., prevent) nuisance activation, such as during transient loads, e.g., while protecting the cell under abnormal conditions. The controlled activation time may be achieved by selecting the cross-section, geometry, and/or thermal mass of the fuse. The activation profile may remain repeatable across multiple cells in high-volume production.

In some embodiments, the fuse geometry opens irreversibly during a surge current. The narrowed cross-section of the fuse may concentrate electrical resistance in a defined path. The defined path may be linear or non-linear, e.g., a serpentine shape. The path may be defined e.g., to extend the effective length of the fuse in a limited tab region. The narrowed geometry may reduce the thermal mass of the fuse region. The reduced thermal mass may allow rapid temperature rise, e.g., during a surge current. The geometry may be dimensioned to promote separation of molten metal, e.g., upon opening. The distance between the separated ends of the fuse may be selected, e.g., to exceed the surface tension bridge length of the molten material. As used herein, surface tension refers to a physical phenomenon in which molten metal contracts to minimize surface area, forming a ball shape. The separation may reduce (e.g., prevent) reconnection after melting. The geometry may provide a stable open gap such as during vibration and/or thermal cycling of the cell. The geometry may be optimized to reduce (e.g., avoid) parasitic conduction paths and/or arcing such as after activation. The geometry may maintain mechanical stability during normal operation. The geometry may remain resistant to fatigue prior to activation. The fuse geometry may promote (e.g., allow) controlled reconnection, e.g., after the current decreases to a value below a reconnection threshold. The reconnection may occur based on cooling of the fuse material to a non-activated temperature below the softening point of the material. The reconnection may restore electrical continuity between the busbar and the active material portion under safe operating conditions. As used herein, the reconnection threshold measured in amperes (A) may be at most about 0.5 A, 0.7 A, or 1.0 A. A current below the reconnection threshold may reduce (e.g., prevent) reactivation probability of the fuse during reconnection.

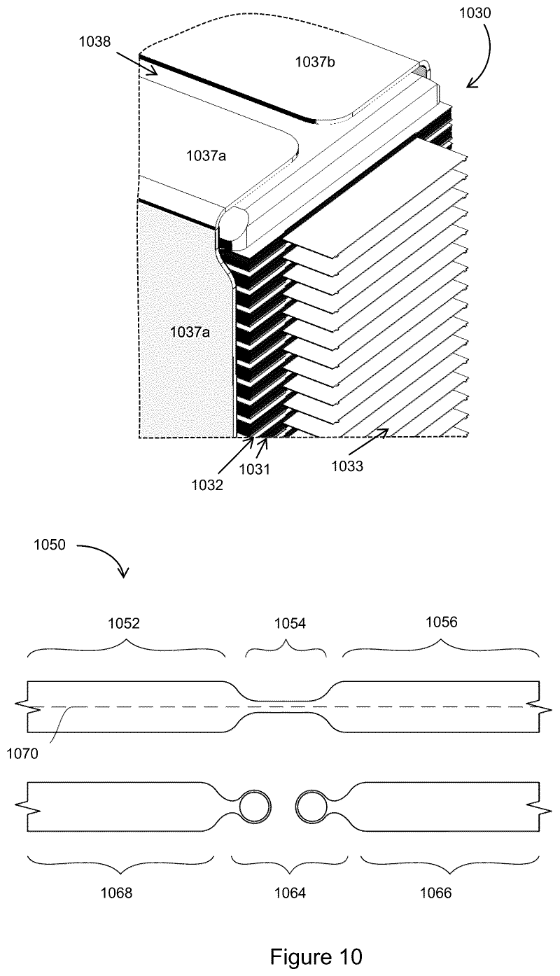

In some embodiments, the fuse metal has a high surface tension upon melting. The molten metal may ball up when the fuse activates. The balling may occur as the molten metal contracts, e.g., to minimize surface area. The fuse may have a first section and a second section. The first section and the second section may be connected by the narrowed portion of the fuse, e.g., as illustrated in FIG. 10. The distance between an end of the second section facing an end of the first section may be selected such that when the metal is molten, the ends disconnect. The distance may exceed the surface tension bridge length of the molten metal. The spacing may maintain an open circuit after activation. The balling and/or separation may occur rapidly, e.g., during surge activation. The open state may remain stable as the molten metal cools. The high surface tension and/or the controlled distance may provide substantial isolation of the shorted section. As used herein, surface tension bridge length refers to the maximum distance between two molten metal ends at which surface tension forces can maintain a liquid bridge. A distance greater than the surface tension bridge length results in physical separation of the molten metal ends.

In some embodiments, the fuse metal comprises an elemental metal, a metal alloy, an allotrope of an elemental metal, any plurality of types thereof, or any combination thereof. In an embodiment, the material of the fuse is the material of the current collector. The elemental metal may comprise aluminum, copper, nickel, tin, any plurality of types thereof, or any combination thereof. The metal alloy may comprise stainless steel, e.g., SS 301 or SS 316, any plurality of types thereof, or any combination thereof. The allotrope of an elemental metal may comprise a structured carbon allotrope, e.g., carbon fiber or expanded graphite, any plurality of types thereof, or any combination thereof. The material selection may be based at least in part on melting temperature, surface tension, electrical conductivity, and/or chemical stability in the cell environment. The composition may be selected to maintain mechanical integrity before activation. The composition may be selected to provide rapid separation and/or a stable open condition, e.g., upon activation. The flexibility of selection may promote process integration across multiple current collector designs and/or chemistries.

In some embodiments, the first section and the second section of the fuse comprise the same material type as the current collector. The material may comprise an elemental metal, a metal alloy, an allotrope of an elemental metal, any plurality of types thereof, or any combination thereof. The elemental metal may comprise tin, nickel, aluminum, or copper, any plurality of types thereof, or any combination thereof. The allotrope of an elemental metal may comprise a structured carbon allotrope, e.g., carbon fiber or expanded graphite, any plurality of types thereof, or any combination thereof. Matching the material of the fuse sections to the current collector may maintain thermal expansion compatibility. The continuity of material across the fuse and the current collector may reduce mechanical stress, e.g., at the fuse interface. The continuity may promote stable weld quality. The continuity may promote predictable activation. The continuity may promote long-term durability of the fuse, e.g., during repeated cycling.

In some embodiments, the fuse material has a melting temperature lower than the ignition threshold of the cell. The melting temperature may be selected such that heat generated by a surge current is e.g., sufficient to melt the fuse material. The melting temperature may be selected to allow fuse activation, e.g., before thermal runaway conditions are reached. The melting temperature may be tuned to balance rapid activation with mechanical durability such as during normal operation. The fuse material may maintain stability during cycling and/or external handling at normal cell temperatures. The melting temperature selection may be coordinated with the geometry of the fuse, e.g., to achieve a repeatable activation profile. The melting temperature of the use material may be verified for compatibility with e.g., cell electrolyte, separator, and/or current collector, such as to reduce (e.g., prevent) premature degradation. The melting temperature control may contribute to safe disconnection of the fuse. The disconnection may be implemented, while minimally (e.g., substantially without) compromising the overall integrity of the cell. The melting temperature margin may improve safety consistency across multiple cells in high-volume production.

In some embodiment, the fuse is supported by a base and/or a supporting member. The base may comprise the separator or the current collector. The support member may comprise an adhesive tape. The base can be nonconductive to heat and/or electricity. The base can act as an electrical insulator and/or thermal insulator. The base may be disposed adjacent to the fuse, e.g., a tape portion. The base may be configured to contact the fuse in at least a portion of the prescribed operation of the cell assembly, e.g., during the entirety of the prescribed operation of the cell assembly. The base may couple with one or more spacer members. The support member can be nonconductive to heat and/or electricity. The support member can act as an electrical insulator and/or thermal insulator. The support member may be disposed adjacent to the fuse, e.g., a tape portion. The support member may be configured to contact the fuse in at least a portion of the prescribed operation of the cell assembly, e.g., during the entirety of the prescribed operation of the cell assembly. The support member may comprise, or may be coupled with (e.g., adhere to), one or more spacer members. The support member may mechanically stabilize the section of the fuse prone to damage, e.g., may mechanically stabilize the narrowed section of the fuse. One or more spacer members can be configured to support the fuse, e.g., from one or from opposing sides of the fuse along the stacking axis. One or more support members can be configured to support the fuse, e.g., from one or from opposing sides of the fuse along the stacking axis. Stabilization of the fuse may reduce the risk of premature failure, e.g., due to vibration and/or handling of the cell assembly, such as during manufacturing and/or prescribed operation of the cell assembly. Stabilization of the fuse may reduce mechanical stress, e.g., during thermal expansion and/or contraction of the cell. The non-electrically conductive nature of the support member and/or of the base, may reduce (e.g., prevent) parasitic current flow around the fuse. The support member and/or of the base, may remain stable at operating temperatures of the cell. The support member and/or of the base, may maintain dimensional stability of the fuse, e.g., until the fuse activates. The support member and/or of the base, may maintain geometric alignment of the fuse, e.g., and of the distal portion of the current collector comprising the fuse portion such as within the cell assembly. The geometric alignment may promote reliable fuse activation and/or consistent compression across cells.

In some embodiments, the support member faces one side of the fuse along the stacking axis. The support member may be part of a spacer member configuration in the cell assembly. The support member may be coupled with a base to form a spacer construct. The base may comprise the current collector or the separator. In an example, the base is a separator. The support member may be coupled with (e.g., adhered to) the current collector or to the separator. The support member may be coupled with (e.g., adhered to) the fuse portion of the current collector. In an example, the support member is coupled with (e.g., adheres to) the separator, e.g., such that the support member will face the fuse portion of the current collector facing the separator. While the support member supports the fuse, and is facing the fuse, the support may be connected (e.g., by adhesion) to the separator rather than to the fuse. The fuse may not be connected with (e.g., adhered to) the current collector. The spacer construct may comprise a first spacer member disposed at a distal end of the separator facing a second spacer member disposed at an opposing distal end of the separator, the separator having a middle portion devoid of the spacer member. The first spacer member may face the second spacer member along the lateral axis (e.g., of the separator) to form a first pair of spacer members contacting a first separator. The first pair of spacer members may be coupled with the first separator (e.g., adhered to the separator). The first pair of spacer members may face the electrode, e.g., cathode. The middle portion of the separator may face the middle portion of the current collector and/or the electrode active material, of the electrode. The first spacer member of the first pair of spacer members, may face the fuse portion of the current collector. The second spacer member of the first pair of spacer members, may face a remainder portion of the current collector opposing the fuse portion along the lateral axis. The fuse portion of the current collector and the remainder portion of the current collector may be disposed at opposing sides of the middle portion of the current collector, along the lateral axis. The current collector may comprise active material at opposing sides of the middle sections along the stacking axis. A second separator may be disposed at opposing sides of the electrode along the stacking axis. The second separator may couple with a second pair of spacer members (e.g., coupled by an adhesive). In a cell stack, an electrode may be bordered by two separators along the stacking axis. Each of the two separators may have a pair of spacer members facing the electrode. Along the stacking axis, the second pair of spacer members face the electrode on an opposing side to the face of the electrode which the first pair of spacer members face. The electrode can be a cathode, e.g., that is laterally shorter than the anode. The arrangement may maintain alignment of the cathode current collector with the anode current collector along the stacking axis, e.g., using the pairs of spacer members. The spacer member may be configured to stabilize the opposing sides of the current collector of the electrode (e.g., cathode), the opposing sides being the remainder portion and the distal portion. The support member may distribute mechanical loading across the fuse region, e.g., during the prescribed use of the cell assembly. The arrangement may maintain uniform compression along the stacking axis, e.g., during at least a portion of the prescribed use of the cell assembly such as during expansion of the electrode active material and/or expansion of the counter-electrode active material. The construct may preserve dimensional tolerance for lamination, sealing, cell integration into an enclosure and/or into a target device. The arrangement may support repeatable alignment of the fuse with respect to the cell assembly, e.g., for high-volume assembly. Without integration of the spacer member, a shape and/or integrity of the fuse may be compromised, e.g., on assembly of the electrodes to generate the cell assembly and/or during the prescribed use of the device such as disclosed herein. Without the integration of the spacer members and/or the support member, portions of the current collector devoid of the active material may move (e.g., dangle) during assembly of the cell assembly and/or during the prescribed operation of the cell assembly. The portions of the current collector devoid of the active material may include the distal portion and/or the remainder portion. Such movement may cause damage to the active material and/or shorts in the cell assembly.

In some embodiments, in the spacer construct comprising the separator. The support member and/or spacer members, may be of the same material as the separator. The support member and/or spacer members, may be of a different material from the separator. The use of the same material may maintain uniform thermal expansion, elasticity, and/or mechanical stiffness, e.g., along the stacking axis and/or at least one axis normal to the stacking axis. The support member and/or spacer members, may comprise a polymer, a resin, an adhesive, any copolymers thereof, any mixtures thereof, or any plurality of types thereof. The support member and/or spacer members, may comprise ethylene acrylic acid, terephthalate, polymers thereof (e.g., polyethylene acrylic acid (EAA) and polyethylene terephthalate (PET)), any mixtures thereof, any plurality of types thereof, any salts thereof as applicable, or any combination thereof. In an example, the material of the support member and/or spacer members, comprises polyethylene terephthalate (PET) for the support, e.g., the support member having (e.g., substantially) the same material type as that of the spacer members. The same material may maintain matched thermal expansion and/or stiffness, across the support member and the spacer members. The use of the same material type may simplify the lamination process and/or maintain consistent compression across the cell assembly, e.g., across multiple unit cells of the cell assembly. The use of a different material may allow the tuning of elasticity and/or adhesion properties, between the support member and the fuse. In an example, the different material comprises an ethylene acrylic acid (EAA) copolymer support member used with PET spacer members, e.g., to provide higher adhesion between the support member and the spacer member and/or base. The base can be the current collector or the separator. In an example, the base is the separator. A different material may provide higher thermal insulation and/or higher rigidity, e.g., to stabilize the narrowed fuse section. In an example, the different material comprises a polyimide support with PET spacer members, such as to increase thermal insulation and rigidity. The flexibility in material choice may allow optimization of activation reliability, mechanical durability, and/or process compatibility, for various cell architectures. The flexibility may support process integration across different cell formats. The separator may or may not be of the same type of material as the spacer member and/or support member.

In some embodiments, in the cell assembly, the collective width of the spacer construct along the lateral axis, is (e.g., substantially) equal (a) to the width of the cathode with its current collector and (b) to the anode with its current collector, e.g., when the spacer construct includes the pair of spacer members coupled with the separator. The collective width may be selected to maintain a uniform height across the electrode assembly. The matched width may reduce (e.g., prevent) changes in thickness. The changes may create localized pressure points, e.g., during lamination. The uniformity of the cell assembly profile may maintain consistent compression across the electrode layers. The uniform width may maintain parallel alignment between the anode and cathode current collectors. The dimensional match may reduce the risk of delamination and/or distortion, e.g., during thermal cycling. The dimensional control of the spacer construct may improve structural stability and/or electrical performance of the cell, e.g., during operation. The dimensional control may support (e.g. allow) repeatable integration in high-volume assembly systems.

In some embodiments, in the cell assembly, the current collector portions devoid of active material, are disposed between two spacer members. The current collector portions devoid of active material may comprise the distal portion and the remainder portion. The distal portion may comprise the tab portion and the fuse portion. The spacer members may be positioned on opposite sides of the base (e.g., separator) along the stacking axis. Each of the spacer members may be (e.g., substantially) the same width along the lateral axis, the same length along the stacking axis, and/or the same height along the height axis. The arrangement may provide (e.g., substantially) symmetrical compression around the current collector portion devoid of active material during lamination. In some examples, a section of the current collector devoid of active material, does not contact the spacer member, the section constituting a lateral gap. The symmetrical compression along the stacking axis, may reduce bending forces on the narrowed fuse section. The placement of the spacer members in the cell stack may control the deflection of the distal portion of the current collector, e.g., during expansion and contraction due to cycling and/or thermal variations. The placement arrangement of the spacer members may maintain consistent thermal and/or electrical conduction paths throughout the current collector, e.g., between the tab portion and the middle portion of the current collector. The balanced thermal profile may improve fuse activation predictability. The positioning of the support member between two spacer members may simplify alignment during high-volume stacking. The positioning of the spacer members along the stacking axis, may reduce the variation in stack height between cells. The lateral position of the spacer member may allow for uniform stacking of electrode types that vary in lateral extent, the electrode types comprising an electrode and a counter electrodes.

In some embodiments, the base (e.g., separator) has (e.g., substantially) the same thickness along the stacking axis, as each spacer member disposed at both sides of the support member (also herein “supporting member”). In some embodiments, the support member has a different thickness along the stacking axis, from each spacer member. The use of the same thickness may maintain uniform contact pressure along the stacking axis. The matched thickness may reduce shear stress at the interface between the support member and the fuse. The use of a different thickness may be selected to increase localized reinforcement and/or thermal insulation, e.g., at the narrowed fuse section. A thicker support member may distribute stress evenly into the spacer members. A narrower support member may reduce thermal conduction away from the fuse during activation. The thickness relationship between the support member and the spacer members along the stacking axis, may be selected to balance the mechanical stability of the fuse e.g., during cycling with activation reliability such as during a surge event. The thickness relationship between the support member and the spacer members along the stacking axis, may be selected to allow activation of the fuse e.g., beyond the prescribed fuse activation threshold.

In some embodiments, the thickness of the base (e.g., separator) along the stacking axis, is greater than the thickness of the fuse. The increased thickness may allow the base to remain substantially intact when the fuse activates. The greater thickness may provide a thermal buffer between the activated (e.g., molten) fuse and the edge of the support member. In some embodiments, the thickness of the fuse may be an order of magnitude less than the thickness of the base. The thicker base may reduce (e.g., prevent) localized heat from the transitioned (e.g., molten) metal from damaging the base, e.g., a polymeric separator having a substantially lower melting point as the molten metal. The difference in thickness may maintain structural stability around the fuse gap, e.g., after fuse activation. The current collector material may melt at a temperature in the range of at least 600 of degrees Celsius (° C.), 900° C., or 1000° C. The support member material may comprise a resin, a polymer, a copolymer, a plurality of types thereof, a mixture thereof, or any other combination thereof. The polymer may comprise polyethylene terephthalate, polypropylene, polyethylene, polyimide, any plurality of types thereof, or any combination thereof. The copolymer may comprise ethylene acrylic acid copolymer, ethylene vinyl acetate copolymer, ethylene methacrylic acid copolymer, any plurality of types thereof, or any combination thereof. The base material may have a melting temperature at least about 100° C., 120° C., or 150° C. The base material may have a melting temperature at most about 250° C., 280° C., or 300° C. The base material may have a melting temperature of any value between the aforementioned values, e.g., from about 100° C. to about 300° C. The base may be the separator or the current collector such as a current collector comprising the fuse portion. In an example, the base is the separator. The fuse may be configured such that its melting temperature remains below the melting temperature of the rest of the current collector metal. The fuse may be configured to maintain mechanical stability, e.g., during normal operation and after fuse activation. The mechanical stability may be obtained with the aid of the spacer members, e.g., at opposing sides of the fuse along the stacking axis. Relative to the fuse, a greater thickness of the base and/or each of the spacer members, may reduce localized thermal exposure, e.g., during fuse activation. The thicker cross-section may allow thermal conduction away from the immediate activated (e.g., molten) region of the fuse. The thermal gradient across the thickness of the base and/or spacer members, may limit their respective bulk softening. The thermal gradient across the thickness of the base and/or spacer members, may limit their respective (e.g., plastic) deformation. The maintained integrity of the base may preserve the alignment of the distal current collector section, e.g., after fuse activation. The preserved alignment of the spacer members in the cell assembly, may maintain stack spacing and/or reduce (e.g., prevent) collapse of adjacent layers, e.g., during the prescribed operation of the cell assembly. The stability of the base after activation, may promote (e.g., ensure) that compression distribution across the stack remains substantially unchanged.

In some embodiments, generation of the spacer construct causes the current collector to deviate from planarity by an angle, e.g., along a plane normal to the stacking axis (Y axis), the plane being along lateral axis and along the height axis (XZ plane). The deviation angle may depend at least in part on the thickness of the support member. The deviation angle may be controlled to remain within the dimensional tolerance of the assembly. The controlled angle may maintain parallel alignment between adjacent electrodes. The deviation may be minimized to reduce pressure non-uniformity on the active material, e.g., during lamination. The angle control may preserve uniform electrical contact between the current collector and the busbar and/or terminal tabs. The thickness of the base and/or support member, may be selected to balance mechanical reinforcement with minimal geometric offset. The controlled planarity normal to the stacking axis—along the lateral axis (and height axis), may maintain stable thermal conduction paths, e.g., during fuse activation. The control of deviation from the lateral axis may maintain long-term durability of the electrode configuration during the prescribed operation of the cell assembly, e.g., during cycling. The planarity control may improve alignment consistency across multiple cell assemblies during high-volume manufacturing.

In some embodiments, an energy storage device comprises a set of battery cells enclosed within a casing structure, e.g., a constraint system. The battery cells may comprise alternating electrodes and counter electrodes, each pair of electrically opposing electrodes separated by a gap comprising a separator. Each electrode may comprise a current collector that extends laterally beyond an edge of the separator by a tab. The tabs of a given electrode type may extend in at least one common direction to facilitate electrical connection. The casing may comprise two opposing casing structures. The casing may comprise two end plates joined to enclose the set of battery cells. The structural configuration may enhance electrical isolation, dimensional stability, and/or modular packaging of the electrode stack.

FIG. 10 shows schematic example 1030 depicting edge portions of an energy storage device, (e.g., a battery). The device comprises battery cells including alternating structure of electrodes such 1031 and counter electrodes separated from each other by a gap such as 1032, e.g., comprising a separator. Each electrode type (e.g., each anode and each cathode) includes its respective current collector onto which active material is deposited (e.g., at one or at both sides). The current collector of each anode type extends laterally by an extended portion, e.g., by a tab such as tab 1033. The tab of current collectors of an electrode type, extend to the same lateral direction beyond an edge of the separator, which separator extends laterally beyond each of the electrode types. The set of cells is encased in a casing formed by two opposing casings 1037a and 1037b, and by two opposing end plates such as end plate 1038.

Example 1050 schematically shows an interconnect component (e.g., a connecting member such as a tab portion of a current collector and a middle portion of the current collector) with a fuse in-tact and with a fuse disconnected. Example 1050 comprises a first portion of interconnect component body 1052 connected with in-tact fuse portion 1054 connected with interconnect component body portion 1056. Fuse 1054 is elongated along long axis 1070 of the interconnect component. Fuse 1054 has a width that is smaller than that of each of portion 1052 and portion 1054. In the example shown in 1050, the fuse is a straight line, and not a meandering line. Example 1050 comprises a first portion of interconnect component body 1068 connected with a first portion of open fuse portion 1064. Second portion of open fuse 1064 is connected with interconnect component body portion 1066. Fuse 1064 may have been disconnected by melting and forming (e.g., high surface tension) two globular masses, each connected to an opposition portion of the interconnect components. Such activated fuse in 1064, is an irreversible fuse.

In some embodiments, when a sufficient current is applied to the interconnect component e.g., busbar extender such as 35A), the fuse alters (e.g., melts) and the interconnect component becomes disconnected. In some implementations, when the fuse activates (e.g. alters its material properties), the interconnect component changes one or more of its material properties to curtail (e.g., to stop) flow of the current through the fuse. In some embodiments, when the fuse is activated, portions of the fuse form globular masses (e.g., ellipsoids such as balls). The globular mass may adhere to ends of the interconnect component previously connected by the in-tact fuse. In some implementations, disconnected fuse comprises the balled-up material on the interconnect component. In some embodiments, the fuse is configured to (a) be in a location, (b) be in a component type, (c) be of a material makeup, and/or (d) have a FLS (e.g., a length, width and/or height), that is/are tailored to curtail (e.g., stop) conduction of through the fuse (and thus through the interconnect component) to reduce (e.g., prevent) the harm. In an example, the fuse is configured to (a) be in a location, (b) be in a component type, (c) be of a material makeup, and/or (d) have a FLS, that is/are tailored to stop conduction of electricity through the fuse (and thus through the interconnect component) to reduce (e.g., prevent) the harm. In an example, the length of in-tact fuse may be of a length such that upon fusing, the interconnector body will cease to flow electrical current a way that would cause the harm, e.g., entirely cease flowing the electrical current through the interconnect component. Alteration of the fuse may or may not be reversible. In some embodiments, the alteration of the fuse is irreversible. In some implementations, the disconnected fuse cannot revert back to being a connected fuse, as it is a one-way change, a permanent change, such as a safety measure.

In some embodiments, a current collector may comprise a narrowed fuse portion disposed between two portions of the current collector. The current collector may include (i) a tearable portion disposed adjacent to the fuse portion and/or (ii) at least one alignment feature positioned near a distal edge. The fuse portion may be electrically connected to a middle portion of the current collector contacting an active material region. The fuse portion may disconnect under thermal, mechanical, and/or electrical stress. The tearable portion may enable mechanical separation with minimal (e.g., substantially without) damage to the adjacent structures. The tearable portion may be configured for tearing after the electrode components have been assembled, and the spacer members and/or support member, support the fuse portion of the current collector. The alignment feature may assist in registration during stacking and/or positioning, e.g., while manufacturing the cell assembly. The tearable portion may be absent from the cell assembly assembled into the energy manipulation device, e.g., battery. The lateral width of the current collector and electrode assembly may be selected to support alignment, thermal control, electrical robustness, and/or structural registration. The lateral width may be adjusted based at least in part on a cavity destined for the energy manipulation device (e.g., battery), the cavity being in the target device. The dimensionality of the electrodes may be any of the ones disclosed herein. In an example, the lateral width is at least about 4.4 mm, 4.5 mm, 4.55 mm, or 4.56 mm. In an example, the lateral width is at most about 4.56 mm, 4.6 mm, 4.7 mm, or 4.8 mm. In an example, the lateral width is any value between the aforementioned values, e.g., from about 4.4 mm to about 4.8 mm.

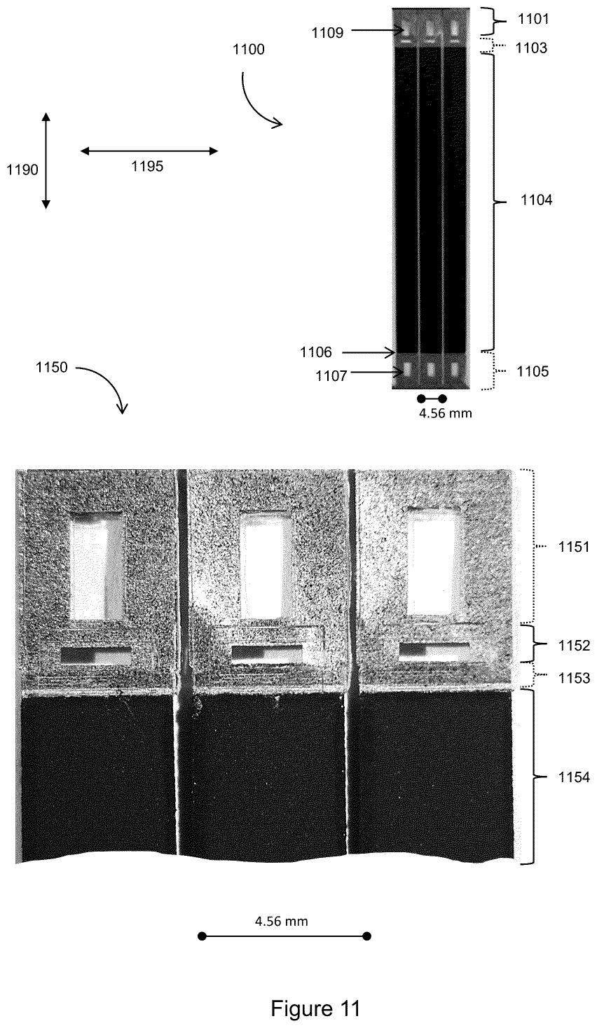

FIG. 11 illustrates in example 1100 a current collector and electrode assembly that are part of a generated web. The current collector comprises a distal portion 1103. The fuse portion in the distal portion 1103 disconnects under surge current to interrupt conduction. The distal portion 1103 is disposed between a tearable portion of the current collector 1101 and a middle portion of the current collector 1104 contacting the electrode active material. Tearable portion 1101 includes alignment feature 1109, e.g., utilized to align each of the resulting electrodes in a cell stack along alignment poles. The distal portion 1103 is electrically connected with the active material region. A tear line 1106 is located between the fuse portion 1103 and the distal portion 1105. The tear line 1106 promotes mechanical separation with minimal (e.g., substantially without) damaging the distal portion of the current collector 1105. An alignment feature 1107 is located near the distal portion 1105. The fuse portion 1103 and tear line 1106 extend normal to lateral axis 1190 and along heigh axis 1195. A height axis 1195 defines the height dimension of the assembly. An alignment feature 1107 comprises a hole for electrode stacking and/or registration. The alignment feature 1107 assists in positioning during cell stacking, e.g., inserted into poles such as skewers. The alignment feature 1107 opposes alignment feature 1109 in the laterally opposing side of the middle portion of the current collector.

FIG. 11 illustrates in example 1150 a photographic image of a current collector structure. The structure corresponds to a portion of example 1100. A tearable portion 1151 of the current collector comprises an alignment features for alignment poles utilized during stacking of the electrodes in a cell stack. A tab portion 1152 is disposed between the remainder portion 1151 and a fuse portion 1153, the tab coupled with the tearable portion by a tear line. The fuse portion 1153 is electrically connected to the middle portion 1154 of the current collector on which active material has been deposited. The tab portion 1152 comprises a slot (e.g., D-slot) region configure to engage with a busbar in the assembled cell assembly. The alignment features in portion 1151 may be used for stacking and/or positioning during assembly of the electrodes into a cell stack.

In some embodiments, a strip for electrode fabrication may comprise an active material area, a current collector outline, and a pair of tab regions disposed on opposite sides of the active material area. One tab region may comprise a dangling portion of the current collector. The opposing tab region may comprise a bent, dented, or trapezoidal portion configured for busbar engagement. At least one tab region may comprise an optional slot shaped as a D-slot or other connector feature. The strip may comprise alignment features disposed near the tab ends to support stacking and registration during manufacturing.

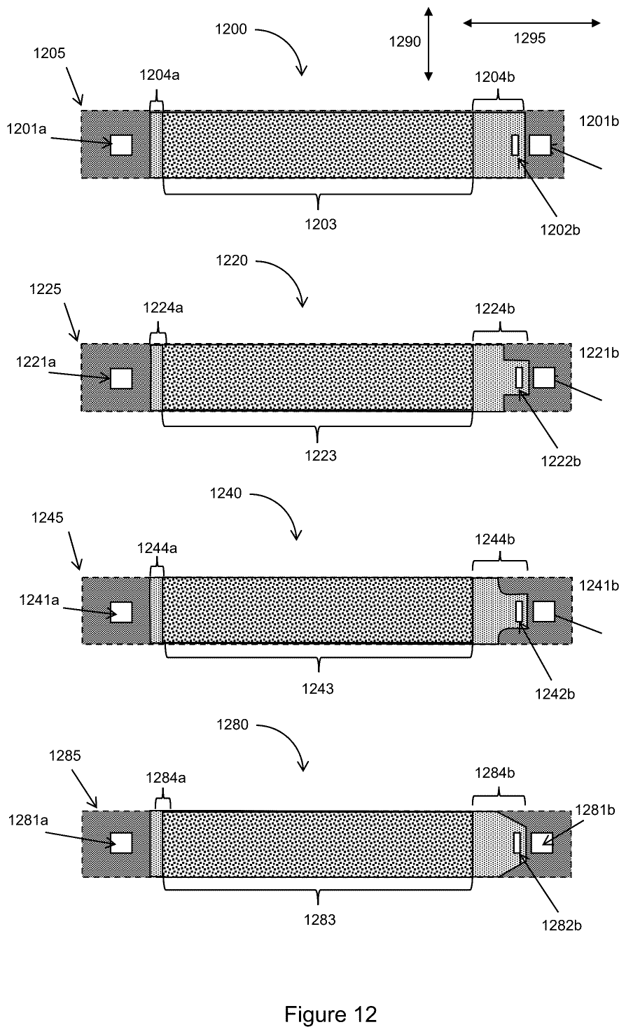

FIG. 12 depicts various strip examples from which electrodes for cells are to be fabricated. The electrode strips may be part of a web of electrode strip (web not shown). The strip examples of FIG. 12 are viewed horizontally, e.g., from the top and/or bottom of the strip. In some embodiments, the strip may be symmetrical along a plane normal to strip's face having the largest surface area, e.g., by mirror symmetry. As used herein, the term long axis refers to a principal axis extending along the lengthwise dimension of the strip—lateral axis, e.g., parallel to the feed direction of a roll-to-roll process or the primary cutting direction in a sheet-fed process. The long axis may extend continuously between opposite ends of the strip. The term short axis refers to the axis orthogonal to the long axis and extending across the width of the strip. The various strips have different tab section configurations. The strip may be a current collector strip partially covered by active material from one or both of its sides. The strip may be a current collector strip having a middle portion covered by active material from one or both of its sides.

Example 1200 shows a strip comprising an active material area 1203. The strip comprises a current collector outline 1205. A remainder region 1204a is located on a first distal lateral end of the middle portion 1203 contacting an active material area. The lateral axis is shown in double arrowed line 1295. A height axis is shown in double arrowed line 1290. A tab region 1204b is located on a second distal lateral end of the middle portion 1203, the second distal end laterally opposing the first distal lateral end of the middle portion 1203. The strip comprises alignment features 1201a and 1201b along a lateral axis of the electrode. Remainder region 1204b can be a dangling portion of the current collector. Tab region 1204b is dented by an optional slot 1202b (e.g., D-slot) to engage with a busbar and comprises an area for fuse placement. In this example, the tab region 1204b has a height similar to the height of the middle portion 1203.

Example 1220 shows a strip comprising an active material area 1223. The strip comprises a current collector outline 1225. A remainder region 1224a is located on a first distal lateral end of the middle portion 1223 contacting an active material area. A tab region 1224b is located on a second distal lateral end of the middle portion 1223, the second distal end laterally opposing the first distal lateral end of the middle portion 1223. The strip comprises alignment features 1221a and 1221b along a lateral axis of the electrode. Remainder region 1224b can be a dangling portion of the current collector. Tab region 1224b is dented by an optional slot 1222b (e.g., D-slot) to engage with a busbar and comprises an area for fuse placement. In this example, the tab region 1224b has a height smaller than the height of the middle portion 1223, the smaller heigh being centred along the long axis of the current collector. The smaller tab (e.g., having dented geometry) 1224b may provide a defined region for fuse formation and promote consistent busbar and/or terminal tab engagement across interconnected assemblies.

Example 1240 shows a strip comprising an active material area 1243. The strip comprises a current collector outline 1245, e.g., as part of a web (web not shown). A remainder region 1244a is located on a first distal lateral end of the middle portion 1243 contacting an active material area. A tab region 1244b is located on a second distal lateral end of the middle portion 1243, the second distal end laterally opposing the first distal lateral end of the middle portion 1243. The strip comprises alignment features 1241a and 1241b along a lateral axis of the electrode. Remainder region 1244b can be a dangling portion of the current collector. Tab region 1244b is dented by an optional slot 1242b (e.g., D-slot) to engage with a busbar and comprises an area for fuse placement. In this example, the tab region 1244b has a height smaller than the height of the middle portion 1243, the smaller heigh being centred along the long axis of the current collector, the tab having inwardly curving sides. The inward bend and curvature of tab 1244b may reduce mechanical stress during connection and promote stable electrical contact within confined laminate geometries.

Example 1280 shows a strip comprising an active material area 1283. The strip comprises a current collector outline 1285, e.g., as part of a web (web not shown). A remainder region 1284a is located on a first distal lateral end of the middle portion 1283 contacting an active material area. A tab region 1284b is located on a second distal lateral end of the middle portion 1283, the second distal end laterally opposing the first distal lateral end of the middle portion 1283. The strip comprises alignment features 1281a and 1281b along a lateral axis of the electrode. Remainder region 1284b can be a dangling portion of the current collector. Tab region 1284b is dented by an optional slot 1282b (e.g., D-slot) to engage with a busbar and comprises an area for fuse placement. In this example, the tab region 1284b has a height smaller than the height of the middle portion 1283, the smaller heigh being centred along the long axis of the current collector, the tab having angled (e.g., bevelled) sides. The trapezoidal shape of tab 1284b may promote edge alignment, reduce tab deformation, and improve bonding uniformity during lamination.

In some embodiments, a distal portion of a current collector comprises a narrowed fuse section formed by lateral cuts, side cuts, and/or a meandering (e.g., serpentine) path. The narrowed section may be positioned between an active material portion and a tab section. The geometry may concentrate electrical resistance to generate localized heating, e.g., during a surge current. The heating may cause controlled (e.g., and irreversible) deformation causing the fuse to open the current path, e.g., by melting. The arrangement may maintain normal conductivity during operation, while enabling predictable activation under abnormal conditions such as above a threshold. The threshold may comprise an electrical and/or thermal threshold.

FIG. 13 shows, in example 1300, a portion of a current collector. The current collector portion includes a distal portion including a winding (e.g., serpentine) narrow path, thus generating a fuse portion of the current collector. The distal portion of the current collector comprises an optional slot 1301 (e.g., D-slot) disposed in a tab body portion 1302. The tab body portion 1302 is aligned along a weld axis 1395 for coupling with a busbar. An electrical current path 1303 extends from an active material portion 1306 toward the tab portion 1302. Lateral cuts 1304a and 1304b along the lateral axis (X axis) are apparent in the fuse portion of the current collector. The lateral cuts can be formed using a knife, and/or a laser dicer. The lateral cuts 1304a 1304b define a fuse region therebetween. Side cuts such as 1305 along the heigh axis (X axis) normal to the lateral axis generate the serpentine path of the fuse, along which current 1303 flows between the tab region 1302 and the middle portion region of the current collector contacting active material 1306. The serpentine cut 1305. The serpentine cut 1305 is disposed between the active material portion 1306 and the tab portion 1302. The serpentine narrows the electrical current path 1303 to the meandering fuse region. A distal side section 1307a and a distal side section 1307b along the heigh axis, on the sides of the tab body portion 1302 are disposed beyond lateral cuts 1304a and 1304b. Side sections 1307a and 1307b are optionally removed from the distal portion of the current collector, to the sides of the fuse portion. A lateral axis 1390 defines a transverse alignment of the distal portion of the current collector, with the height axis being 1395. The serpentine cut of the fuse increases the effective fuse length within a limited portion of the distal current collector portion, which allows finer control of resistance and/or activation temperature, while preserving the footprint of the distal portion of the current collector. The serpentine cut 1305 can form a localized resistance zone in the electrical current path 1303. The localized resistance zone can generate Joule heating during a current surge event. The cuts 1304a and 1304b can reduce thermal mass in the serpentine fuse path. The reduced thermal mass can enable the fuse to reach an activation temperature within milliseconds during an electrical surge event. Removal of the distal sections 1307a and 1307b can reduce stiffness in the fuse region and/or assist in tuning the conditions (e.g., timing) of fuse activation. The positioning of the serpentine fuse between the active material portion 1306 and the tab portion 1302, preserves mechanical integrity at the height axis 1395. The mechanical integrity can be of a of a weld joint with the tab region. The geometry of the distal portion of the current collector can maintain thermal isolation of the fuse from the active material portion 1306 and/or can support consistent activation behavior. The distal portion design integrates patterned cuts and optional section removal into a single fabrication operation, e.g., to provide predictable, consistent, efficient, an/or robust, fuse activation in high-volume manufacturing.

FIG. 13 shows, in example 1350, a portion of a current collector including the distal portion having a serpentine fuse with lateral and side cuts. Example 1350 is a photographic image of example 1300. An optional slot 1351 is provided for engagement with a busbar. A tab portion 1352 is aligned along a height axis 1395 for coupling with the busbar. An active material portion 1356 is connected with a middle portion of the current collector disposed underneath the active material, the middle portion coupled with the distal portion including the fuse and tab portion 1352. The middle portion is coupled with the tab portion through through an electrical current path of the fuse such that a surge in current coming from the tab and directed into the middle portion of the current collector, will have to pass through the meandering path of the fuse. The current path passes through a serpentine fuse formed in the fuse region of the current collector, the fuse region being bordered by cut lines 1354b and 1354a, the fuse region comprising slits parallel to heigh axis 1395. The fuse is defined by a lateral cut 1354a, a side cut 1354b, and a series of six heigh cuts such as cut 1355 in the current collector, e.g., by a knife or laser dicer. The six heigh cuts are interdigitated, with each successive heigh cut bordering another one of the cut lines 1354b and 1354a interchangeably, to form a serpentine path of the fuse, the six height lines are equally spaced along the lateral direction parallel lateral axis 1390. The serpentine shape increases the effective fuse length in a limited tab area, providing controlled electrical resistance and predictable activation current. A distal section 1357a and a distal width section 1357b along the heigh axis, are positioned at opposite height (Z) ends of the tab. In an example, the distal sections 1357a 1357b are optionally removed from the tab body portion 1352. A lateral axis 1390 defines the width direction of the tab. In an example, the serpentine cut has a length of about 4.56 mm to set the required resistance for activation. The arrangement directs current from the active material portion 1356 to the middle portion of the current collector, and through the fuse to the tab portion 1352, and vice versa, e.g., allowing normal conduction under operating load and rapid isolation during a surge event.

In some embodiments, a distal portion of the current collector comprises a meandering (e.g., serpentine) fuse cut into a current collector in a fuse portion disposed between a middle portion of the current collector coupled with an active material and a tab portion of the current collector configured to couple with a busbar and/or terminal tab. The distal portion may comprise (i) a tab portion, (ii) an optional slot for the busbar, (iii) a cut forming the fuse, (iv) a tearable line bordering the tab portion, (v) a tearable portion, or (vi) any combination thereof. The cut portion (e.g. meandering path) may create a narrowed cross-section to control electrical resistance during a surge current. The tearable line may be formed by mechanical and/or laser dicing to allow controlled separation. The dimensional orientation of the fuse may be defined relative to a lateral axis and a width axis of the tab.

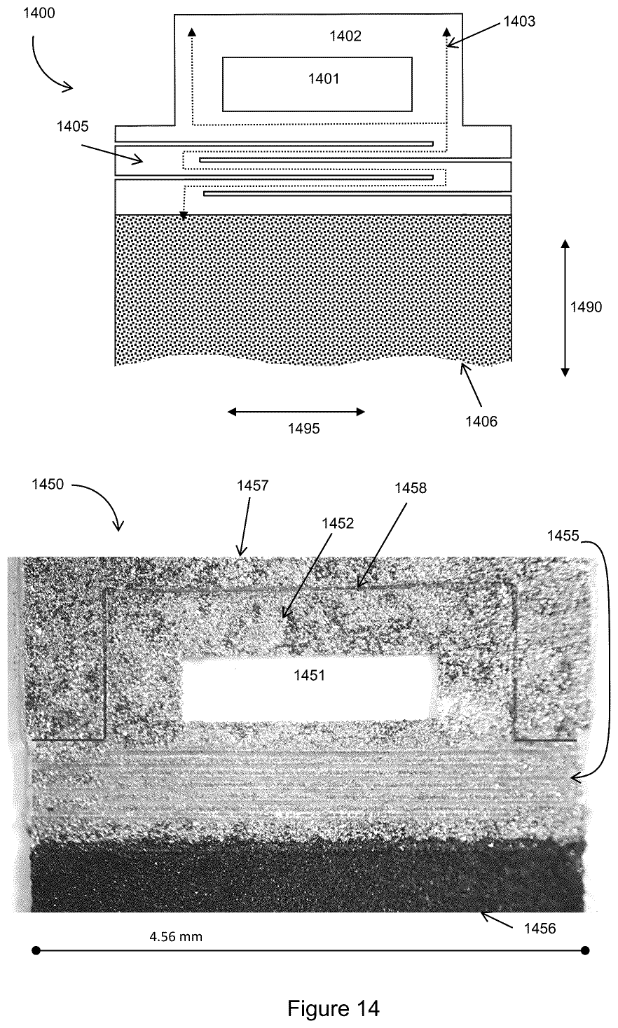

FIG. 14 shows an example 1400 of a distal portion of the current collector with a winding, e.g., serpentine, fuse. Example 1400 comprises a slot 1401 for engaging with a busbar. A tab portion 1402 extends between the slot 1401 and an active material portion 1406. An electrical current path 1403 extends from the middle portion of the current collector coupling active material 1406 through a serpentine cut 1405. The serpentine cut 1405 in the current collector can be produced using a knife and/or a laser. The cut forms a narrowed cross-section that can increase electrical resistance during a surge current. The configuration shown in example 1400 distributes mechanical load evenly across the height of the current collector, e.g., while providing rapid fuse activation. The meandering fuse path may extend the fuse length in a compact distal portion region of the current collector devoid of active material. The design may allow precise control of activation time and heat localization, e.g., with minimally (e.g., substantially without) reducing tab area destined for coupling, e.g., with a busbar and/or terminal tab. The absence of side cuts can reduce stress concentration, maintains higher mechanical strength in the tab, increase the threshold for fuse breakage, lower the number of operations required to generate the electrode, simplify process, reduce process operations, improve process robustness, reduce process errors, reduced debris during processing, and/or improves durability. The improved durability can be under vibration, electrical, and/or thermal, cycling. A lateral axis 1490 and a heigh axis 1495 define the dimensional orientation of the fuse region. As used herein, dimensional orientation refers to the alignment and measurement reference of the fuse region along two perpendicular axes, e.g., X axis and Z axis. The lateral axis 1490 (X axis) defines the lateral direction across the tab. The height axis 1495 defines the height (Z) direction through the height of the tab in the stacking view. The assembly in example 1400 promotes controlled electrical isolation during a short-circuit event.

FIG. 14 shows an example 1450 of a distal portion of a current collector with a winding, e.g., serpentine, fuse, the distal portion contacting a section of the middle portion of the current collector. Example 1450 is a photographic image of example 1400. A tab body portion 1452 extends between slot 1451 for busbar engagement, and a section of a middle portion of the current collector on which active material 1456 is deposited. A tearable line 1458 is formed in the tab body portion by creating a broken line of cuts. The cuts can be generated using mechanical and/or laser dicing. The electrical current path of the fuse extends from the active material region 1456 through meandering cut 1455. The meandering cut 1455 creates a narrowed cross-section to increase electrical resistance during a surge current. A current collector tearable portion 1457 is positioned adjacent to the fuse region to maintain edge stability. The active material portion 1456 in this example has a height of 4.56 mm along the height (Z) axis. The configuration may provide rapid and localized fuse activation, e.g., while maintaining mechanical stability under vibration and thermal cycling. The fuse is defined by a series of six heigh cuts such as cut 1455 in the current collector, e.g., by a knife or laser dicer. The six heigh cuts are interdigitated, with each successive heigh cut bordering another opposing sides along the height of the current collector (Z axis 1495) interchangeably, to form a serpentine path of the fuse, the six height lines are equally spaced along the lateral direction parallel lateral axis 1490 (X axis).

In some embodiments, a cell stack comprises a cathode current collector. The cathode current collector may be positioned between, and covered by, cathode active material layers along the stacking axis (Y axis). The cathode current collector may extend laterally (along the X axis) to an external busbar, with the fuse element being absent. Separators may be disposed between the cathode and opposing anode active material layers. An anode current collector may support the anode active materials. Spacer members, e.g., adhesive tape on the separators, may maintain stack alignment and/or compression along a stacking axis. The substantially continuous conductive path may reduce series resistance, maintain electrical conductivity, and/or improve thermal conduction, to the tab regions of each of the current collectors. The conductance may comprise electrical conductance, thermal conductance, or a combination thereof. The configuration may be selected where over-current (e.g., surge) protection is provided externally.

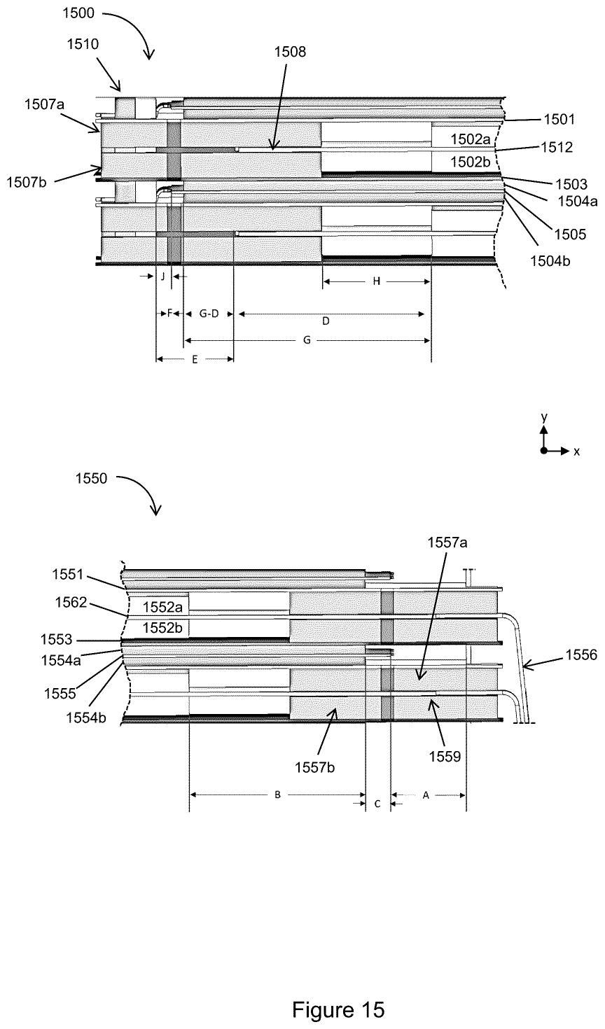

FIG. 15 shows example 1500, a cell stack portion devoid of a current collector fuse, on the left side of the cell stack relative to a Cartesian coordinate system. A cathode current collector 1512 is positioned between two cathode active material layers 1502a and 1502b. An anode busbar 1510 is engaged with anode tabs curved downwards towards the stacking axis, the anode busbar extending parallel to the stacking axis (Y axis). A current collector remainder portion 1508 is supported by a first spacer structure 1507a and a second spacer structure 1507b. First spacer structure 1507a is coupled with first separator 1501, the first spacer structure 1507a facing current collector remainder portion 1508. Second spacer structure 1507b is coupled with second separator 1503, the second spacer structure 1507b facing current collector remainder portion 1508. First separator 1501 is disposed between the cathode active material 1502a and an opposing anode active material similar to 1504b. A second separator 1503 is disposed between the cathode active material 1502b and an opposing anode active material 1504a. An anode current collector 1505 is coupled with the anode active material layers 1504a and 1504b at opposing sides of the anode current collector 1505 along the stacking axis. Spacer members 1507a and 1507b, (e.g., structured adhesive tapes applied to the separators) are positioned to maintain stack alignment and/or dimensional uniformity along the stacking axis. The spacer members may be inserted at least in part due to the cathode active material portion being laterally shorter than the anode active material portion. The absence of a fuse element allows a continuous metallic conduction path from the current collector to the busbar, reducing series resistance and maximizing electrical conductivity. The uninterrupted path may enhance thermal conduction from the electrode body to the tab, improving heat dissipation during high-rate cycling. Such configuration may be selected where over-current protection is implemented externally to the cell. The uniform compression profile created by the spacer members 1507a and 1507b promotes mechanical stability, vibration tolerance, robust design in manufacturing, robust design in use of the device, and/or increases manufacturing repeatability in high-volume production.

FIG. 15 shows example 1550, a cell stack portion devoid of a current collector fuse, on the right side of the cell stack relative to a Cartesian coordinate system. Example 1500 is a continuation of example 1550 along the lateral axis. A cathode current collector 1562 is positioned between two cathode active material layers 1552a and 1552b. Cathode anode tabs such as 1556, are curved downwards towards the stacking axis. A cathode busbar can extend parallel to the stacking axis (Y axis), cathode busbar not shown. A current collector distal portion 1559 is supported by a first spacer structure 1557a and a second spacer structure 1557b. First spacer structure 1557a is coupled with first separator similar to 1551, the first spacer structure 1557a facing current collector distal portion 1559. Second spacer structure 1557b is coupled with second separator similar to 1553, the second spacer structure 1557b facing current collector distal portion 1559. First separator 1551 is disposed between the cathode active material 1552a and an opposing anode active material similar to 1554b. A second separator 1553 is disposed between the cathode active material 1552b and an opposing anode active material 1554a. An anode current collector 1555 is coupled with the anode active material layers 1554a and 1554b at opposing sides of the anode current collector 1555 along the stacking axis. Spacer members 1557a and 1557b, (e.g., structured adhesive tapes applied to the separators) are positioned to maintain stack alignment and/or dimensional uniformity along the stacking axis. The arrangement maintains direct, low-resistance current flow from the cathode to the busbar with minimal (e.g., substantially without) interruption by a fuse element. The absence of a fuse increases electrical conductivity and reduces activation-related series resistance. The absence of a fuse increases the chance of harm from such a battery, e.g., in the absence of fuses in another relevant location. The structure maintains high thermal conduction paths through the tab region, improving heat spreading during high-rate operation. The configuration may be selected where over-current protection is provided by an external circuit protection device. The stable mechanical and thermal properties of the assembly may improve cycle life, vibration resistance, and lamination process consistency in high-volume manufacturing.

In some embodiments, the cell stack includes a supporting member. The current collector, e.g., fuse thereof, can be coupled with a supporting member. The separator can be coupled with the supporting member. The supporting member can comprise a tape. The tape may be (e.g., substantially) the same tape as the tape from which the spacer members are made of. The tape of the supporting member can be placed on a tape of the supporting member, e.g., that is in turn placed on a separator. A separator can include a tape for the supporting member, on top of which another tape layer can be placed—constituting the supporting member. A separator can include a tape for the supporting member, and a respective current collector facing the separator, can have (e.g., substantially the same) tape constituting the supporting member, the tape adhering to the current collector fuse portion. The supporting member may or may not have a width dimensionality of the spacer members along the stacking axis. The supporting member may be of a smaller width dimensionality than that of the spacer member along the stacking axis. The supporting member may be of a larger width dimensionality than that of the spacer members along the stacking axis. The supporting member may be configured to contact the fuse from a side of the current collector along the stacking axis. The supporting member may adhere to one spacer member among the two spacer members facing the fuse along the stacking axis. The supporting member may adhere to the fuse. The supporting member may contact the fuse in the cell stack, and not adhere to the fuse. Two spacer members and the supporting member, may have a collective dimensionality of the cathode active material, e.g., at its most expanded state. Inclusion of the supporting member within the longitudinal space of the electrode (e.g., cathode) may cause the current collector to deviate from lateral planarity. The supporting member may couple to the fuse portion of the current collector, e.g., by an adhesive such as disclosed herein. The supporting member may or may not have the material type of the spacer member. The supporting member may have at least one common material type with the spacer member, e.g., the material choices of the spacer members such as disclosed herein. The supporting member may have at least one material type different from that of the spacer member. The supporting member may comprise a polymer, a resin, any copolymers thereof, any mixtures thereof, or any other combinations thereof.

In some embodiments, the supporting member has (e.g., substantially) the same thickness along the stacking axis, as each spacer member disposed at both sides of the support. In some embodiments, the supporting member has a different thickness along the stacking axis, from each spacer member. The use of the same thickness may maintain uniform contact pressure along the stacking axis. The matched thickness may reduce shear stress at the interface between the supporting member and the fuse. The use of a different thickness may be selected to increase localized reinforcement and/or thermal insulation, e.g., at the narrowed fuse section. A thicker supporting member may distribute stress evenly into the spacer members. A narrower support may reduce thermal conduction away from the fuse during activation. The thickness relationship between the supporting member and the spacer members along the stacking axis, may be selected to balance the mechanical stability of the fuse e.g., during cycling with activation reliability such as during a surge event. The thickness relationship between the supporting member and the spacer members along the stacking axis, may be selected to allow activation of the fuse e.g., beyond the prescribed fuse activation threshold.

In some embodiments, the thickness of the supporting member along the stacking axis, is greater than the thickness of the fuse. The increased thickness may allow the supporting member to remain substantially intact when the fuse activates. The greater thickness may provide a thermal buffer between the activated (e.g., molten) fuse and the edge of the supporting member. In some embodiments, the thickness of the fuse may be an order of magnitude less than the thickness of the base. The thicker supporting member may reduce (e.g., prevent) localized heat from the transitioned (e.g., molten) metal from damaging the supporting member, e.g., a polymeric supporting member having a substantially lower melting point as the molten metal. The difference in thickness may maintain structural stability around the fuse gap, e.g., after fuse activation. The current collector material may melt at a temperature in the range of at least 600 of degrees Celsius (° C.), 900° C., or 1000° C. The supporting member's material may comprise a resin, a polymer, a copolymer, a plurality of types thereof, a mixture thereof, or any other combination thereof. The polymer may comprise polyethylene terephthalate, polypropylene, polyethylene, polyimide, any plurality of types thereof, or any combination thereof. The copolymer may comprise ethylene acrylic acid copolymer, ethylene vinyl acetate copolymer, ethylene methacrylic acid copolymer, any plurality of types thereof, or any combination thereof. The supporting member's material may have a melting temperature at least about 100° C., 120° C., or 150° C. The supporting member material may have a melting temperature at most about 250° C., 280° C., or 300° C. The supporting member material may have a melting temperature of any value between the aforementioned values, e.g., from about 100° C. to about 300° C. The fuse may be configured such that its melting temperature remains below the melting temperature of the rest of the current collector metal. The fuse may be configured to maintain mechanical stability, e.g., during normal operation and after fuse activation. The mechanical stability may be obtained with the aid of the spacer members and/or supporting member, e.g., at opposing sides of the fuse along the stacking axis. Relative to the fuse, a greater thickness of the supporting member and/or each of the spacer members, may reduce localized thermal exposure, e.g., during fuse activation. The thicker cross-section may allow thermal conduction away from the immediate activated (e.g., molten) region of the fuse. The thermal gradient across the thickness of the supporting member and/or spacer members, may limit their respective bulk softening. The thermal gradient across the thickness of the supporting member and/or spacer members, may limit their respective (e.g., plastic) deformation. The maintained integrity of the support may preserve the alignment of the distal current collector section, e.g., after fuse activation. The preserved alignment of the spacer members in the cell assembly, may maintain stack spacing and/or reduce (e.g., prevent) collapse of adjacent layers, e.g., during the prescribed operation of the cell assembly. The stability of the supporting member after activation, may promote (e.g., ensure) that compression distribution across the stack remains substantially unchanged.

In some embodiments, generation of the spacer construct causes the current collector to deviate from planarity by an angle, e.g., along a plane normal to the stacking axis (Y axis), the plane being along lateral axis and along the height axis (XZ plane). The deviation angle may depend at least in part on the thickness of the supporting member. The deviation angle may be controlled to remain within the dimensional tolerance of the assembly. The controlled angle may maintain parallel alignment between adjacent electrodes. The deviation may be minimized to reduce pressure non-uniformity on the active material, e.g., during lamination. The angle control may preserve uniform electrical contact between the current collector and the busbar and/or terminal tabs. The thickness of the supporting member may be selected to balance mechanical reinforcement with minimal geometric offset. The controlled planarity normal to the stacking axis—along the lateral axis (and height axis), may maintain stable thermal conduction paths, e.g., during fuse activation. The control of deviation from the lateral axis may maintain long-term durability of the electrode configuration during the prescribed operation of the cell assembly, e.g., during cycling. The planarity control may improve alignment consistency across multiple cell assemblies during high-volume manufacturing.

In some embodiments, a cell assembly comprises a narrowed fuse region in a current collector positioned between spacer members and supported by an adjacent support such as the separator. The spacer members may maintain uniform stack compression and alignment along the stacking axis. The support may stabilize the narrowed fuse section and control heat dissipation during activation. The spacer members may have an adhesive material coated onto at least one surface. The support may have the adhesive material coated onto at least one surface. The fuse region may be dimensioned to generate localized Joule heating under surge current, enabling rapid melting and electrical isolation of the shorted section. The arrangement may maintain planarity of the current collector within assembly tolerances and preserve long-term mechanical stability during cycling. The fuse region may have a length along its long path at least about 200 μm, 400 μm, 500 μm, 550 μm, 580 μm, 600 μm, or 700 μm. The fuse region may have a length at most about 400 μm, 500 μm, 610 μm, 620 μm, or 650 μm, 700 μm, or 800 μm. The fuse region may have a length of any value between the aforementioned values, e.g., from about 200 μm to about 800 μm. The support may have a thickness along the stacking axis at least about 10 μm, 15 μm, 20 μm, 30 μm, 40 μm, 45 μm, 48 μm, or 49 μm. The support may have a thickness at most about 20 μm, 30 μm, 40 μm, 51 μm, 52 μm, 55 μm, or 70 μm. The support may have a thickness of any value between the aforementioned values, e.g., from about 45 μm to about 55 μm, or from about 10 μm to about 70 μm. At least one of the spacer members may have a thickness having any value disclosed herein for the support. The current collector may be planar along the XZ plane (e.g., plane normal to the stacking axis). At least a portion of the current collector may deviate from planarity. The at least the portion of the current collector deviating from planarity may comprise a connecting region between the middle portion and the fuse portion, a connecting portion between the middle portion and the remainder portion, or any combination thereof. In some embodiments, laterally opposing connecting portions of the current connector deviate from planarity, e.g., at (e.g., substantially) the same deviation thickness along the stacking axis and/or substantially the same deviation angle. In some embodiments, laterally opposing connecting portions of the current connector deviate from planarity, e.g., the deviation being (e.g., substantially) symmetrical about the stacking axis of the cell assembly. The deviation angle of the current collector from planarity may be at least about 0.1°, 0.2°, 0.25°, 10, 5°, or 10° The deviation angle may be at most about 1.0°, 1.2°, 1.5°, 5°, 10°, or 15°. The deviation angle may be of any value between the aforementioned values, e.g., from about 0.1° to about 15°. The fuse region may be dimensioned to produce a controlled resistance. The controlled resistance may generate localized Joule heating during a surge current. The heat generation may enable fuse activation within a predetermined time window. The fuse activation may maintain mechanical stability and/or reduce thermal distortion of adjacent layers. The support and/or spacers may be dimensioned to maintain a uniform compression profile across the stack. The dimensioning may preserve positional alignment of electrodes and current collectors along the stacking axis. The dimensioning may control heat flow away from the fuse. The arrangement may maintain electrical isolation during fuse activation.

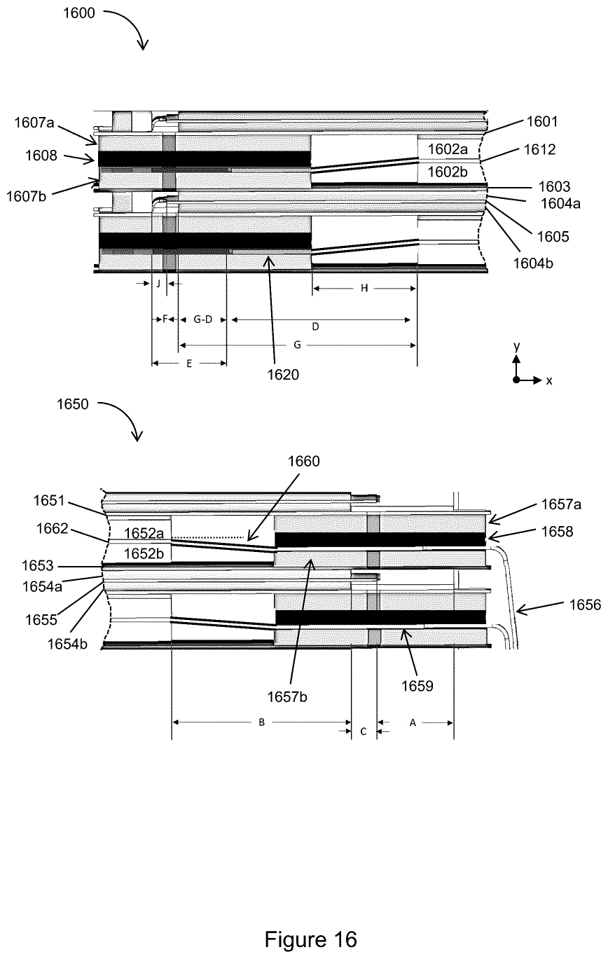

FIG. 16 illustrates, in example 1600, a cell stack with a current collector fuse relative to a Cartesian coordinate system. A separator 1601 is disposed adjacent to a cathode current collector 1612. Cathode active material 1602a and cathode active material 1602b are coated on opposing faces of the cathode current collector 1612. A separator 1603 is positioned between the cathode layers and anode layers. Anode active material 1604a and anode active material 1604b are coated on opposing faces of an anode current collector 1605. Spacer members 1607a and 1607b, each of the spacer members can be an adhesive tape. The spacer member 1607a couples with separator 1601. Spacer member 1607b couples with separator 1603. The separators are stacked along the stacking axis. The adhesive tape of the each of the spacer members can be about 50 μm thick along the Y axis. A supporting member 1608, is positioned adjacent to a remainder portion of the current collector 1620, e.g., to provide mechanical stability during manufacturing and/or handling. The supporting member can be a 50 μm adhesive tape. Due to the inclusion of supportive member 1608, the current collector deviates from lateral position of its middle portion depicted in 1612 its longitudinal position of the remainder portion, by an angle, e.g., to accommodate equally thick spacer members 1607a and 1607b, with supporting member 1608.

FIG. 16 illustrates, in example 1650, a cell stack with a current collector fuse relative to a Cartesian coordinate system. Example 1650 is right side continuation of the left side example 1600. Separator 1651 is disposed adjacent to a cathode current collector 1662. Cathode active material 1652a and cathode active material 1652b are coated on opposing faces of the cathode current collector 1662. A separator 1653 is positioned between the cathode layers and anode layers. Anode active material 1654a and anode active material 1654b are coated on opposing faces of an anode current collector 1655 along the stacking axis. Spacer members 1657a and 1657b, each of the spacer members can be an adhesive tape. The spacer member 1657a couples with separator 1651. Spacer member 1657b couples with separator 1653. The separators and spacer members are stacked along the stacking axis. The adhesive tape of the each of the spacer members can be about 50 μm thick along the Y axis. A supporting member 1658, is positioned adjacent to the fuse portion of the current collector, e.g., to provide mechanical stability during manufacturing and/or handling. The supporting member can be a 50 μm adhesive tape. Due to the inclusion of supportive member 1658, the current collector deviates from lateral position of its middle portion depicted in 1662 its longitudinal position of the remainder portion, by an angle, e.g., to accommodate equally thick spacer members 1657a and 1657b, with supporting member 1658. The arrangement generates a deviation angle 1660 of the current collector from planarity, which is controlled to remain within assembly tolerance. The fuse region 1659 concentrates electrical resistance to provide rapid heating during a surge current. The supporting member 1658 and the spacers 1657a and 1657b maintain structural integrity and reduce (e.g., prevent) distortion of the narrowed fuse section during assembly and operation. The configuration enables predictable fuse activation while preserving stack geometry, mechanical durability, and energy density.

In some embodiments, the fuse integration into the cell stack is compatible with manufacture using spacer members and/or supporting members. The spacer members and/or supporting members may be at a same height or different heights. The assembly process may remain unchanged for either configuration. The thickness of the supporting members and/or spacer members may define a controlled deviation angle of the current collector from planarity. The deviation angle may remain within assembly tolerance for high-volume production. The controlled geometry may maintain precise layer alignment in the stack. The configuration may reduce tooling changeover between cell variants. The uniform or adjusted heights may maintain consistent compression across the stack during lamination. The dimensional control may also preserve the thermal and/or mechanical environment around the fuse for predictable activation performance. In some embodiments, a fuse exhibits a rapid potential rise during an electric short-circuit event. The rise may occur when localized heating melts the narrowed fuse section. The activation may occur within milliseconds under high-current fault conditions. The open-circuit state may remain stable after activation to maintain electrical isolation.

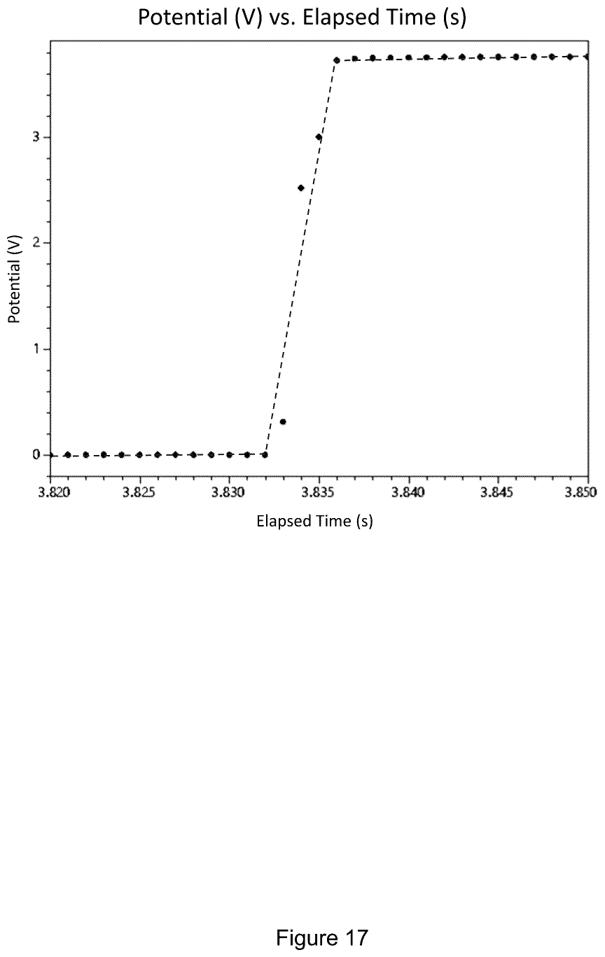

FIG. 17 shows a plot of potential (V) versus elapsed time (s) during an electric short-circuit (ESC) test of a fuse. The fuse is connected in series with a resistor of 80 mΩ and a known electrochemical cell at a bottom-of-charge state. The potential is measured across the fuse during the ESC event. The initial flat region indicates negligible potential drop across the fuse under low load. A rapid voltage rise occurs when the surge current through the narrowed section generates localized Joule heating. The heating elevates the fuse temperature to the melting point of the fuse material. The steep increase in potential corresponds to the opening of the current path. The post-activation plateau represents the open-circuit voltage of the test configuration. The time interval between the onset of voltage rise and the plateau indicates the activation time of the fuse under the defined ESC condition. The test demonstrates that the fuse interrupts the current path within milliseconds under a high-current fault while maintaining stable isolation after activation. The fuse was included in an aluminum current collector comprising an LCO based active material layer. In FIGS. 11, 13, and 14, images (e.g., photographs) of the current collector including the fuse were taken from an aluminum current collector comprising the LCO based active material layer.

In some embodiments, the spacer member and/or supporting member comprises an adhesive, e.g., an adhesive layer. The adhesive may comprise (i) carboxylic acid groups in acid form, (ii) carboxylic acid groups in salt form, and/or (iii) a mixture thereof. The acid form may be present in an amount at least twice, three times, four times, or five times greater than the salt form. The amount may be at most six times, five times, four times, or three times greater than the salt form. The amount may be of any value between the aforementioned values, e.g., from about two times to about five times greater. The adhesive material may comprise (i) ethylene/acrylic acid copolymer [poly(ethylene-co-acrylic acid)], (ii) ethylene acrylic acid ionomer, (iii) acrylic acid, and/or (iv) any combination thereof. The adhesive formulation may comprise a weight ratio of acid copolymer to ionomer. The ratio may be at least about 2:1, 3:1, 4:1, or 5:1. The ratio may be at most about 6:1, 5:1, 4:1, or 3:1. The ratio may be of any value between the aforementioned values, e.g., from about 2:1 to about 6:1. The transition (e.g., melting) point of the ethylene/acrylic acid copolymer may be at most about 77° C. The transition point of the ethylene acrylic acid ionomer may be at most about 91° C. (e.g., zinc acrylic acid salt). The selected formulation and/or ratio may enable thermal responsiveness such as disclosed herein. The formulation may support dual-surface adhesion across coated and/or uncoated regions of the constraint interface.

In some embodiments, the adhesive material is chemically inert to the chemistry of the electrochemical cell. The adhesive may resist degradation in the presence of electrolyte solvents and/or dissolved salts. The adhesive may be stable under exposure to lithium ions, carbonate mixtures, and/or reactive intermediates, e.g., under the prescribed use conditions such as disclosed herein. The adhesive may maintain dimensional and/or chemical stability, e.g., under the prescribed use conditions such as disclosed herein such as during cycling. The adhesive may reduce (e.g., avoid) releasing gases, decomposing, and/or triggering parasitic reactions, e.g., under the prescribed use conditions such as disclosed herein. The inertness may preserve interfacial stability between the constraint and/or the cell assembly. The chemical stability may be retained during, e.g., under the prescribed use conditions such as disclosed herein, e.g., during formation and/or repeated charge-discharge cycles during the prescribed lifetime of the device such as disclosed herein, e.g., of at least 500, 700, 1000, 1200, or 1500 charge and discharge cycles. The adhesive may resist chemical swelling and/or leaching, e.g., over the prescribed lifetime of the device such as over extended operational life. The inert property may sustain adhesion performance while minimizing (e.g., substantially without) compromising electrochemical compatibility.

In some embodiments, the adhesive material adheres to multiple surfaces in the electrochemical cell assembly. The adhesive may be utilized to adhere components of the cell assembly to each other. The adhesive may adhere to the separator, to the current collector, to the supporting member, and/or to the spacer member. The adhesive may be used to adhere the supporting member to the base (e.g., separator or current collector). The adhesive may be used to adhere the supporting member to the spacer member or to the current collector (e.g., fuse portion thereof). The adhesive formulation may support dual adhesion across heterogeneous interfaces. The adhesion may be retained through thermal cycles, volumetric changes (e.g., mechanical expansion), pressure, electrical cycling, and/or electrolyte exposure. The adhesive may sustain interface integrity between the coupled components during fabrication, prescribed lifetime of the device and/or prescribe use of the device, such as disclosed herein. The use may be the prescribed use of the device, buffering, electrode formation process, storing, transporting, upgrade, maintenance, or any combination thereof. The use may be under prescribed conditions, e.g., within jurisdictional standards. The adhesive may sustain interface integrity between the constraint and/or the cell during electrochemical cycling.

In some embodiments, the adhesive material adheres to components of the cell assembly. The components can comprise the supporting member, the spacer member, the separator, the current collector, or any combination thereof. The adhesive may form mechanical and/or chemical bonds with one or more of the components of the cell assembly. The adhesive may be compatible with smooth and/or textured surfaces. The bond strength may be maintained across insulated regions and/or bare metallic surfaces. The adhesion may support structural load transfer, e.g., during formation and/or operational charge and discharge cycling. The adhesive interface may remain (e.g., substantially and/or measurably) stable under thermal fluctuation and/or humidity exposure. The adhesion compatibility may allow flexible designs using coated and/or uncoated regions, within a single assembly.

In some embodiments, the adhesive maintains adherence between the rigid constraint and/or the cell assembly during its volumetric changes. The volumetric changes may occur during buffering, during cell formation, and/or during the charge and discharge cycles. The coupling of the adhesive with the rigid portion may persist during the prescribed use of the device, e.g., during formation of the electrochemical cell. The formation may comprise initial buffering with charge carriers and/or formation of a passivation layer. The adhesive may accommodate dimensional shifts in the cell assembly, e.g., without (e.g., substantial and/or measurable) loss of bonding such as during the prescribed lifetime of the device. The interfaces may remain stable across volumetric change, relaxation, and/or thermal transitions. The interface may include the interface between the adhesive and the separator, the adhesive and the current collector, the adhesive and the spacer member, the adhesive and the supporting member, or any combination thereof. The coupling may distribute stress forces (e.g., substantially) uniformly and/or to reduce (e.g., prevent) deformation of the adhered components, e.g., under the prescribed using to the device such as under cyclic stress. The coupling stability may improve structural reliability of the adhered components, e.g., during the prescribed use of the device and/or under the prescribed lifetime of the device such as under long-term cycling. The adhesive formulation may be optimized to maintain adhesion under multi-phase transitions, for example, during formation and/or active cycling.

In some embodiments, the adhesive is formulated to comprise carboxylic acid groups in acid form and/or salt form. The acid groups may be present in excess relative to the salt groups. The acid-to-salt ratio may be at least about 2:1, 3:1, 4:1, or 5:1. The acid-to-salt ratio may be at most about 6:1, 5:1, 4:1, or 3:1. The acid-to-salt ratio may be of any value before the aforementioned values, e.g., from about 2:1 to about 6:1. The excess of acid form may enhance bonding to metal oxide surfaces and/or polymer insulators. The salt form may contribute to ionic stability and/or mechanical cohesion. The adhesive formulation may promote interfacial bonding, e.g., without thermal, chemical, and/or mechanical degradation. The balance may be selected to maintain adhesive performance under the prescribed use of the device such as under cell formation and/or active cycling. The composition may be tuned for compatibility with the chemistry of the coupled components and of the rest of the chemistry of the manufactured device, e.g., battery.

In some embodiments, the adhesive material comprises acrylic acid derivatives. The acrylic acid derivative may comprise aliphatic polymers, branched polymers, acid form of acrylic acid, salt form of acrylic acid, copolymers, any mixture thereof, any plurality of types thereof, or any combination thereof. The adhesive may include (i) ethylene/acrylic acid copolymer [poly(ethylene-co-acrylic acid)], (ii) ethylene acrylic acid ionomer, (iii) acrylic acid, and/or (iv) any combination thereof. The copolymer may provide thermal response and/or flexibility. The adhesive may be elastic, e.g., under the thermal, electric, and/or mechanical conditions of the device such as under the prescribed use of the device. The ionomer may provide enhanced ionic conductivity and/or mechanical integrity. The acrylic acid may enhance adhesion to polar surfaces. The transition point of the adhesive may be at least about 70° C., 75° C., 77° C., or 78° C. The transition point of the adhesive may be at most about 85° C., 82° C., 80° C., or 78° C. The transition point of the adhesive may be of any value before the aforementioned values, e.g., from about 75° C. to about 80° C. The transition point of the adhesive may be about 91° C. (e.g., zinc acrylic acid salt). The composition of adhesive material may be selected based at least in part on the transition profile, flow characteristics, and/or bonding compatibility with the surfaces of the components to be coupled. The transition may comprise melting point, glass transition, softening, tackiness, or any combination thereof.

some embodiments, the adhesive composition is a blend of ethylene acrylic acid copolymer and/or ethylene acrylic acid ionomer. The ratio of copolymer to ionomer may be at least about 2:1, 3:1, 4:1, or 5:1. The ratio may be at most about 6:1, 5:1, 4:1, or 3:1. The ratio may be of any value before the aforementioned values, e.g., from about 2:1 to about 6:1. The ratio may be selected to achieve thermal responsiveness and/or ionic bonding strength. In an example, the adhesive is a 4:1 mixture of ethylene acrylic acid copolymer to ethylene acrylic acid ionomer. The selected ratio may enable optimal adhesion to rigid constraint portion (e.g., metal), coating (e.g., lacquer), and/or insulator (e.g., alumina) surfaces. The blend may balance flexibility, transition point, elasticity, ductility, tackiness, and/or (iii) interfacial wetting, for constraint, cell assembly, and/or liner, coupling applications.

In some embodiments, the adhesive comprises ethylene acrylic acid, ethylene acrylic salt, ethylene, polyethylene terephthalate, any copolymer thereof, any plurality of types thereof, or any combination thereof. Ethylene acrylic acid may provide strong adhesion, e.g., to the metallic surface of the fuse. Ethylene acrylic salt may maintain adhesion in the presence of electrolyte exposure, e.g., during cycling. Polyethylene terephthalate may provide high tensile strength and/or dimensional stability at elevated temperatures. The support material may provide optimization of thermal softening, mechanical reinforcement, and/or adhesion properties. The composition may be selected to maintain structural reinforcement of the fuse during assembly, lamination, and/or cycling. The support may maintain dimensional stability until the fuse activates. The support may retain partial structural integrity after activation, e.g., to preserve spacing and/or alignment in the cell assembly. The retention of partial structural integrity after activation may maintain uniform compression in the cell assembly. The retention may reduce the risk of misalignment over the life of the cell.

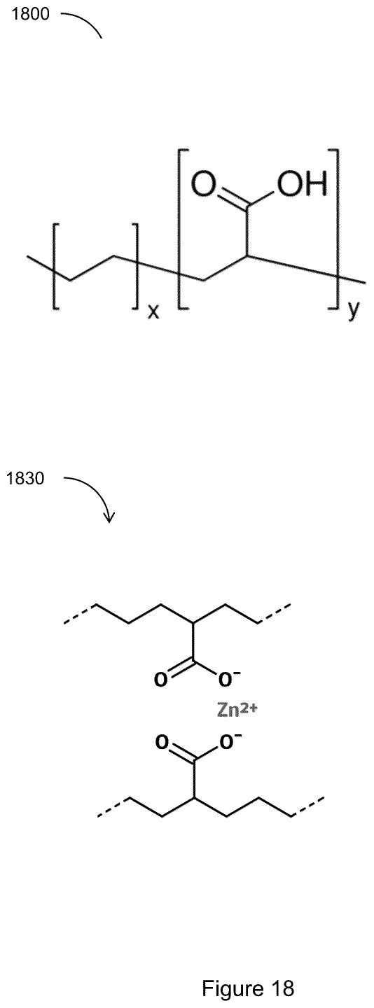

FIG. 18 illustrates two examples of adhesive polymer compositions applicable to the constraint system. Example 1800 shows the chemical structure of a copolymer comprising ethylene and acrylic acid units. The polymer chain comprises repeating —CH₂—CF₂— segments and —CH₂—CH(CO₂H)— segments. The molar ratio of ethylene to acrylic acid is denoted by x:y. The carboxylic acid groups provide polar functional sites capable of hydrogen bonding and/or ionic interaction. The ethylene segments can confer flexibility and thermal compliance. The structure corresponds to poly(ethylene-co-acrylic acid), which can bond effectively to metallic and/or oxide surfaces. Example 1830 shows a metal-coordinated ionic complex formed between acrylic acid moieties and a divalent cation. The structure comprises two carboxylate groups coordinated to a Zn²⁺ ion in a chelate geometry. The ionic interaction forms a crosslinked ethylene acrylic acid ionomer matrix. The crosslinks can enhance cohesive strength and/or reduce adhesive flow under thermal load. The Zn²⁺ ion can alter the melting behavior and/or adhesion profile of the material.

In some embodiments, the present disclosure comprises a method. The method may comprise at least one of (i) receiving calendered active material on a current collector, (ii) cutting holes for alignment and optional holes for busbar engagement, (iii) placing the current collector on a support, (iv) cutting slits for a fuse and a cuttable portion, (v) cutting the current collector into electrodes, or (vi) any combination thereof. The operations may be performed in sequence disclosed herein, in a different order, or with at least two operations done simultaneously or sequentially. The calendering may comprise compressing the active material at a pressure of at least about 1 tons (T), 2 T, 3 T or 5 T. The calendering may comprise compressing the active material at a pressure between the aforementioned pressure values, e.g., from about 1 T to about 5 T.

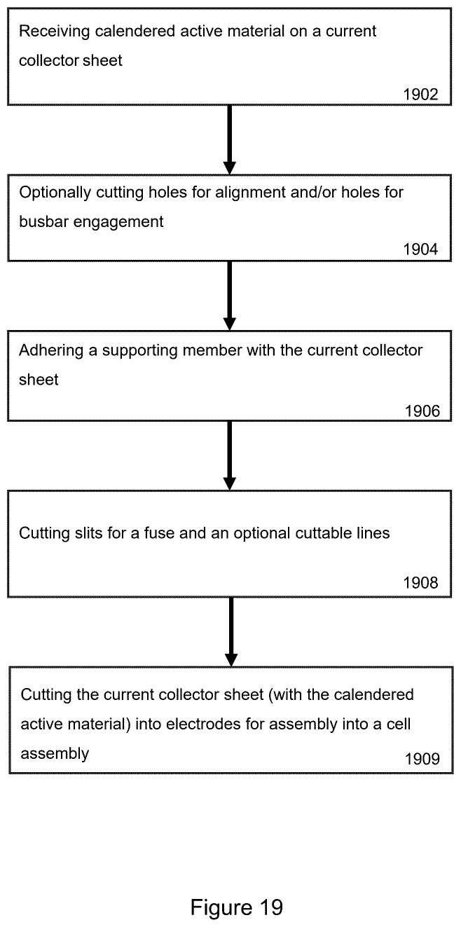

FIG. 19 shows a method flowchart 1900. The method comprises receiving calendered active material on a current collector sheet in block 1902. The calendering can be pressure-controlled and/or height-controlled. The method comprises optionally cutting holes for alignment and optional holes for busbar engagement in block 1904. The method comprises adhering a supporting member with the current collector sheet in block 1906. The method comprises cutting slits for a fuse and a cuttable portion in block 1908. The method comprises cutting the current collector sheet (with the calendered active material) into electrodes in block 1909. The operations in blocks 1904 to 1909 can be performed in sequence, in a different order, or with at least two operations done simultaneously or sequentially.

In some embodiments, the energy manipulation device (e.g., battery) is utilized for providing energy to electrical devices (also referred to herein as “target device”). The target device(s) may include smartphone, tablet, wearable electronics (watches, glasses, health tracks), power bank (e.g., for mobile devices), micro portable devices (drones, cameras, smart card), mobile Wi-Fi, Bluetooth headset, smart home related device (IoTs), electric toothbrushes, precision grooming tools, small-scale gardening equipment, (e.g., service) robots, (e.g., compact) medical such as chest compression, cosmetics, (e.g., compact) exercise, other wellness devices, learning tools, UAVs (drones) such as for short distance, e.g., racing, short distance, and military drones, torpedoes, and missiles. The target device may comprise a vehicle. The vehicle may comprise a ship, a spacecraft, an airplane, a helicopter, a spaceship, a train, a car, or a truck. The target device may comprise industrial equipment, online banking tools (e.g., a bank Ukey), Bluetooth enabled devices, EVs (e.g., including consumer, bikes, race cars, scooters), body worn vests, warmers, coolers, cameras, Internet of Things (IoTs), Wearables, watches, e-cigarette, augmented reality (AR) glasses, virtual reality (VR) glasses, sensors, hearing devices, smart glasses, or any combination thereof. The energy manipulation device (e.g., battery) may be utilized for any battery powered electronic product. The robots may be servicing robots for cargo, e.g., maneuvering. The cargo maneuvering may be within a facility, or between facilities. The robot may comprise a warehouse robot. The EV can comprise a UAV. The EV may comprise a UAV. The energy manipulation device may be utilized for control. The energy manipulation device may be utilized for video streaming, e.g., an MP3 player. The drone may be an underwater drone and/or an aerial drone. The target device may comprise a cellular phone. The target device may be a portable device, a notebook computer, an electric toy, or an electric tool. The vehicle can be a pure electric vehicle, a hybrid electric vehicle or a range-extended vehicle. The spacecraft may include airplanes, rockets, space planes, or a spaceship. The electric toy can comprise a fixed toy, or a mobile toy. The toy may comprise a game machine, or an electric vehicular toy. The vehicular toy may comprise any vehicle type disclosed herein. The power tools may comprise metal cutting tools, grinding tools, assembly tools, or railroad tools. The power tools may comprise electric drills, electric grinders, electric wrenches, electric screwdrivers, electric hammers, impact drills, concrete shakers, or electric planers.

In some embodiments, the device is manufactured. The device can be fabricated (e.g., fabricated). The environment may or may not be an ambient environment. The environment may comprise one or more environmental characteristics different than those of the ambient environment. The one or more characteristics may comprise a lower concentration of reactive agent, a higher temperature, or a higher pressure. The reactive agent may react with one or more components of the device, e.g., during its use, storage, shipping, maintenance, and/or fabrication. The cells may be fabricated according to any configuration disclosed herein, and using any material disclosed herein, as appropriate. The tabs may be folded, welded, adhered to a tacky connector, and/or adhered to a solid busbar. The manufacturing process (e.g., of any component disclosed herein) may comprise printing, stenciling, heat application, heat transfer, stamping, stenciling, dicing, any combination thereof, or any plurality thereof, as applicable. The application may comprise deposition. The printing may comprise stencil printing, direct printing, or sublimation printing. One or more operations of the manufacturing may be controlled by a control system, e.g., comprising at least one controller such as any control system disclosed herein.

In some embodiments, the cells are manufactured, e.g., to form a battery. An insulator and/or adhesive (e.g., tacky material) may be applied such as at a glass or at a melting temperature of at least one component of the adhesive, e.g., at a temperature of at least about 100° C., 150° C., 200° C., or 250° C. The application of the adhesive and/or insulator can be at least at ambient pressure, or above ambient pressure, e.g., at a pressure of at least about 14.5 psi, 14.7 psi, 20 psi, or 25 psi. The adhesive and/or insulator may harden. The adhesive and/or insulator may have a thickness of at least about 50 μm, 100 μm, or 150 microns (μm). The adhesive and/or insulator may have a resistance, e.g., of at most about 0.1 milliohms (mΩ), 0.2 mΩ, 0.5 mΩ, 1 mΩ, or 2 ohms (Ω).

In some embodiments, the system, device, and/or apparatus disclosed herein comprises a control system. The control system may comprise one or more controllers. The control system may comprise, or be operatively coupled with, one or more devices, apparatuses, and/or systems of the mechanism (e.g., system, device, or apparatus) disclosed herein, including any component of the device(s), apparatuses(s), and/or system(s). The controller(s) may comprise, or be operatively coupled with, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a control system. A control system may comprise a laser control system. The controller may comprise a feedback control scheme. The feedback control scheme may comprise an open feedback loop control scheme. The feedback loop control scheme may comprise a closed feedback loop control scheme. The feedback control scheme may comprise hardware compensation. The feedback control scheme may comprise software compensation. The control system may comprise, or be operatively coupled with, a metrological detection system and configured to receive measurement data from the metrological detection system. The control system may be configured to generate control signals responsive to the measurement data collected by the metrological detection system.

In some embodiments, the systems, apparatuses, devices, and/or components thereof disclosed herein comprise one or more controllers. The one or more controllers can comprise one or more central processing unit (CPU), input/output (I/O) and/or communications module. The CPU can comprise electronic circuitry that carries out instructions of a computer program by performing arithmetic, logical, control and I/O operations specified by the instructions. The controller can comprise a suitable software (e.g., operating system). The control system may optionally include a feedback control loop and/or feed-forward control loop. The controllers may be shared between one or more systems or apparatuses. Each apparatus or system may have its own controller. Two or more systems and/or their components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller system may comprise a single input single output controller (SISO) or a multiple input multiple output controller (MIMO). The controller may interpret the input signal received. The controller may acquire data from one or more sensors. Acquiring may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof.

The outputs may include a display (e.g., screen), speaker, or printer. The control system may use control protocols, e.g., including modbus, Open Platform Communication Unified Architecture (OPCUA), EhterNet/IP, PROFINET, Profibus, MQTT, EtherCAT, IO-Link, FANUC FOCAS, and/or LSV/2, as applicable. The control system may utilize control logic, e.g., including programmable logic controllers (PLCs), Supervisory Control and Datra Acquisition (SCADA), Distributed control systems (DCS), integrated automation systems, and/or edge computing and Industrial Internet of Things (IIoT), as applicable. The control may include machine to machine control, user to machine control (e.g., user provides input to machine), or machine to user control (e.g., providing input to a user). The control system may utilize controller area network (CAN) and/or CAN open protocols.

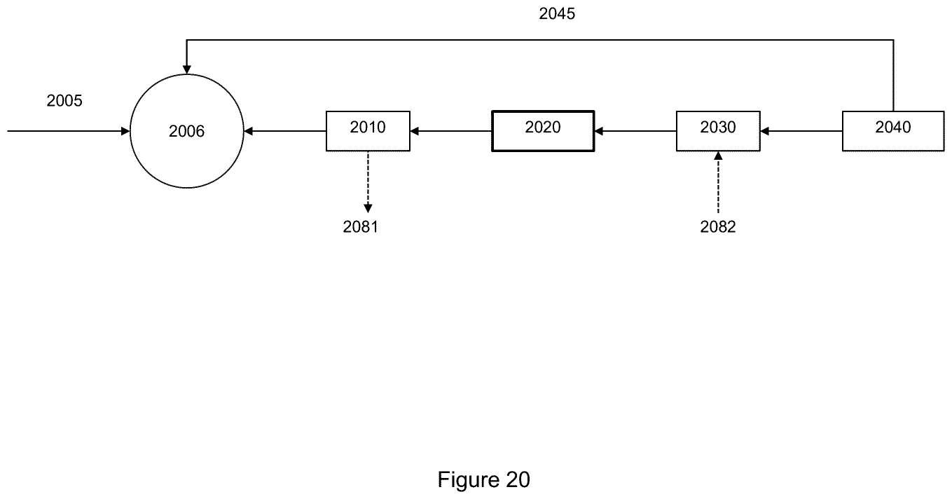

FIG. 20 shows a schematic example of process 2020 controlled using a control system in a feedback loop control scheme, e.g., in a closed loop control scheme. The control system receives set point 2005 to comparator 2006 that generates an error signal, which is fed 2045 into controller 2040. In other control systems, the comparator can be part of the controller. Controller 2040 generates a control signal that is fed into controlling element 2030. The controlling element may comprise a mechanism utilized for its control function to control process 2020. Controlling element 2030 provides an input to process 2020. The mechanism may effectuate a physical and/or a chemical change, which change is the input to process 2020. The physical change may comprise mechanical change, magnetic change, electromagnetic change, piezoelectric change, electrical change, pressure change, or temperature change. The chemical change may comprise a change in a chemical gradient, or in a chemical entity. Process 2020 can be any process disclosed herein, e.g., any method such as a fabrication (e.g., manufacturing) method. Process 2020 generates an output detected by measuring element 2010, e.g., using its sensor(s). The output provided by process 2020 may be a reaction of the process to the input provided by control element 2030. Measuring element 2010 generates a variable amplitude signal that is fed back into comparator 2006 and is again compared with the setpoint. Measuring element 2010 optionally also generates a controlled variable 2081. Control element 2030 optionally also receives a manipulated variable 2082, e.g., from an external source such as a processor and/or a communication system. Sensor(s) can be used by measuring element 2010 for the measurement of parameters of the process, e.g., 2020. The sensor measurement can be a determination of an amplitude of a parameter such as of a material, e.g., as disclosed herein. In an example, the value of the measurement is consistent and repeatable. The sensor(s) can convert the physical parameters (e.g., repeatedly, and reliably) into a usable form by the control system, e.g., into an electrical signal such as in a digital form. The comparator can perform an error detection, e.g., by determining a difference between the amplitude of the measured variable and a requested set reference point (e.g., set point 2005), which difference is the error signal. The error signal can be amplified and/or conditioned such as filtered. The signal amplification and/or conditioning may be performed by an external component to the controller (e.g., 2040), or within the controller. The reference point (e.g., set point) can be stored in the memory of the controller, or of a memory operatively coupled with the controller. The controller can be a (e.g., micro-) processor-based system that can determine the next operation to be taken in a process. The process may be sequential. The controller may evaluate the error signal in a continuous process control system, e.g., to determine what action is to be taken. The controller (e.g., 2040) can condition the signal, or be operatively coupled with a unit conditioning the system. Conditioning the signal may comprise noise filtering. Conditioning the signal may comprise correcting the signal for a non-linearity in the sensor. The controller may include the parameters of the process input control element. The controller may condition the error signal to direct the control element, e.g., 2030. The controller can monitor input signal(s). The input signals may be interrelated. The controller may be configured to direct at least two control elements in concert. The controller may be configured to direct at least two control elements simultaneously. The controller may be configured to direct at least two control elements sequentially. The control element (e.g., 2030) can be a device that controls an incoming material to the process, or any other attribute of the process comprising a physical attribute or a chemical attribute. The physical attribute may comprise mechanical, magnetic, piezoelectric, electromagnetic, electrical, pressure, or temperature attribute. The chemical attribute may comprise a chemical gradient, or in a chemical entity. The control element can be a flow control element. The control element can be a temperature control element. The control element can have toggle (e.g., On/Off) characteristics. The control element can provide linear, or non-linear, control of the control element. The control element can be used to adjust the input to the process, e.g., bringing the output variable to the value of the set point. The measuring element (e.g., 2010) can consist of sensor(s) to measure the physical property of a variable, a transducer to convert the sensor signal into an electrical signal, and/or a transmitter to amplify the electrical signal. The amplification of the signal can be transmitted with minimal (e.g., without measurable) loss. The control element may comprise an actuator which changes the electrical signal from the controller into a signal to operate and/or control a physical device such as a valve. The controller may comprise a memory or be operatively coupled with a memory. The control system may comprise a summing circuit, e.g., to compare the set point to the sensed signal, so that it can generate the error signal. The summing circuit may be part of the comparator. The controller may use the error signal to generate a correctional signal to control the control element. In an example, the controller controls a valve via an actuator and the input variable. The sensors of the measuring element may comprise optical sensors, temperature sensors, pressure sensors, chemical sensors, proximity sensors, viscosity sensors, chemical sensors, or any other sensor disclosed herein. The chemical sensors may sense a material comprising oxygen, water, or any other reactive agent(s) herein. The sensors may be configured to sense one or more attributes of the methods disclosed herein such as the fabrication methods.

In some embodiments, modeling is utilized to at least in part generate and/or optimize, the open loop control scheme. The modeling may comprise performing data analysis. The data analysis may comprise artificial intelligence, e.g., utilized in a learning module. In some embodiments, the data analysis comprises at least one of: linear regression, least squares fit, Gaussian process regression, nonparametric multiplicative regression (NPMR), kernel regression, regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), Lebesgue measure, group method of data handling (GMDH), Naive Bayes classifiers, k-nearest neighbors algorithm (k-NN), singular value decomposition, fuzzy measure theory, Borel measure, Harr measure, risk-neutral measure, support vector machines (SVMs), neural networks, support vector machines, classification and regression trees (CART), random forest, gradient boosting, generalized linear model (GLM) technique, or any combination thereof.

Control may comprise regulate, modulate, adjust, maintain, alter, change, govern, manage, restrain, restrict, direct, guide, oversee, manage, preserve, sustain, restrain, temper, or vary.

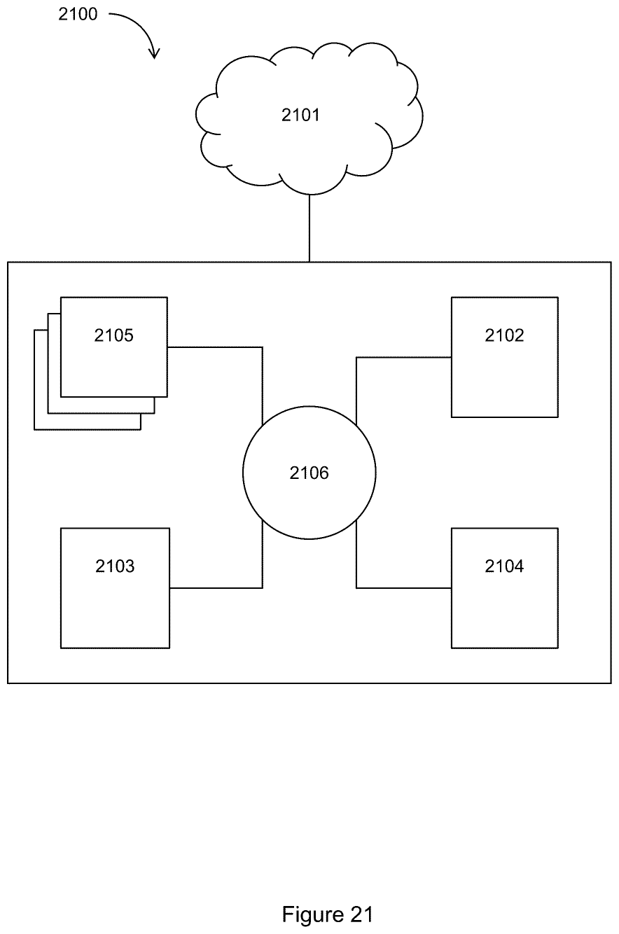

In some embodiments, the device, system, and/or apparatus disclosed herein comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor may be programmed to implement methods of the disclosure. The controller may control at least one component of the systems and/or apparatuses disclosed herein. FIG. 21 shows a schematic example of a computer system that is programmed or otherwise configured to facilitate execution any of the methods provided herein. The computer system can control (e.g., direct, monitor, and/or regulate) various features of the methods, apparatuses, devices, and/or systems of the present disclosure. The computer system can be part of, or be in communication with, the device, system and/or apparatus disclosed herein. The computer may be coupled with one or more mechanisms disclosed herein, and/or any parts thereof. The computer system can include a processing unit 2106 (also “processor,” “computer” and “computer processor” used herein). The computer system may include memory or memory location 2102 (e.g., random-access memory, read-only memory, flash memory), electronic storage unit 2104 (e.g., hard disk), communication interface 2103 (e.g., network adapter) for communicating with one or more other systems, and peripheral devices 2105, such as cache, other memory, data storage and/or electronic display adapters. The memory 2102, data storage unit 2104, interface 2103, and peripheral devices 2105 are in communication with the processing unit 2106 through a communication bus (solid lines), such as a motherboard. The storage unit can comprise a data storage unit (or data repository) for storing data. The computer system can be operatively coupled with a computer network (“network”) 2101, e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server. The processing unit 2106 can execute a sequence of machine-readable instructions, which can be embodied in a program or software. The instructions may be stored in a memory location, e.g., memory 2102. The instructions can be directed to the processing unit 2106, which can subsequently program or otherwise configure the processing unit to implement methods of the present disclosure. Examples of operations performed by the processing unit 2106 can include fetch, decode, execute, and write back. The processing unit 2106 may interpret and/or execute instructions. The processing unit 2106 may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit 2106 can be part of a circuit, such as an integrated circuit. One or more other components of the system (e.g.,) can be included in the circuit.

In some embodiments, the storage unit (e.g., 2104) stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet. The processor may be configured to process control protocols, e.g., communicate with one or more components of the mechanism (e.g., device, apparatus, and/or system) disclosed herein using the control protocols. Control protocols can be one or more of the internet protocol suites, e.g., transmission control protocol (TCP) or transmission control protocol/internet protocol (TCP/IP). Control protocols can be one or more serial communication protocols. Control protocols can be one or more of controller area networks or another message-based protocol, e.g., for communication with microcontrollers and devices. Control protocols can interface with one or more serial bus interfaces for communication with the mechanism disclosed herein, e.g., with any of its components. The control protocol can be any control protocol disclosed herein.

In some embodiments, the system, device, and/or apparatus disclosed herein comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine executable code. Methods described herein can be implemented by way of machine (e.g., computer processor) executable code stored on an electronic storage location of the computer system, such as, for example, on the memory 2102 or electronic (e.g., data) storage unit 2104. The machine executable or machine-readable code can be provided in the form of software. During use, the processor (e.g., 2106) can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine that has a processer adapted to execute the code or can be compiled during runtime. The code can be supplied in a programming language that can be selected to enable the code to execute in a pre-compiled or as-compiled fashion.

In some embodiments, the computer system utilizes a machine-readable medium/media to execute, or direct execution of, operation(s). The program instructions can be inscribed in a machine executable code. A machine-readable medium/media, such as computer-executable code, may take many forms, including but not limited to, a tangible storage medium/media, a carrier wave medium, or physical transmission medium. Non-volatile storage media/medium include, for example, optical or magnetic disks, such as any of the processor related storage devices in any computer(s) or the like, such as may be used to implement the databases. Volatile storage media/medium can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium/media with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or data storage may comprise a storing device external to and/or removable from device, such as a Universal Serial Bus (USB) memory stick, and/or a hard disk. Many of these forms of computer readable media may be involved in carrying one or more sequences of one or more instructions to a processor for execution.

In some embodiments, the device, system, and/or apparatus disclosed herein comprises, or is operatively coupled with, a communication technology, e.g., in addition to the optical fiber disclosed herein. The communication may comprise wired or wireless communication. For example, the systems, apparatuses, and/or parts thereof may comprise Bluetooth, wi-fi, global positioning system (GPS), or radiofrequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro- or mini-USB. The surface identification mechanism may comprise a plug and/or a socket, e.g., electrical, AC power, DC power. The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In accordance with methodologies disclosed herein, testing has been performed to evaluate fuse activation and thermal response in a cell assembly. The examples disclosed herein, assess activation timing, circuit disconnection, and temperature behavior, under short-circuit and nail penetration conditions.

Example 1—In one example, a support comprising a tape of polyethylene terephthalate (PET) was used in a cell assembly. The cathode comprised lithium cobalt oxide (LCO) on an aluminum (Al) foil current collector. The electrolyte comprised a solvent mixture of propylene carbonate (PC) and dimethyl carbonate (DMC) in a 70:30 volume ratio. The PET support maintained mechanical stability of the narrowed fuse section during assembly. The configuration provided a stable interface between the cathode tab and the spacer construct. The PET support preserved alignment of the tab section during lamination and testing.

Example 2—In one example, a fuse with a single-wave geometry and a resistance of 0.12 ohms responded in less than 4 milliseconds to open on shorting a 3.7-volt load in series with a 0.08-ohm resistor. The coupon sample was tested, while submerged in a beaker containing a 70:30 volume ratio solvent mixture of propylene carbonate (PC) and dimethyl carbonate (DMC) as the electrolyte. The single-electrode fuse may protect against a nail penetration or an internal short, with a resistance of less than about 2.5 ohms. Above a short resistance of about 2.5 ohms, the shorting current may be less than about 1.7 amperes. The test results are shown in FIG. 17.

Example 3—In one example, experiments were conducted to evaluate fuse activation during a nail penetration event. The current increased until the fuse activated and melted. The fuse disconnected the shorted and molten section from the terminal circuit. During the nail penetration test, the temperature of the cell increased slightly due to heating at the shorted fuse. The temperature increase was not sufficient to trigger a thermal runaway event.

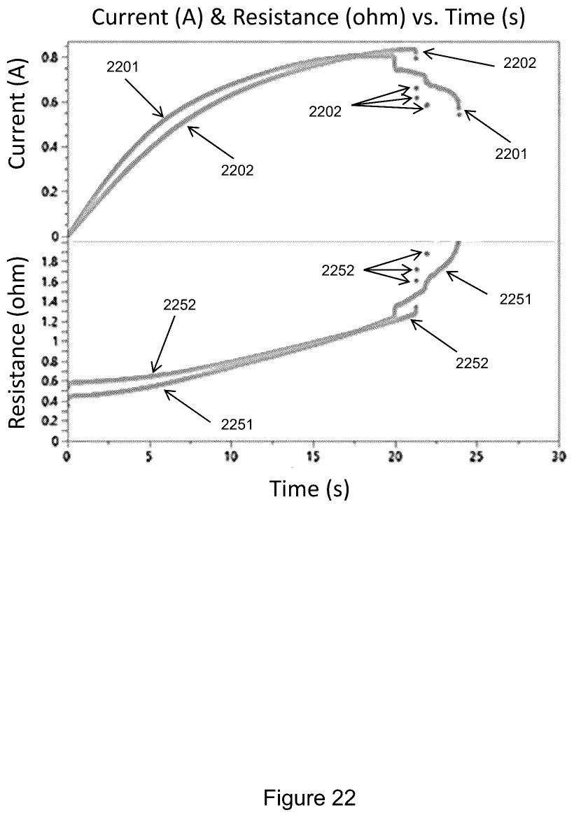

FIG. 22 shows the results of an electrical overload test for samples A and B. A distal end of the tab is coupled with one side of a closed electrical loop, and the other side of the loop is coupled with the active material region of the cathode. The configuration forces the current to pass through the fuse. The upper graph shows current versus time. Samples A and B represented duplicate experiments. Sample A is represented by trace 2201. Sample B is represented by trace 2202. The current increases until the fuse opens. The lower graph shows resistance versus time. Sample A is represented by trace 2251. Sample B is represented by trace 2252. The activation profiles of both samples coincide, with small variations attributed to process tolerances. The cathode comprises lithium cobalt oxide (LCO) on an aluminum (Al) current collector. The fuse operates at 0.15-0.30 amperes per wave. The aluminum fuse has a thickness of about 12 μm for sample A. The minimum laser-ablated linewidth is about 70 μm.

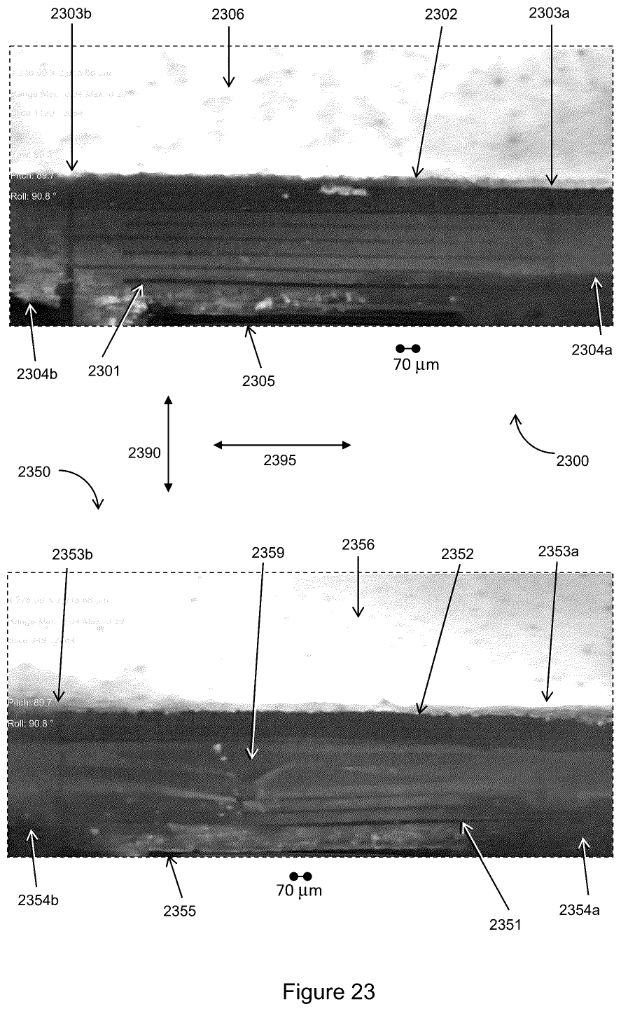

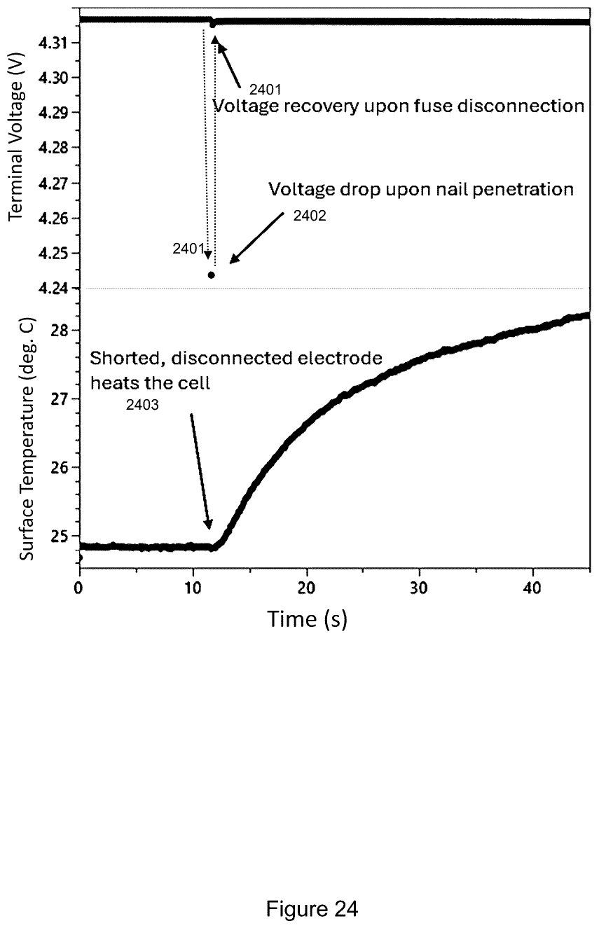

In tests shown in FIGS. 23 and 24, a nail penetration event caused the voltage to drop, the fuse to activate, and the circuit to disconnect. The voltage then returned toward its initial value. The temperature increased slightly, e.g., by about 3° C. The residual temperature rise did not result in thermal runaway.

FIG. 23 shows example 2300 and example 2350. Example 2300 and example 2350 are X-ray images of a fuse used in a nail penetration test. Example 2300 shows an undamaged fuse reference image. A lateral side slit 2303a is visible on one side of a fuse portion 2302 of a current collector. A lateral side slit 2303b along a lateral axis is visible in the distal portion 2302 comprising a fuse portion, the distal portion being devoid of an active material layer. An active material layer 2306 couples with a middle portion of a current collector (not visible). The fuse portion is positioned between lateral side slit 2303a and its opposing lateral side slit 2303b along the height axis. A distal section 2304a is located on one height end of the distal portion, opposing to distal section 2304b, the distal sections bordering the fuse portion of the distal portion of the current collector. The distal portion comprises six slits such as height slit 2301 (slit along the height axis 2395—Z axis). The six slits are positioned at a central location along the distal portion 2302, which six slits are disposed in the fuse portion of the current collector. The height slits are dimensioned to a defined spacing to control fuse activation behavior. An opening for busbar engagement 2305 is located in distal portion 2302. The opening for busbar engagement 2305 (D-slot) provides a clearance for mechanical coupling to the busbar. A lateral axis 2390 is defined across the distal portion 2302. The lateral axis 2390 (x axis) aligns the side slit 2303a, the side slit 2303b, and the active material portion 2306. A height axis 2395 (z-axis) is defined along the distal portion 2302. The height axis 2395 aligns the section 2304a, section 2304b, and the opening for busbar engagement 2305. The six slits are interdigitated and staggered to generate the meandering fuse in a similar manner to those depicted in FIG. 13, with every consecutive height slit contacting another one of opposing lateral slits 2303a and 2303b. The slits are disposed in an equidistance manner along the lateral axis. A width of the slits along the lateral axis is (e.g., substantially) the same. A width of the fuse portions along the lateral axis is (e.g., substantially) the same.

Example 2350 is an X-ray image of the fuse of example 2300 after its fuse has been activated after a nail penetration test. A lateral side slit 2353a is visible on one side of a distal portion 2352 of the current collector devoid of active material. An opposing lateral side slit 2353b is visible on the opposite side of the distal portion 2352 of the current collector. An active material 2356 is positioned on a section of a middle portion of a current collector. The fuse portion is disposed between the lateral side slit 2353a and the lateral side slit 2353b. A physical disconnection 2359 is visible in the fuse portion of distal portion 2352 of the current collector. A height slit 2351 is present along the height of distal portion 2352. Section 2354a is present at one end of distal portion 2352, opposing section 2354b, forming a border for the fuse portion along the height axis. An opening for busbar engagement 2355 is positioned in the distal portion 2352. A scale bar of 70 μm is shown for dimensional reference in the X-ray image. The scale bar provides a measurement reference for the features of the fuse and tab body.

FIG. 24 shows the results of a nail penetration test for terminal voltage and surface temperature. The upper graph shows terminal voltage versus time. A penetration of a nail causes a voltage drop 2402. The fuse activates and disconnects the shorted section of the electrode from the terminal circuit. A voltage recovery 2401 occurs upon fuse disconnection. The lower graph shows surface temperature versus time. A shorted, disconnected electrode 2403 heats the cell. The surface temperature increases slightly, e.g., by about 3° C. The temperature rise does not result in a thermal runaway event.

As illustrated and discussed herein, systems and methods are disclosed for mitigation of catastrophic failure due to ISC which do not compromise working performance and energy density of secondary batteries. A previously disclosed solution adds a resistor between the electrodes and busbar using an electrically conductive polymer adhesive to throttle discharge current to a short but can sometimes allow a battery cell to accrue high temperatures under suboptimal circumstances. Further, if the resistance is largely determined by contact resistance, variability between electrode to busbar connections may compound due to various processing factors and through the life of the battery due to changes in the polymer adhesion (for instance, due to swelling in electrolyte and mechanical fatigue). In contrast, the resistance in this proposed design is controlled by geometry of a metal that can be pre-screened for defects prior to assembling the electrodes into a stack, as the connection to the busbar is established by metal-to-metal laser weld, with proven reliability. Early demonstrations show variations of +/−0.1 ohm.

In an example, another solution, the J-slot—a design where a free-standing cross-section of a current collector is necked to the size of a filament which can fuse open under a given current—has been shown to reliably disconnect an electrode from the terminal circuit path, but does not always activate quickly enough prevent ignition at the short location. Also, freestanding J-slot is mechanically weak and expected to have reliability challenges over the long lifetime of a battery. The proposed design in this disclosure activates similarly to the J-slot design while also throttling current to the short location like the conductive adhesive resistor between the electrodes and busbar design.

In an example, incorporating fusible segments within the current collectors could activate above a threshold current to disconnect the circuit and interrupt current flow to an ISC location from regions upstream of the fuse, including from other electrodes connected to the shorted electrode through their shared busbar. The fuse segment could be a narrowed cross-section of metal current collector between the region where active material is laminated and its connection point with the busbar. To mitigate failure caused by particularly low-resistance ISC connections, the length of the narrowed region may be extended to provide a series resistance which throttles the rate of current flow travelling from the busbar to the short, allowing the fuse more time to activate before the short location reaches a temperature of concern. The narrow fuse cross-section of the current collector is mechanically reinforced for reliable stability during everyday working performance by lamination to a tape. The fuse segment would be applied to each individual electrode connected to the selected busbar (can be applied to either cathode or anode, application to both is redundant and unnecessary).

For example, as shown herein, the fuse design has a narrow fuse section that would preferably be made of aluminum and incorporated into the cathode current collector, but could also be made of copper incorporated into the anode current collector (or nickel/stainless steel current collectors for special applications). The fusible region cross-sections could range as little as 50 μm×5 μm to as large as 250×25 μm and length could extend from 0.5 mm to 50 mm. To achieve longer fuse lengths within the restricted area where the current collector could be adhered to a mechanically reinforcing tape spacer, the fuse pattern may be non-linear like a serpentine. The fuse design shown herein is made of aluminum with a 70 μm×15 μm cross-section with serpentine pattern totaling 15 mm in length. As shown in FIG. 2, the fuse segment adds a series resistance of 0.5 ohm between the weld to the busbar and active material laminated regions and melts to disconnect them when 0.8 A is applied.

In an example, when placed within a secondary battery stack, a demonstration has been performed to show the fuse can provide abuse tolerance against nail penetration. As shown in FIGS. 23 and 24, when the nail penetration is performed, the terminal voltage momentarily drops to indicate a short has formed then immediately recovers indicating the internally shorted cathode electrodes have disconnected from the cathode terminal. X-Ray-microscope imaging after testing shows the fuse cross-section of an electrode connected to the nail has broken to disconnect it from the rest of the battery circuit. The shorted electrodes physically in contact with the nail were able to safely discharge, which caused the surface temperature to rise several degrees without causing a catastrophic event.

In an example, for high volume manufacturing (HVM), the fusible current collector segment can be laser-patterned into a web during laser-dicing of electrode rolls—compatible with incumbent electrode cutting HVM processes and equipment. After lamination of the tape, a laser can be pulsed to remove current collector material in that region leaving the fuse segment intact and adhered to the tape reinforcement. This is important as an unreinforced fusible cross-section would be mechanically weak and likely break in downstream processing. The dimension of the fuse could also be verified using incumbent in-line vision metrology to ensure the fuse will behave as designed. This would be cheaper than adding electrical resistance metrology as may be needed for other solutions with resistive polymer adhesive.

In an example, the systems and methods disclosed herein include a secondary battery having a battery enclosure, and an electrode assembly and an electrolyte within the battery enclosure. The electrode assembly having unit cells stacked in a stacking direction, each of the unit cells comprising an anode structure, a separator structure, and a cathode structure. The cathode structure including a fuse section incorporated into a cathode current collector.

In an example, the systems and methods disclosed herein can be modified such that the threshold current of the fuse could be selected to address an external short circuit event where the current is evenly distributed throughout the entire cell across all the electrodes. The systems and methods disclosed herein can also be modified such that a secondary narrower cross-section within the fuse length can be incorporated to promote disconnecting in a specific location. The systems and methods disclosed herein can also be modified such that the fuse may be laminated with tape to hinder heat transfer to the environment. The systems and methods disclosed herein can also be modified such that the current near fuse link can be removed to hinder heat transfer to other regions of current collector. The systems and methods disclosed herein can also be modified such that additional fuse segments could be incorporated within the active material region to further subdivide electrodes with large capacities and inherently low resistances.

While preferred embodiments of the present inventions have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for energy manipulation, the device comprising: a cell assembly being an electrochemical cell assembly, the cell assembly comprising an electrode separated from a counter-electrode by a stacking gap, the electrode comprising an electrode current collector having a middle portion contacting an electrode active material, the current collector comprising a distal portion contacting the middle portion, the distal portion having (a) a tab portion disposed at a terminal of the current collector, and (b) a fuse portion contacting the tab portion, the fuse portion being operatively coupled with the middle portion of the current collector, the distal portion being devoid of the electrode active material.

2. The device of claim 1, wherein the current collector has a lateral axis constituting the longest axis of the current collector, the middle portion and the distal portion being disposed along the lateral axis.

3. The device of claim 1, wherein the electrode is stacked along a stacking axis with the counter-electrode, a lateral axis being normal to the stacking axis; and wherein the electrode has an electrodes lateral length along the lateral axis smaller than a counter-electrode lateral length, and a collective lateral length of the middle portion and of the fuse portion is smaller than the counter-electrode lateral length.

4. The device of claim 1, wherein the electrode is stacked along a stacking axis with the counter-electrode, a lateral axis being normal to the stacking axis; and wherein the cell assembly comprises a spacer member disposed adjacent to a distal lateral end of the electrode active material and along the lateral axis, the spacer member being configured to contact the fuse portion of the current collector such that the spacer member supports the fuse portion structurally during at least a portion of a use of the cell assembly, the use comprising electrically charging the electrode or electrically discharging the electrode.

5. The device of claim 4, wherein the spacer member is a first spacer member, and wherein the cell assembly comprises a second spacer member disposed at an opposing lateral side of the separator; optionally wherein the first spacer member and the second spacer member are disposed along a lateral axis of the separator, the spacer members being disposed adjacent to opposing lateral ends of the electrode active material.

6. The device of claim 5, wherein the first spacer member and the second spacer member constitute a first pair of spacer members coupled with a first face of the separator along the stacking axis, the cell assembly comprising a second pair of spacer members coupled with the separator at a second face of the separator opposing the first face; the first pair of spacer member being configured to face the electrode current collector.

7. The device of claim 1, wherein the electrode is stacked along a stacking axis with the counter-electrode, a lateral axis being normal to the stacking axis; and wherein the tab portion is bent in a direction having a vector component along the stacking axis.

8. The device of claim 1, wherein a lateral surface area of the electrode is rectangular comprising a rectangle, the rectangle having an aspect ratio of at least about 1:2.

9. The device of claim 1, wherein the cell assembly is configured to operate at standard operation conditions comprising cycles of electrical charge and discharge; C-rate charging, voltage differential, or any combination thereof.

10. The device of claim 1, wherein the device comprises a constraint system configured to curb volumetric expansion of the cell assembly to abide by jurisdictional standards and/or industry standards, the fuse remaining functional during the volumetric expansion.

11. The device of claim 1, wherein the fuse portion comprises a meandering fuse; optionally wherein the meandering fuse is a serpentine type fuse.

12. The device of claim 1, wherein a slot is disposed in a connection between the tab portion and the fuse portion of the current collector.

13. The device of claim 1, wherein the electrode is stacked along a stacking axis with the counter-electrode, a lateral axis being normal to the stacking axis; and wherein the middle portion of the current collector has a first height, the height being along a height axis normal to the stacking axis and normal to the lateral axis, the fuse having a second height that is the same or smaller than the first height.

14. The device of claim 1, wherein the electrode is stacked along a stacking axis with the counter-electrode, a lateral axis being normal to the stacking axis; and wherein along the stacking axis, the fuse portion of the current collector is on the same plane as the middle portion of the current collector.

15. The device of claim 1, wherein the electrode is stacked along a stacking axis with the counter-electrode, a lateral axis being normal to the stacking axis; and wherein along the stacking axis, the fuse portion of the current collector is on a different plane as the middle portion of the current collector by a longitudinal distance.

16. The device of claim 1, wherein the electrode is stacked along a stacking axis with the counter-electrode, a lateral axis being normal to the stacking axis; and wherein the middle portion of the current collector couples with a remainder end of the current collector, the remainder end opposing the tab portion, the remainder end contacting the middle portion of the current collector, the remainder end being along the lateral axis of the current collector.

17. The device of claim 1, wherein the fuse is configured to protect against harm caused by an electrical surge; optionally wherein the harm is to the device, to personnel handling the device, to a facility in which the device is disposed, to an environment in which the facility is disposed, to an ambient environment external to the device, to an internal environment of the device, to equipment in the facility, or to any combination thereof.

18. A method comprising: (a) providing the device of claim 1; and (b) manufacturing, testing, buffering, storing, transporting, and/or using the device for the energy manipulation.

19. An apparatus for using the device of claim 1, the apparatus comprises: at least one controller configured to (a) operatively couple with at least one component and with the device; and (b) executing, or directing the at least one component to execute, one or more operations associated with manufacturing, testing, buffering, storing, transporting, and/or using, the device; optionally wherein the at least one controller is configured to operatively couple with a power source and/or with a communication platform; and optionally wherein one or more of the at least one component is of the device.

20. One or more non-transitory computer readable media comprising program instruction physically inscribed thereon, the program instructions, when read by one or more processors, are configured to (I) execute, or direct execution of, one or more operations associated with manufacturing, testing, buffering, storing, transporting, and/or using, the device of any of claim, and (II) the one or more operations comprising directing at least one component to execute the one or more operations, the one or more processors being configured to operatively couple with the at least one component.
